(19) United States
(12) Patent Application Publication
(10) Pub. No.: US 2026/0161048 A1
(43) Pub. Date: Jun. 11, 2026

(54) Driving Arrangement, Camera Module and Assembling Method Thereof

(71) Applicant: NINGBO SUNNY OPOTECH CO., LTD, Yuyao City (CN)

(72) Inventors: Qiang FU, Yuyao City (CN); Yinli FANG, Yuyao City (CN); Chao HONG, Yuyao City (CN); NAI WEN HSU, Yuyao City (CN); HIROSHI OSADA, Yuyao City (CN); Chen Hsien Fan, Yuyao City (CN); Fan CHANG, Yuyao City (CN); Chenyang ZHONG, Yuyao City (CN)

(21) Appl. No.: 19/406,972

(22) Filed: Dec. 3, 2025

(30) Foreign Application Priority Data
Dec. 5, 2024 (CN) 2024117831970
Aug. 11, 2025 (CN) 2025111159946
Aug. 11, 2025 (CN) 2025111164520
Aug. 11, 2025 (CN) 2025111165580
Aug. 11, 2025 (CN) 2025111166494
Aug. 11, 2025 (CN) 2025111167904
Aug. 11, 2025 (CN) 2025111170682

(51) Int. Cl. G03B 5/00

(52) U.S. Cl. CPC G03B 5/00; G03B 2205/0061

(57) ABSTRACT

A driving arrangement for a camera module includes a movable part, a fixed part, a piezoelectric actuator, a pre-pressing part and a first support part, a friction plate is arranged on top of the movable part, a bottom of the movable part has a guide groove, the piezoelectric actuator includes a friction head, the pre-pressing part is arranged on top of the piezoelectric actuator to apply a pre-pressing force perpendicular to the optical axis to the movable part, the first support part provided between bottom of the movable part and the fixed part includes a plurality of support balls, when the movable part is moved to an extreme position, a minimum length of the support balls being closely arranged is not less than a maximum distance between the friction head and an end of the friction plate.

### CROSS REFERENCE OF RELATED APPLICATION

This application is a non-provisional application that claims priority under 35 U.S.C. § 119 to China application number CN202411783197.0, filing date Dec. 5, 2024, China application number CN202511115994.6, filing date Aug. 11, 2025, China application number CN202511117068.2, filing date Aug. 11, 2025, China application number CN202511116558.0, filing date Aug. 11, 2025, China application number CN202511116452.0, filing date Aug. 11, 2025, China application number CN202511116649.4, filing date Aug. 11, 2025, and China application number CN202511116790.4, filing date Aug. 11, 2025, wherein the entire content of which is expressly incorporated herein by reference.

### BACKGROUND OF THE PRESENT INVENTION

### Field of Invention

The present invention relates to the field of camera module, and more particular to a driving arrangement, a camera module, and a method for assembling the same.

### Description of Related Arts

Currently, as electronic devices continue to evolve towards miniaturization and high performance, camera modules, as a standard component of electronic devices, are facing increasingly stringent user demands for both small size and high imaging capabilities. To further enhance user experience, the industry is actively working on compact design and functional integration improvements for camera modules. Through technological innovation and functional integration, the industry is continuously driving the development of camera modules towards greater compactness and intelligence, further realizing functions such as autofocus, zoom, image stabilization, and telephoto capabilities.

A periscope camera module is a special type of camera module that uses an optical path deflector to change the path of light, allowing it to be placed horizontally in electronic devices such as mobile phones. This solves the problem of excessively tall telephoto camera modules caused by the excessive optical total length of telephoto lenses. This design allows the camera to provide a longer focal length and higher zoom capability without increasing the module thickness.

### SUMMARY OF THE PRESENT INVENTION

An object of this application is to provide a driving arrangement, a camera module, and an assembling method thereof, wherein by driving from the top of the movable part, it helps to improve assembly consistency and contact flatness, and reduce tilting and consistency problems caused by assembly errors.

Another object of this application is to provide a driving arrangement, a camera module, and an assembling method thereof which helps to prevent the optical lens from tipping over and further enhances the stability of the optical lens.

Another object of this application is to provide a driving arrangement, a camera module, and an assembling method thereof which simplifies the assembly process of the camera module, reduces assembly difficulty, and further shortens production time.

Another object of this application is to provide a driving arrangement and a camera module, wherein magnetic attraction assembly and pre-pressing part are respectively arranged on two sides of the movable part. The pre-pressing force generated by the pre-pressing part and the magnetic attracting force generated by the magnetic attraction assembly make the force on the movable part more uniform, thus avoiding the problem of the camera module tipping over and affecting the imaging effect.

Another object of this application is to provide a driving arrangement and a camera module, wherein a damping structure is arranged to provide buffering on the side without a piezoelectric actuator, thereby preventing the movable part from continuing to move, buffering the impact generated by the collision of the movable part, and reducing noise.

Another object of this application is to provide a driving arrangement and a camera module which solves or at least partially alleviates the following problems that may occur when the movable part overturns, the first support part is subjected to a large force, and thus sliding friction, pitting, and jamming may occur due to the pre-pressing part and the piezoelectric actuator acting on one side of the movable part.

Another object of this application is to provide a driving arrangement and a camera module which optimizes the contact point distribution of the support balls at the bottom of the movable part by setting small balls between two support balls and using different sizes between the support balls and the small balls, so that the force on the movable part is more uniform, while reducing the sliding friction ratio and reducing wear.

Another object of this application is to provide a driving arrangement and a camera module, wherein by setting the relationship between the minimum length of the first support part and the distance from the friction head to one end of the friction plate, it alleviates to some extent the problem of the movable part easily overturning at the extreme position, so as to ensure that the movable part can still be stably supported when it moves to the extreme position, and reduces the risk of the movable part overturning due to uneven force at the extreme position.

Another object of this application is to provide a driving arrangement and a camera module which simplifies the wiring by placing the position sensing element and the electric conductive component on two sides of the flexible circuit board and electrically connecting the flexible circuit board, thereby avoiding interference between the electric conductive component and the position sensing assembly and the flexible circuit board, and solving or at least partially alleviating the wiring problem between the piezoelectric actuator and the position sensing element in the driving arrangement.

Another object of this application is to provide a driving arrangement and a camera module which effectively improves the compactness of the mounting structure on the first fixed sidewall by setting the position sensing element inside the first fixed sidewall and electrically connecting it to the flexible circuit board, and setting at least a portion of the electric conductive component outside the flexible circuit board to electrically connect it to the conductive element of the flexible circuit board. This avoids increasing the assembly gap between the fixed part and the movable part and is beneficial to improving the accuracy of position sensing.

Another object of this application is to provide a driving arrangement and a camera module which reduces the welding difficulty and the number of bends of the electric conductive component by placing the welding point between the electric conductive component and the flexible circuit board at the bottom, thereby reducing the possibility of breakage.

Another object of this application is to provide a driving arrangement and a camera module, wherein the pre-pressing part comprises a pre-pressing part body and a pre-pressing deformable body. The distance between the top surface of the main body of the electric conductive component and the bottom surface of the pre-pressing part body of the pre-pressing part is H1, and the distance between the top surface of the extension area and the bottom surface of the deformable body of the pre-pressing part is H2. H1 is not greater than H2, so as to avoid the deformation of the electric conductive component and the deformation of the deformable part interfering with each other under the operation of the piezoelectric actuator, thereby affecting the driving effect of the driving arrangement.

To achieve the above objectives, the technical solution adopted in this application is a driving arrangement for a periscope camera module, comprising:
a movable part which is arranged to support an optical lens which defines an optical axis;
a fixed part, wherein the movable part is movably disposed within the fixed part;
a piezoelectric actuator, which makes frictional contact with the top of the movable part and is arranged to drive the movable part to move along the optical axis.
a pre-pressing part which is arranged on the top of the piezoelectric actuator to apply a pre-pressing force perpendicular to the optical axis to the movable part; and
a pressing block coupled to the pre-pressing part and designed to be installed from the top of the fixed part to provide a preset space for deformation of the pre-pressing part.

The pressing block can simplify the assembly process, improve the consistency and stability of the camera module, adjust the pre-pressing force of the pre-pressing part, and protect the pre-pressing part.

As a preferred embodiment, the movable part comprises a first movable sidewall located on a first side and a second movable sidewall located on a second side, wherein the pressing block, the pre-pressing part, and the piezoelectric actuator are sequentially located above the first movable sidewall along a second direction, wherein the second direction is perpendicular to the optical axis.

As a preferred embodiment, the pressing block comprises a pressing beam and two pressing arms, with the two pressing arms located at two ends of the pressing beam. The pressing block is installed on the fixed part by fixing the two pressing arms to the fixed part. The bottom surface of the pressing arms is lower than the bottom surface of the pressing beam. A groove is formed between the pressing beam and the two pressing arms, and the groove provides deformation space for the pre-pressed part.

As a preferred embodiment, each of the pressing arms comprises a pressing mounting platform and a pressing fixing platform. The two pressing fixing platforms of the two pressing arms are located outside the two pressing mounting platforms along the optical axis. The distance between the two pressing fixing platforms along the second direction is greater than the distance between the two pressing mounting platforms along the second direction. The groove is formed between the two pressing mounting platforms and the pressing beam. The pre-pressing part is installed on the two pressing mounting platforms, and the two pressing fixing platforms are respectively fixed to the fixed part.

As a preferred embodiment, the pressing mounting platforms of the two pressing arms are respectively spaced apart from the fixed part, and there is a gap between the two pressing mounting platforms and the fixed part.

As a preferred embodiment, when viewed along the optical axis, the pressing beam is spaced apart from the first movable sidewall of the movable part, and the pressing arm is spaced apart from the first movable sidewall of the movable part.

As a preferred embodiment, the driving arrangement further comprises a first support part disposed between the fixed part and the movable part along the second direction. The top and bottom of the first movable sidewall of the movable part maintain frictional contact with the piezoelectric actuator and the first support part respectively. The first support part provides a supporting force to the movable part along the second direction. The pre-pressing part deforms under the action of the pressing block and the first support part to generate the pre-pressing force along the second direction, wherein the direction of the pre-pressing force is opposite to the direction of the supporting force.

As a preferred embodiment, the dimension of the pressing block along the optical axis is larger than the dimension of the first support part along the optical axis; in the optical axis direction, the projection of the first support part along the second direction is entirely within the projection range of the pressing block along the second direction.

As a preferred embodiment, the fixed part comprises a first fixed sidewall located on a first side, a second fixed sidewall located on a second side, and a fixed body connecting the first fixed sidewall and the second fixed sidewall. The bottom surface of the first movable sidewall is provided with a second guide groove, and the bottom of the first fixed sidewall is provided with a first guide groove. The first support part is installed between the second guide groove and the first guide groove. The dimension of the pressing block along the optical axis is larger than the dimension of the second guide groove along the optical axis, and in the optical axis direction, the projection of the second guide groove along the second direction is entirely within the projection range of the pressing block along the second direction.

As a preferred embodiment, the piezoelectric actuator comprises a piezoelectric active part and a friction head connected to each other, and the friction head maintains frictional contact with the first movable sidewall under the action of the pre-pressing part; wherein the position of the friction head acting on the first movable sidewall is aligned with the cross-sectional center of the first support part in a second direction.

To achieve one of the objectives of this application, the technical solution adopted in this application is a camera module, which comprises:
any of the above-mentioned driving arrangement;
a light deflection element arranged to deflect incident light rays;
an optical lens, wherein the optical lens is held on the light deflection path of the light deflection element; and
a photosensitive assembly for receiving light from the optical lens.

To achieve one of the objectives of this application, the technical solution adopted in this application is a method for assembling a driving arrangement, which comprises the following steps:
S1: provide a fixed part;
S2: provide a movable part, which is movably installed in the fixed part, wherein the movable part is used to carry an optical lens, the optical lens defines an optical axis;
S3: provide a piezoelectric actuator, a pre-pressing part, and a pressing block; assemble the piezoelectric actuator, the pre-pressing part, and the pressing block to form a pre-pressing driving assembly, wherein the pre-pressing part is disposed between the piezoelectric actuator and the pressing block, the piezoelectric actuator is mounted on the pre-pressing part, the pressing block is coupled to the pre-pressing part to provide a deformable preset space for the pre-pressing part; and
S4: install the pre-pressing driving assembly onto the fixed part in a direction perpendicular to the optical axis and position the pre-pressing driving assembly on top of the movable part.

As a preferred embodiment, the step S3 further comprises the following steps:
S31: first, couple the pre-pressing component to the pressing block, and then install the piezoelectric actuator on the pre-pressing part to form the pre-pressing driving assembly.

This application provides a driving arrangement, comprising:
A movable part which is arranged to support an optical lens, the optical lens defines an optical axis, he movable part comprises a first movable sidewall and a second movable sidewall opposite to each other, the bottom of the first movable sidewall has a second guide groove, and the bottom of the second movable sidewall has a second support groove;
a fixed part, wherein the movable part is movably disposed within the fixed part;
a piezoelectric actuator which makes frictional contact with the top of the first movable sidewall, and is arranged to drive the movable part to move along the optical axis.
a pre-pressing part which is disposed on the top of the piezoelectric actuator to apply a pre-pressing force perpendicular to the optical axis to the second guide groove, wherein the pre-pressing force direction intersects the plane containing the inner surface of the second guide groove;
a magnetic attraction assembly which is brought close to the second support groove to apply a magnetic attracting force perpendicular to the optical axis to the second support groove, wherein the direction of the magnetic attraction force is perpendicular to the plane containing the inner surface of the second support groove;
a first support part and a second support part, wherein the first support part comprises at least two support balls, and the second support part comprises at least one support ball, wherein the at least two support balls of the first support part are tightly fitted in the second guide groove as a main guide portion, and the at least one support ball of the second support part is loosely fitted in the second support groove as an auxiliary support portion.

As a preferred embodiment, the projection of the pre-pressed part along the second direction, the projection of the piezoelectric actuator along the second direction, and the projection of the first support part along the second direction overlap, while the projection of the second support part along the second direction do not overlap with the projection of the magnetic attraction assembly along the second direction, and the second direction is perpendicular to the optical axis.

As another preferred embodiment, the driving arrangement further comprises a pressing block fixed to the fixed part, the pressing block, the pre-pressing part and the piezoelectric actuator being located sequentially on the top of the first movable sidewall along the second direction, and the projection of the first support part along the second direction being entirely within the projection range of the pressing block along the second direction.

Further preferably, the piezoelectric actuator comprises a piezoelectric active part and a friction head connected to each other. Under the action of the pre-pressing part, the friction head and the top of the movable part always maintain frictional contact. The pressing block, the pre-pressing part, the friction head and the first support part are together passed through by an imaginary line parallel to the second direction. The cross-sectional center of the pressing block, the position of the friction head acting on the movable part and the cross-sectional center of the first support part are aligned in the second direction.

Further preferably, the magnetic attracting force and the pre-pressing force are parallel to each other and in the same direction, and the pre-pressing force is greater than the magnetic attracting force.

Further preferably, the first support part comprises at least two support balls and at least one small ball located between them. The at least two support balls and at least one small ball of the first support part are all disposed in the second guide groove. The pre-pressing force is applied to the line connecting the at least two support balls of the first support part, and the magnetic attracting force is applied to a position close to the second support part.

Further preferably, the first support part is in contact with the second guide groove at two points, and the second support part is in contact with the second support groove at a single point.

Preferably, the second guide groove has two opposing sidewalls, and there is an included angle between the planes containing the two sidewalls. The first support part is in frictional contact with the two sidewalls of the second guide groove, so that the first support part is tightly fitted in the second guide groove. The second support groove has a bottom wall, and the second support part is in frictional contact with the bottom wall of the second support groove, so that the second support part is loosely fitted in the second support groove.

More preferably, the line connecting the first support part and the second support part intersects the plane containing the side wall of the second guide groove, and the line connecting the first support part and the second support part is parallel to the plane containing the bottom wall of the second support groove.

Further preferably, a first magnetic attracting element and a second magnetic attracting element are provided, the first magnetic attracting element is provided on the fixed part, the second magnetic attracting element is provided on the movable part, and the second magnetic attracting element is provided between the first support part and the second support part and adjacent to the second support part. The first magnetic attracting element and the second magnetic attracting element are arranged opposite to each other along the second direction and interact to generate magnetic attracting force. Along the first direction, the distance from the second magnetic attracting element to the second support part is less than the distance from the second magnetic attracting element to the first support part.

Further preferably, the first magnetic attracting element is a metal magnetic yoke, the first magnetic attracting element comprises a base portion and a support portion, at least a portion of the base portion having its projection along the second direction overlaps with the projection of the second magnetic attracting element along the second direction, and at least a portion of the support portion having its projection along the second direction overlaps with the projection of the second support portion along the second direction.

This application also provides a driving arrangement for a periscope camera module, comprising:
a movable part for supporting an optical lens, the optical lens defines an optical axis, the movable part comprises opposing first movable sidewalls and second movable sidewalls, wherein the second movable sidewall has a slot;
a fixed part, wherein the movable part is movably disposed within the fixed part;
a piezoelectric actuator which makes frictional contact with the top of the first movable sidewall and is arranged to drive the movable part to move along the optical axis;
a pre-pressing part which is disposed on the top of the piezoelectric actuator and applies a pre-pressing force perpendicular to the optical axis to the first movable sidewall;
a damping structure comprising a damping bracket and a damping element, the damping bracket is disposed on the fixed part, and the damping element is extended from the plane of the damping bracket toward the second movable sidewall, at least a portion of the damping element is extended into the slot of the second movable sidewall.

As a preferred embodiment, the damping bracket comprises a main body part, an installing part, and a side connection part. The installing part is located at two ends of the main body part. The plane of the main body part is parallel to the optical axis, and the plane of the installing part is perpendicular to the optical axis. The side connection part is extended from the plane of the main body part along a second direction. The plane of the side connection part is perpendicular to both the plane of the main body part and the plane of the installing part, wherein the second direction is perpendicular to the optical axis.

As a preferred embodiment, the fixed part comprises opposing first and second fixed sidewalls, the second fixed sidewall has an opening, at least a portion of the second movable sidewall being located within the opening, the installing part being fixed to the second fixed sidewall, and the main body par covers the opening.

As a preferred embodiment, the damping element comprises a first part and a second part, the first part being connected to the main body part of the damping bracket, the second part being connected to the first part, and the second part not contacting the main body part of the damping bracket, wherein the length of the second part along the optical axis is less than the length of the first part along the optical axis.

As a preferred embodiment, the length of the second part along the optical axis is less than the length of the slot along the optical axis.

As a preferred embodiment, the height of the second part along the second direction is greater than the height of the first part along the second direction.

Preferably, the height of the second part along the second direction is less than the height of the slot along the second direction.

As a preferred embodiment, along the second direction, at least a portion of the main body part abuts against the top of the second fixed sidewall, and at least a portion of the main body part has a certain gap with the top of the second movable sidewall.

As a preferred embodiment, the first part comprises a top surface and a bottom surface opposite each other along a second direction, and the bottom surface of the first part has a gap with the top of the second movable sidewall.

As a preferred embodiment, the slot of the second movable sidewall has an inner sidewall parallel to the second direction, the second part of the damping element has an inner surface parallel to the second direction, and there is a gap between the inner sidewall and the inner surface.

As a preferred embodiment, when the movable part moves along the optical axis, the inner wall of the slot contacts the inner surface of the second part, and the second part moves or deforms towards the side where the inner wall does not contact the inner surface under the action of force.

This application also provides a driving arrangement for a periscope camera module, comprising:
a movable part arranged to support an optical lens, the optical lens defines an optical axis, the movable part comprises opposing first movable sidewalls and second movable sidewalls, the bottom of the first movable sidewall having a guide groove extending along the optical axis;
a fixed part, wherein the movable part is movably disposed within the fixed part;
a first support and a second support which re provided between the movable part and the fixed part, the first support is provided between the bottom of the first movable sidewall and the fixed part, and the second support is provided between the second movable sidewall and the fixed part;
the first support part comprises at least two support balls, and the second support portion comprises at least one support ball;
the number of support balls in the first support part is greater than the number of support balls in the second support part, and the support balls in the first support part are accommodated in the guide groove;
a piezoelectric actuator which makes frictional contact with the top of the first movable sidewall, is used to drive the movable part to move along the optical axis; and
a pre-pressing part which is disposed on the piezoelectric actuator to apply a pre-pressing force perpendicular to the optical axis to the first movable sidewall and the first support part.

As a preferred embodiment, the first support part comprises at least two support balls and at least one small ball located between them, and the pre-pressing force of the pre-pressing part acts on the line connecting the at least two support balls of the first support part.

As a preferred embodiment, the driving arrangement further comprises a pressing block which is fixed to the fixed part. The pressing block, the pre-pressing part, and the piezoelectric actuator are located sequentially on the top of the first movable sidewall of the movable part along the second direction. The projection of the first support part along the second direction is entirely within the projection range of the pressing block along the second direction, wherein the second direction is perpendicular to the optical axis direction.

As a preferred embodiment, the piezoelectric actuator comprises a piezoelectric active part and a friction head connected to each other, the friction head maintaining frictional contact with the first movable sidewall, wherein an imaginary line passing through the pressing block, the pre-pressing part, the friction head, and the first support part along the direction of the pre-pressing force in the second direction passes through them.

As a preferred embodiment, the center of the cross-section of the pressing block and the position where the friction head acts on the first movable sidewall are aligned with the center of the cross-section of the first support in a second direction.

As a preferred embodiment, the first support provides a supporting force along a second direction to the first movable sidewall, and the pre-pressing part deforms under the action of the pressing block and the first support to generate the pre-pressing force, wherein the direction of the pre-pressing force is opposite to the direction of the supporting force.

As a preferred embodiment, the bottom of the second movable sidewall has a support groove extending along the optical axis, and the second support portion is accommodated in the support groove.

As a preferred embodiment, the number of the guide groove and the support groove is one. The guide groove extends through the bottom of the first movable sidewall along the optical axis, and the support groove is extended through at least a portion of the bottom of the second movable sidewall along the optical axis. The length of the guide groove along the optical axis is greater than the length of the support groove along the optical axis.

As a preferred embodiment, the support balls of the first support part are tightly fitted into the guide groove, and the support balls of the second support portion are loosely fitted into the support groove.

As a preferred embodiment, the difference between the length of the guide groove along the optical axis and the minimum total length of the first support part is not less than the mechanical stroke of the movable part.

This application also provides a driving arrangement for a periscope camera module, comprising:
a movable part for supporting an optical lens which defines an optical axis, and a friction plate arranged on a top of the movable part and extending along the optical axis, wherein a bottom of the movable part has a guide groove extending along the optical axis;
a fixed part, wherein the movable part is movably disposed within the fixed part;
a piezoelectric actuator which comprises at least one friction head that is in frictional contact with the friction plate and is used to drive the movable part to move along the optical axis;
a pre-pressing part which is arranged on a top of the piezoelectric actuator to apply a pre-pressing force perpendicular to the optical axis to the movable part; and
a first support part provided between the bottom of the movable part and the fixed part, wherein the first support part comprises a plurality of support balls, wherein when the movable part is moved to an extreme position, a minimum length of the plurality of support balls being closely arranged is not less than a maximum distance between the at least one friction head and an end of the friction plate.

As a preferred embodiment, the movable part comprises a first movable sidewall and a second movable sidewall which is opposite to the first movable sidewall, wherein the pre-pressing part, the friction head and the friction plate are sequentially located at a top of the first movable sidewall along a second direction, and the first support part is located at a bottom of the first movable sidewall, wherein a projection of the pre-pressing part along the second direction, a projection of the friction head along the second direction, a projection of the friction plate along the second direction and a projection of the first support part along the second direction overlap each other, wherein the second direction is perpendicular to the optical axis.

As a preferred embodiment, the movable part has an incident light side and an exit light side, and when the movable part is moved to the extreme position at the incident light side, the plurality of support balls are concentratedly arranged at one end of the guide groove adjacent to the exit light side, and the minimum length of the plurality of support balls being closely arranged is not less than the maximum distance between the at least one friction head and the one end of the friction plate adjacent to the exit light side.

As a preferred embodiment, when the movable part is moved to the extreme position at the exit light side, the plurality of support balls are concentratedly arranged at another end of the guide groove adjacent to the incident light side, and the minimum length of the plurality of support balls being closely arranged is not less than the maximum distance between the at least one friction head and the another end of the friction plate adjacent to the incident light side.

As a preferred embodiment, the movable part has an incident light side and an exit light side, and when the movable part is moved to the extreme position at the incident light side, the plurality of support balls are concentratedly arranged at another end of the guide groove adjacent to the incident light side, and the minimum length of the plurality of support balls being closely arranged is not less than the maximum distance between the at least one friction head and the another end of the friction plate adjacent to the incident light side.

As a preferred embodiment, when the movable part is moved to the extreme position at the exit light side, the plurality of support balls are concentratedly arranged at one end of the guide groove adjacent to the exit light side, and the minimum length of the plurality of support balls being closely arranged is not less than the maximum distance between the at least one friction head and the one end of the friction plate adjacent to the exit light side.

As a preferred embodiment, the projection of the friction plate along the second direction overlaps with a line connecting the two farthest endpoints of the guide groove, and the projection of the friction plate along the second direction overlaps with a line connecting the two support balls of the first support part.

As a preferred embodiment, the projection of the friction head along the second direction overlaps with the projection of a line connecting the first and last balls of the first support part along the second direction.

As a preferred embodiment, the projection of the friction head along the second direction is covered by the projection of the guide groove along the second direction.

As a preferred embodiment, the driving arrangement further comprises a pressing block fixed to the fixed part and coupled to the pre-pressing part to provide a deformable preset space for the pre-pressing part, wherein the pressing block is placed on a top of the pre-pressing part, and the projection of the first support part along the second direction is entirely within a projection range of the pressing block along the second direction.

As a preferred embodiment, the maximum distance between the at least one friction head and the one end of the friction plate is not less than a mechanical stroke of the movable part.

This application also provides a driving arrangement for a periscope camera module, comprising:
a movable part for supporting an optical lens, the optical lens defines an optical axis, the movable part comprises a first movable sidewall;
a fixed part, wherein the movable part is movably disposed within the fixed part, the fixed part comprises a first fixed sidewall, the first movable sidewall is opposite to the first fixed sidewall along a first direction, the first direction is perpendicular to the optical axis direction;
a position sensing assembly comprising a position sensing element and a position sensing magnet disposed opposite to each other along the first direction, wherein the position sensing magnet is disposed on the first movable sidewall;
a piezoelectric actuator which makes frictional contact with the top of the first movable sidewall and is arranged to drive the movable part to move along the optical axis;
an electric conductive component which is disposed on the top of the piezoelectric actuator and electrically connected to the piezoelectric actuator, the electric conductive component is bent from the top of the piezoelectric actuator to the first fixed sidewall; and
a flexible circuit board which is disposed on the first fixed sidewall, and at least a portion of the position sensing element and the electric conductive component are respectively located on two sides of the flexible circuit board and electrically connected to the flexible circuit board.

As a preferred embodiment, the flexible circuit board comprises an inner side and an outer side opposite to each other along the first direction, the first fixed sidewall has a mounting groove, the position sensing element is disposed in the mounting groove to electrically connect to the inner side of the flexible circuit board, and the electric conductive component is bent to the outer side of the flexible circuit board to electrically connect to the flexible circuit board.

As a preferred embodiment, the flexible circuit board comprises a top near the piezoelectric actuator and a bottom away from the piezoelectric actuator, wherein the electric conductive component is bent from the top of the piezoelectric actuator and is extended to the bottom of the flexible circuit board to provide conductivity at the bottom of the flexible circuit board.

As a preferred embodiment, the electric conductive component comprises a main body, an extension part, and a welding part. The main body is located at the top of the piezoelectric actuator. The extension part is bent along the second direction from the plane of the main body. The welding part is connected to the extension part and is electrically connected to the bottom of the flexible circuit board. The plane of the main body is perpendicular to the plane of the flexible circuit board, and the plane of the extension part is parallel to the plane of the flexible circuit board. The second direction is perpendicular to the optical axis and the first direction.

As a preferred embodiment, the piezoelectric actuator comprises a piezoelectric active part and a friction head connected to each other, the friction head is in frictional contact with the top of the first movable sidewall; the main body is located on top of the piezoelectric active part, and two extension parts are extended from two ends of the main body along the optical axis and then are bent along the second direction.

As a preferred embodiment, the extension part comprises an extension area and an extension leg. The extension areas are extended from two ends of the main body along the optical axis and then are bent and connected to the extension legs along the second direction. The extension leg is connected to the welding part at its bottom along the second direction. The main body, the extension areas, the extension legs, and the welding part form an extension opening.

As a preferred embodiment, a pre-pressing part is also included and is disposed on the top of the piezoelectric actuator to apply a pre-pressing force perpendicular to the optical axis to the movable part; the pre-pressing part comprises a pre-pressing part body and pre-pressing part deformable bodies, the pre-pressing part deformable bodies are extended from two ends of the pre-pressing part body along the optical axis; along a second direction, the distance from the top surface of the main body of the electric conductive component to the bottom surface of the pre-pressing part body is H1, and the distance from the top surface of the extension part of the electric conductive component to the bottom surface of the pre-pressing part deformable body is H2, H1≤H2.

As a preferred embodiment, there is a height difference between the plane where the extension part is located and the plane where the main body is located, and the extension part and the main body are connected by an inclined connecting portion.

As a preferred embodiment, a mounting portion is provided between the pre-pressing part body and the main body of the electric conductive component to increase the distance H1 from the top surface of the main body to the bottom surface of the pre-pressing part body.

### BRIEF DESCRIPTION OF THE DRAWINGS

FIG. 1 is a schematic view of the camera module in some embodiments of this application.

FIG. 2 is an exploded view of the camera module in some embodiments of this application.

FIG. 3 is an exploded view of the driving arrangement in some embodiments of this application.

FIG. 4 is an exploded view of the camera module in some other embodiments of this application.

FIG. 5 is a schematic sectional view of the driving arrangement in the optical axis direction and the second direction in some embodiments of this application.

FIG. 6 is a schematic sectional view of the driving arrangement in the optical axis direction and the second direction in some other embodiments of this application.

FIG. 7 is a schematic sectional view of the camera module in the first and second directions in some embodiments of this application.

FIG. 8 is a bottom view of the camera module in some embodiments of this application.

FIG. 9 is a bottom view of the camera module in some other embodiments of this application.

FIG. 10 is a bottom view of the camera module in some other embodiments of this application.

FIG. 11 is a schematic view of the assembly process of the first support part, the second support part, and the fixed part of the driving arrangement in the embodiment shown in FIG. 6.

FIG. 12 is a schematic view of the assembly process of the movable part of the driving arrangement in the embodiment shown in FIG. 6.

FIG. 13 is a schematic view of the assembly process of the piezoelectric actuator and pre-pressing part of the driving arrangement in the embodiment shown in FIG. 6.

FIG. 14 is a schematic view of the assembly process of the pressing block and pre-pressing part of the driving arrangement in the embodiment shown in FIG. 6.

FIG. 15 is an exploded view illustrating the top cover and fixed part of the driving arrangement in a modified embodiment of this application.

FIG. 16 is an exploded view of the driving arrangement after the top cover is removed in a modified embodiment of this application.

FIG. 17 is a top view of the piezoelectric actuator, the pre-pressing part, and the pressing block of the driving arrangement in a modified embodiment of this application.

FIG. 18 is a bottom view of the piezoelectric actuator, the pre-pressing part, and the pressing block of the driving arrangement in a modified embodiment of this application.

FIG. 19 is a sectional view of the driving arrangement in the optical axis direction and the second direction in a modified embodiment of this application.

FIG. 20 is a sectional view of the driving arrangement in the first direction in a modified embodiment of this application.

FIG. 21 is a sectional view of the driving arrangement in the second direction in a modified embodiment of this application.

FIG. 22 is a bottom view of the movable part of the driving arrangement in a modified embodiment of this application.

FIG. 23 is a bottom view of the camera module in some embodiments of this application.

FIG. 24 is a sectional view of the camera module in the first direction in some embodiments of this application.

FIG. 25 is a sectional view of the camera module in the optical axis direction in some embodiments of this application.

FIG. 26 is a sectional view of the camera module in the first direction in some embodiments of this application.

FIG. 27 is an exploded view illustrating the top cover and fixed part of the driving arrangement in some embodiments of this application.

FIG. 28 is a sectional view of the damping structure in some embodiments of this application.

FIG. 29 is a schematic view illustrating the deformation of the damping structure in some embodiments of this application.

FIG. 30 is a schematic view of the damping structure in some embodiments of this application.

FIG. 31 is a schematic view of the assembly process of the first support part, the second support part, and the fixed part of the driving arrangement.

FIG. 32 is a schematic view of the assembly process of the movable part of the driving arrangement.

FIG. 33 is a schematic view illustrating the assembly process of the piezoelectric actuator and pre-pressing part of the driving arrangement.

FIG. 34 is a schematic view illustrating the assembly process of the pressing block and the pre-pressing part of the driving arrangement.

FIG. 35 is a sectional view of the driving arrangement in the optical axis direction in a modified embodiment of this application.

FIG. 36 is a bottom view of the movable part of the driving arrangement in a modified embodiment of this application.

FIG. 37 is a schematic view of the driving arrangement without a fixed part in a modified embodiment of this application.

FIG. 38 is a sectional view of a camera module with a single friction head in a modified embodiment of this application, wherein the single friction head is moved to its extreme position towards the incident light side.

FIG. 39 is a sectional view of a camera module with a single friction head in a modified embodiment of this application, wherein the single friction head is moved to its extreme position towards the exit light side.

FIG. 40 is a sectional view of a camera module with double friction heads in a modified embodiment of this application, wherein the double friction heads are moved to an extreme position towards the incident light side.

FIG. 41 is a sectional view of a camera module with double friction heads in a modified embodiment of this application, wherein the double friction heads are moved to an extreme position towards the exit light side.

FIG. 42 is a sectional view of a camera module with a single friction head being moved to its extreme position toward the incident light side in another modified embodiment of this application.

FIG. 43 is a sectional view of a camera module with a single friction head being moved to its extreme position toward the exit light side in another modified embodiment of this application.

FIG. 44 is a sectional view of a camera module with double friction heads in another modified embodiment of this application, wherein the double friction heads are moved to an extreme position toward the incident light side.

FIG. 45 is a sectional view of a camera module with double friction heads being moved to an extreme position towards the exit light side in another modified embodiment of this application.

FIG. 46 is a schematic view of the pressing block, the pre-pressing part, and the piezoelectric actuator of the driving arrangement in a modified embodiment of this application.

FIG. 47 is a schematic view of the structure of the pressing block, the pre-pressing part and the piezoelectric actuator of the driving arrangement from another perspective in a modified embodiment of this application.

FIG. 48 is a schematic sectional view of the camera module in the first direction in a modified embodiment of this application.

FIG. 49 is a structural side view of the pressing block, pre-pressing part, and the piezoelectric actuator in a modified embodiment of this application.

FIG. 50 is an enlarged view of area A in FIG. 49.

FIG. 51 is an enlarged view of the area A in FIG. 49 in another embodiment.

Reference numerals in the drawings: 10, fixed part; 11, first fixed sidewall; 111, first guide groove; 112, first receiving groove; 113, second receiving groove; 114, base extension; 1141, second mounting plane; 115, first sidewall body; 116, mounting groove; 12, fixed body; 13, second fixed sidewall; 131, first support groove; 132, opening; 14, conductor; 141, conductor portion; 15, flexible circuit board; 20, movable part; 21, first movable sidewall; 211, second guide groove; 22, friction portion; 221, friction plate; 23, second movable sidewall; 231, second support groove; 232, slot; 2321, first inner sidewall; 2322, second inner sidewall; 30, piezoelectric actuator; 31, piezoelectric active part; 32, friction head; 33, electrical conductive component; 331, first connecting part; 333, second connecting part; 3331, first sub-connecting portion; 3332, second sub-connecting portion; 334, electrical conductive part; 335, shaping component; 34, buffer component; 3301, main body; 3302, extension part; 33021, extension area; 33022, extension leg; 3303, welding part; 3300, extension opening; 40, pre-pressing part; 41, fixed end; 411, fixing hole; 42, elastic part; 43, bending part; 412, hollow hole; 421, connecting hole; 44, mounting part; 441, connecting post; 50, pressing block; 51, pressing beam; 52, pressing arm; 521, pressing fixing platform; 522, pressing mounting platform; 523, first mounting plane; 524, mounting column; 520, gap; 53, structural reinforcement element; 500, groove; 61, first support part; 611, support ball; 612, small ball; 62, second support part; 601, support ball; 602, small ball; 70, magnetic attraction assembly; 71, first magnetic attracting element; 711, base portion; 712, support portion; 72, second magnetic attracting element; 80, photosensitive assembly; 90, light deflection element; 100, optical lens; 110, position sensing assembly; 1101, position sensing element; 1102, position sensing magnet; 120, top cover; 150, damping structure; 151, damping bracket; 1511, main body part; 1512, installing part; 1513, side connection part; 152, damping element; 1521, first part; 1522, second part; 15221, first inner surface; 15222, second inner surface.

### DETAILED DESCRIPTION OF THE PREFERRED EMBODIMENT

The present application will be further described below with reference to specific embodiments. It should be noted that, without conflict, the various embodiments or technical features described below can be arbitrarily combined to form new embodiments.

In the description of this application, it should be noted that the terms “center”, “lateral”, “longitudinal”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc., which indicate the orientation and positional relationship based on the orientation or positional relationship shown in the accompanying drawings, are only for the convenience of describing this application and simplifying the description, and do not indicate or imply that the device or element referred to must have a specific orientation, or be constructed and operated in a specific orientation, and should not be construed as limiting the specific protection scope of this application.

It should be noted that the terms “first”, “second”, etc., in the specification and claims of this application are used to distinguish similar objects and are not necessarily used to describe a specific order or sequence.

The terms “comprising” and “having”, and any variations thereof, in the specification and claims of this application are intended to cover non-exclusive inclusion, for example, a process, method, system, product, or device that comprises a series of steps or units is not necessarily limited to those steps or units that are explicitly listed, but may include other steps or units that are not explicitly listed or that are inherent to such process, method, product, or device.

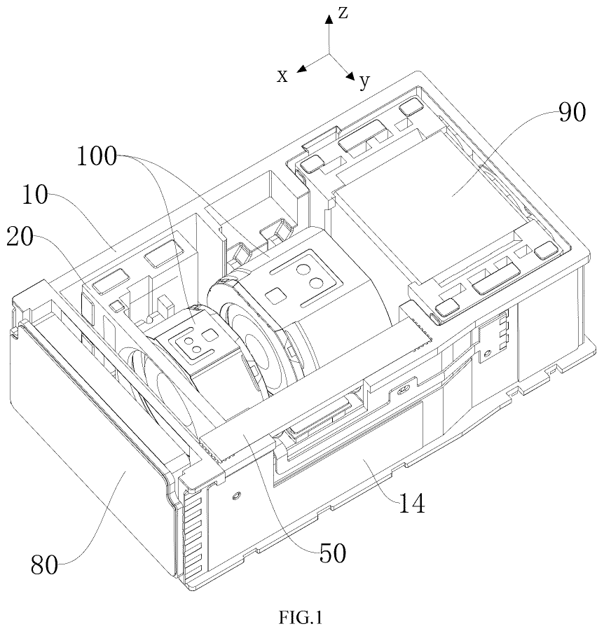

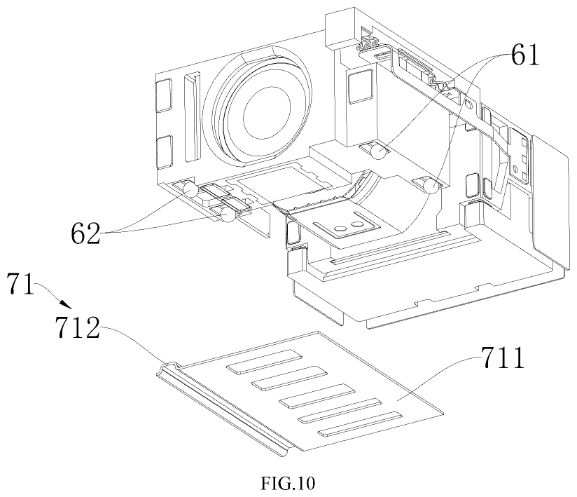

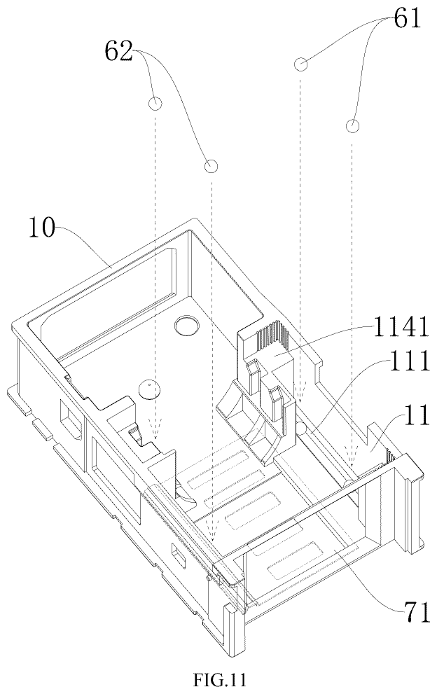

According to one aspect of this application, a driving arrangement for a camera module is provided, as shown in FIGS. 1 to 22. This driving arrangement can be applied to camera modules, particularly periscope camera modules that require significant motor driving force. Further, the driving arrangement comprises a movable part 20, a fixed part 10, a piezoelectric actuator 30, a pre-pressing part 40, and a pressing block 50. The movable part 20 carries an optical lens 100 which defines an optical axis. The movable part 20 is movably disposed within the fixed part 10 for driving the optical lens 100 to move with respect to the fixed part 10, thereby enabling focusing and zooming functions. Further, the piezoelectric actuator 30 makes frictional contact with the top of the movable part 20, driving the movable part 20 to move along the optical axis. Further, the pre-pressing part 40 is disposed on the top of the piezoelectric actuator 30 and applies a pre-pressing force perpendicular to the optical axis to the movable part 20. Specifically, the pressing block 50 is fixed to the fixed part 10 and coupled to the pre-pressing part 40. The pressing block 50 is designed to be installed on the fixed part 10 from the top and provides a deformable preset space for the pre-pressing part 40. By driving from the top of the movable part 20, this application helps to improve assembly consistency and contact flatness, prevents the optical lens 100 from tipping over, reduces tilting and consistency problems in the periscope camera module, and reduces assembly difficulty.

As shown in FIG. 1, the optical lens 100 defines an optical axis perpendicular to a first direction and a second direction. Specifically, the first direction is defined as the width direction of the periscope camera module along the Y-axis, the second direction is defined as the height direction of the periscope camera module along the Z-axis, and the optical axis direction is defined as the length direction of the periscope camera module along the X-axis. It is understood that this coordinate system setting also applies to other modified embodiments of this application.

In some embodiments, the piezoelectric actuator 30 is disposed on top of at least a portion of the movable part 20 along the second direction, and at least a portion of the pre-pressing part 40 is clamped between the piezoelectric actuator 30 and the pressing block 50 along the second direction. The pressing block 50 controls the deformation of the pre-pressing part 40 to generate a pre-pressing force along the second direction. The piezoelectric actuator 30 and the movable part 20 abut against each other under the action of the pre-pressing force, wherein the second direction is perpendicular to the optical axis direction. Since the pre-pressing part 40 and the pressing block 50 are disposed above the height direction of the camera module along the Z-axis, and the pressing block 50 is coupled to the pre-pressing part 40, and the pressing block 50 is designed to be installed from the top onto the fixed part 10 for assembly, the assembly process of the camera module is simplified, further reducing the tilting phenomenon of the movable part 20 and the poor consistency of the camera module caused by assembly errors, thereby improving the imaging stability of the camera module. Furthermore, the pressing block 50 can also adjust the degree of deformation of the pre-pressing part 40 to adjust the magnitude of the pre-pressing force, thereby improving the performance of the driving arrangement. Furthermore, the pressing block 50 can also protect the pre-pressing part 40, preventing the pre-pressing part 40 from interfering with other components in the driving arrangement during deformation, thereby affecting the performance of the pre-pressing part 40.

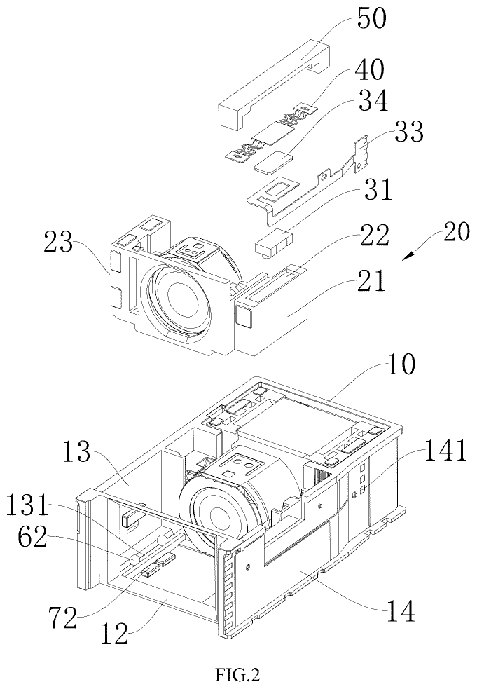

Referring to FIGS. 2, 3, 15, and 16, in some embodiments, the piezoelectric actuator 30 comprises a piezoelectric active part 31 and a friction head 32 connected to each other. The pre-pressing force applied downward in the second direction by the pre-pressing part 40 helps maintain frictional contact between the movable part 20 and the friction head 32 in the piezoelectric actuator 30. This facilitates the movement of the movable part 20 along the optical axis after the piezoelectric active part 31 receives voltage, reducing the shaking and tilting of the optical lens 100 during the driving process, thereby improving the imaging accuracy and stability of the camera module during autofocus. It is understood that by keeping the movable part 20 and the friction head 32 in mutual contact, the movable part 20 can move smoothly and quickly when driven, further improving the response speed of the movable part 20 to the piezoelectric actuator 30 and shortening the time spent during focusing. Furthermore, while improving the driving force provided by the piezoelectric actuator 30, it also enhances the stability of the camera module, reduces image jitter, and thus improves image quality.

In some examples, viewed along the second direction, the friction head 32 is located in the middle of the pre-pressing part 40 along the optical axis. This allows the preload exerted by the pre-pressing part 40 on the friction head 32 to be as symmetrical as possible with respect to the friction head 32, thereby making the drive of the piezoelectric actuator 30 more stable and reducing the risk of tilting. It should be understood that regardless of whether there is one, two, or more friction heads 32, the aforementioned that the friction head 32 is located in the middle of the pre-pressing part 40 means that all friction heads 32 are located in the middle of the pre-pressing part 40. The middle portion refers to the intermediate region along the optical axis, away from both ends.

In some examples, viewed along the second direction, the piezoelectric active part 31 is located in the middle of the pre-pressing part 40 in the optical axis direction. In this way, the pre-pressing force exerted by the pre-pressing part 40 on the piezoelectric active part 31 can be as symmetrical as possible with respect to the piezoelectric active part 31, thereby making the drive of the piezoelectric actuator 30 more stable and reducing the risk of tilting.

In some examples, viewed along the second direction, the pre-pressing part 40 is located in the middle of the pressing block 50 in the optical axis direction, so that the pre-pressing part 40 can produce as symmetrical deformation as possible within the pressing block 50, thereby generating as symmetrical preload as possible, to improve the stability and reliability of the driving arrangement.

Referring to FIGS. 5, 6, and 19, in some embodiments, the fixed part 10 is provided with a first receiving groove 112 and a second receiving groove 113. The first receiving groove 112 and the second receiving groove 113 are opened along a second direction on the same side of the fixed body 12. The first receiving groove 112 is communicated to the upper part of the second receiving groove 113. The pressing block 50 is disposed in the first receiving groove 112, and one side of the movable part 20 is accommodated in the second receiving groove 113. The dimension of the first receiving groove 112 along the optical axis is larger than the dimension of the second receiving groove 113 along the optical axis. Specifically, since the length dimension of the first receiving groove 112 along the optical axis is larger than the length dimension of the second receiving groove 113 along the optical axis, the pressing block 50 accommodated in the first receiving groove 112 can be fixed to the fixed part 10, further increasing the stability and reliability of the pressing block 50. Furthermore, the pressing block 50 is placed in the first receiving groove 112, the movable part 20 is placed in the second receiving groove 113, and the pre-pressing part 40 and the piezoelectric actuator 30 are sequentially arranged between the pressing block 50 and the movable part 20, making the structure more compact and increasing the space utilization rate inside the camera module.

It is understood that the length of the second receiving groove 113 along the optical axis is greater than the length of the movable part 20 along the optical axis, thereby providing space for at least a portion of the movable part 20 to move along the optical axis within the second receiving groove 113 when driven by the piezoelectric actuator 30.

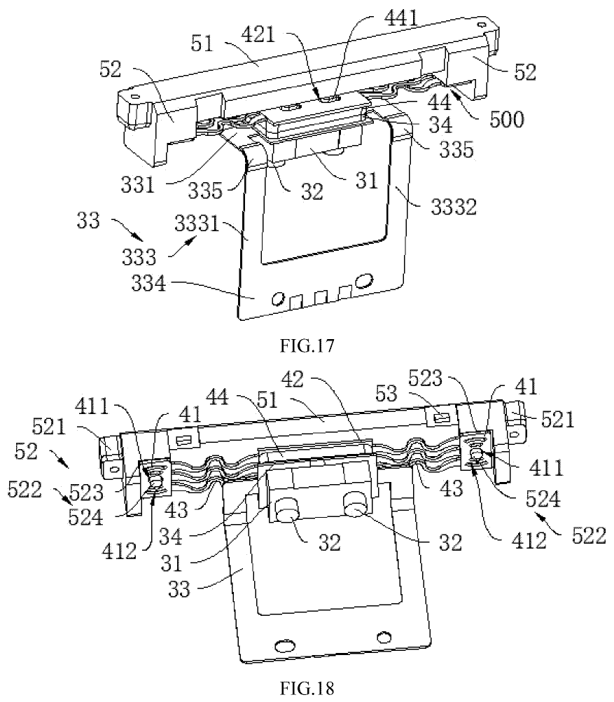

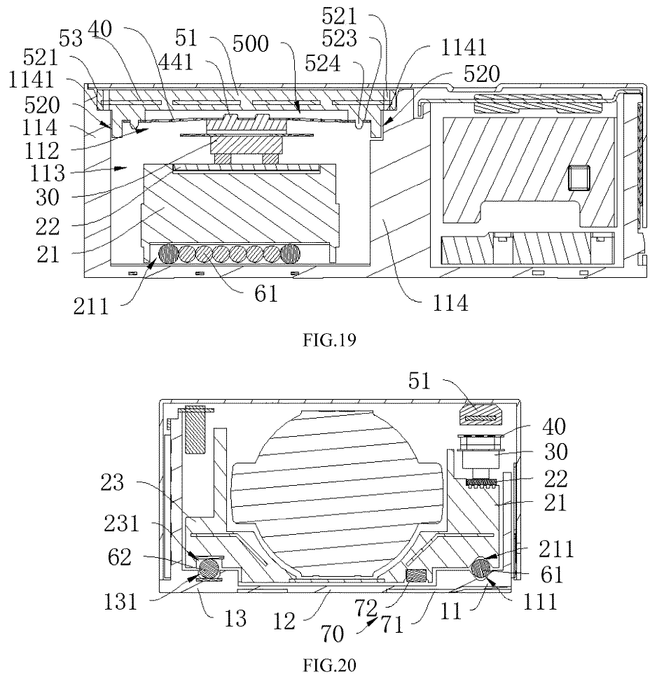

Referring again to FIG. 19, in a modified embodiment of this application, the first receiving groove 112 is a stepped groove, and the first receiving groove 112 has a shape that is larger at the top and smaller at the bottom along the second direction. That is, the dimension of the end of the first receiving groove 112 away from the second receiving groove 113 in the optical axis direction is larger than the dimension of the end of the first receiving groove 112 near the second receiving groove 113 in the optical axis direction. The pressing block 50 is disposed in the first receiving groove 112 and fixed within the first receiving groove 112. Accordingly, referring further to FIGS. 17 and 18, in this example, the pressing block 50 comprises a pressing beam 51 and two pressing arms 52. The two pressing arms 52 are respectively located at two ends of the pressing beam 51, and the pressing block 50 is installed on the fixed part 10 by fixing the two pressing arms 52 to the fixed part 10. The two pressing arms 52 are extended from two ends of the pressing beam 51 along the second direction toward the fixed part 10 and are fixedly connected to the fixed part 10. The two pressing arms 52 and the pressing beam 51 form a “Π” shape. The bottom surface of the pressing arm 52 is lower than the bottom surface of the pressing beam 51. The pre-pressing part 40 is fixed to the pressing block 50 by fixing it with the two pressing arms 52. A groove 500 is formed between the pressing beam 51 and the two pressing arms 52. The groove 500 is suitable for providing deformation space for the pre-pressing part 40. More specifically, each pressing arm 52 comprises a pressing mounting platform 522 and a pressing fixing platform 521. The two pressing fixing platforms 521 are located outside the two pressing mounting platforms 522 along the optical axis direction. The distance between the two pressing fixing platforms 521 along the second direction is greater than the distance between the two pressing mounting platforms 522 along the second direction. The groove 500 is formed between the two pressing mounting platforms 522 and the pressing beam 51. The pre-pressing part 40 is installed on the two pressing mounting platforms 522. The two pressing fixing platforms 521 are respectively fixed to the fixed part 10.

In this design, the groove 500, the first receiving groove 112, and the second receiving groove 113 of the pressing block 50 are communicated and connected. At least a portion of the pre-pressing part 40 and the movable part 20 are clamped between the pressing block 50 and the fixed part 10, and at least a portion of the pre-pressing part 40 and the movable part 20 are located within the space connected by the groove 500, the first receiving groove 112, and the second receiving groove 113. It should be understood that when the pressing block 50 is pressed down further in the second direction, the pre-pressing part 40 and at least a portion of the movable part 20 will be clamped more tightly, the deformation of the pre-pressing part 40 will be greater, and thus the pre-pressing force generated by the pre-pressing part 40 will be greater. In other words, the pressing block 50 can not only provide deformation space for the pre-pressing part 40 and maintain the deformation generated by the pre-pressing part 40, but also adjust the magnitude of the pre-pressing force generated by the pre-pressing part 40. For example, by moving the pressing beam 51 downward toward the movable part 20 in the second direction, the pressing block 50 can be further pressed down, thereby increasing the pre-pressing force of the pre-pressing part 40.

Furthermore, the pressing mounting platforms 522 of the two pressing arms 52 are respectively spaced apart from the fixed part 10, and gaps 520 are provided between the two pressing mounting platforms 522 and the fixed part 10. These gaps 520 can be filled with air or other cushioning materials. It should be understood that by providing these gaps 520 the pressing mounting platforms 522 and the fixed part 10 are not in direct contact, thereby reducing the impact of the fixed part 10 on the pressing mounting platforms 522. Consequently, the pre-pressing part 40 fixed on the pressing mounting platforms 522 is less affected by the fixed part 10, and similarly, changes in the pre-pressing part 40 have a reduced impact on the fixed part 10. For example, when the fixed part 10 is impacted, because the two pressing mounting platforms 522 are spaced apart from the fixed part 10, the effect of the shock on the pre-pressing part 40 is reduced, which in turn reduces the impact on the piezoelectric actuator 30 and the driving effect of the driving arrangement.

Furthermore, as shown in FIG. 19, the pressing block 50 may further comprises a structural reinforcement element 53 embedded therein to enhance the structural strength of the pressing block 50. The structural reinforcement element 53 is protruded from the side of the pressing block 50. It should be understood that the structural reinforcement element 53 may be embedded in the pressing beam 51 and the pressing arm 52, or it may only be embedded in the pressing beam 51. It should be understood that a cushioning material may also be fixed to the structural reinforcement element 53 by means of adhesive bonding or integral molding. This cushioning material may be formed between the pressing arm 52 and the movable part 20 of the pressing block 50 to prevent the movable part 20 and the pressing arm 52 from directly colliding.

Referring again to FIG. 19, it is worth mentioning that in this modified embodiment, viewed along the optical axis, the movable part 20 and the pressing block 50 are spaced apart, and there is an air gap between them. In other words, along the optical axis, the movable part 20 and the pressing block 50 do not overlap. This reduces the risk of the movable part 20 colliding with the pressing block 50 when it moves with respect to the fixed part 10 along the optical axis. Furthermore, since the pressing arm 52 of the pressing block 50 is extended from the pressing beam 51 toward the first movable sidewall 21 of the movable part 20, specifically, viewed along the optical axis, the pressing beam 51 and the first movable sidewall 21 of the movable part 20 are spaced apart, and the pressing arm 52 and the first movable sidewall 21 of the movable part 20 are also spaced apart.

It is worth mentioning that the aforementioned spacing means that, viewed along the optical axis, the movable part 20 and the pressing block 50 are at least a certain distance apart in both the first and/or second directions. Specifically, along the second direction, the bottom surface of the pressing arm 52 of the pressing block 50 is higher than the top surface of the first movable sidewall 21.

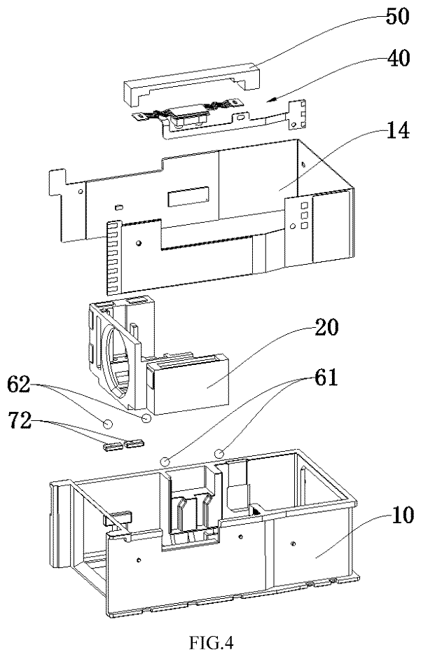

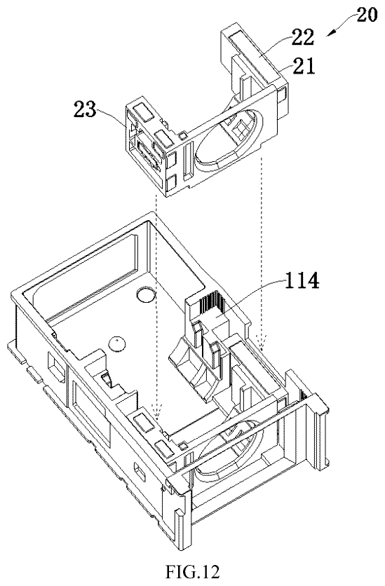

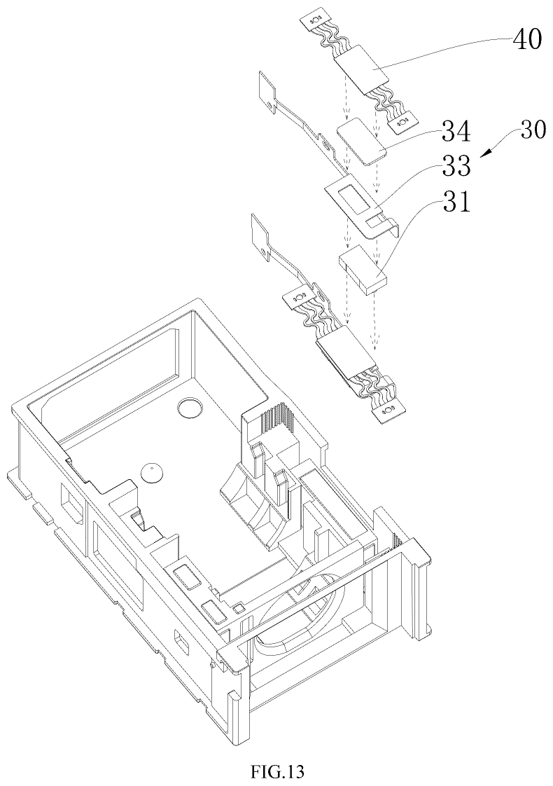

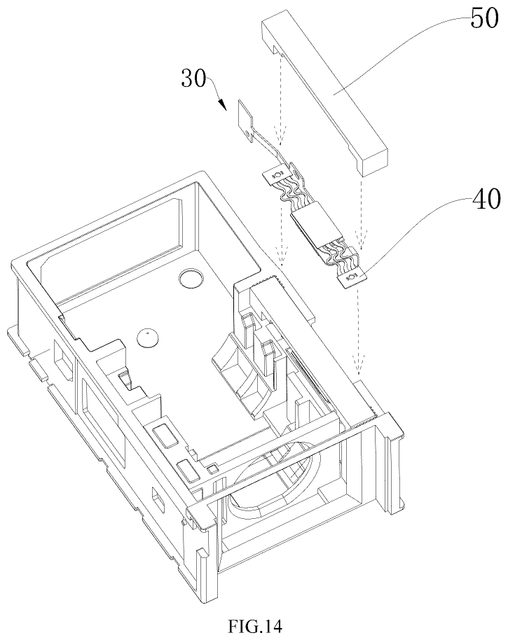

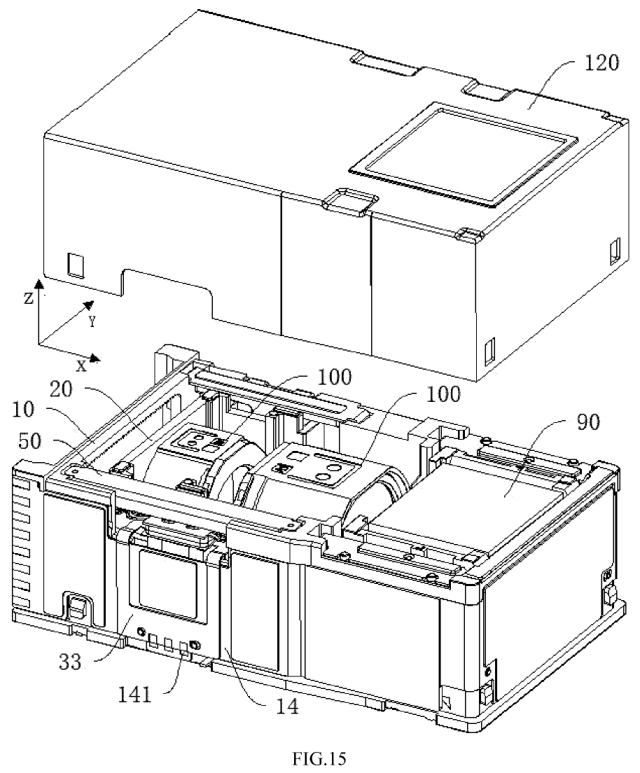

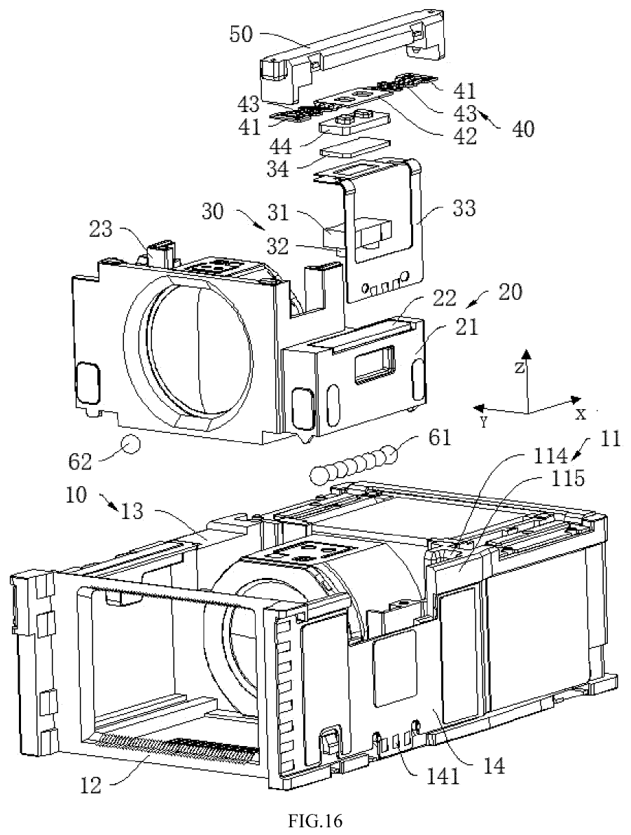

In some embodiments, as shown in FIGS. 4 and 16, the driving arrangement further comprises a first support part 61 which is disposed between the fixed part 10 and the movable part 20 along the second direction. At least a portion of the upper and lower parts of the movable part 20 maintain frictional contact with the piezoelectric actuator 30 and the first support part 61 respectively. In this driving arrangement, the pre-pressing part 40, the piezoelectric actuator 30, the movable part 20, and the first support part 61 are sequentially clamped between the pressing block 50 and the fixed part 10 along the second direction. The first support part 61 provides an upward support force to the movable part 20 along the second direction. The pre-pressing part 40 deforms under the combined action of the first support part 61 and the pressing block 50, thereby providing a downward pressing force along the second direction. It is understandable that if the pressing block 50 is not fixed to the fixed part 10, the pre-pressing part 40 and the pressing block 50 will move upward in the second direction under the action of the first support part 61, causing the pressing block 50, the pre-pressing part 40, and the piezoelectric actuator 30 to detach from the movable part 20. This would prevent the pre-pressing part 40 from deforming and generating the pre-pressing force, affecting the drive. To avoid this situation, the pressing block 50 is fixedly connected to the fixed part 10 in this application. Under the action of the first support part 61, the pressing block 50 will generate a downward pressing force in the second direction due to its connection with the fixed part 10. This prevents the pre-pressing part 40 and the pressing block 50 from detaching and maintains the deformation of the pre-pressing part 40, thus ensuring the generation of the pre-pressing force. The direction of the pre-pressing force is the same as the direction of the downward pressing force, the direction of the downward pressing force is opposite to the direction of the supporting force, and the direction of the pre-pressing force is opposite to the direction of the supporting force. Understandably, if only a pre-pressing force is applied to the top of the movable part 20 on one side, it may increase the risk of overturning of the movable part 20. Therefore, in order to maintain the force balance of the movable part 20, the first support part 61 provides a support force to the movable part 20 in the opposite direction to the pre-pressing force to balance it and reduce the risk of overturning of the movable part 20.

In some embodiments, the pre-pressing part 40 deforms under the action of the pressing block 50 and the first support part 61 to generate the pre-pressing force, the direction of which is the same as that of the downward pressure. Under the action of the pre-pressing force, the friction head 32 and the first movable sidewall 21 of the movable part 20 always maintain frictional contact, which is beneficial for the piezoelectric actuator 30 to generate a stable driving force.

In some embodiments, referring to FIGS. 7 to 10, 16 and 20, the driving arrangement further comprises a second support part 62 which is disposed between the fixed part 10 and the movable part 20 along the second direction. The second support part 62 and the first support part 61 are disposed opposite each other on two sides of the bottom of the fixed part 10 along the first direction which is perpendicular to the second direction and the optical axis direction. The fixed part 10 comprises a first side and a second side opposite each other. The first support part 61 is disposed on the first side close to the piezoelectric actuator 30 and is tightly clamped between the movable part 20 and the fixed part 10. The second support part 62 is disposed on the second side away from the piezoelectric actuator 30 and is loosely clamped between the movable part 20 and the fixed part 10.

Since the pre-pressing part 40 is only provided on one side of the movable part 20, the support force provided by the second support member 62 to the bottom of the other side of the movable part 20 further balances the pre-pressing force generated on one side of the movable part 20. On the one hand, it avoids excessive friction caused by the surface contact between the movable part 20 and the fixed part 10, which would result in poor driving effect. On the other hand, the provision of the second support member 62 helps to improve the parallelism of the movable part 20 when it moves, further improves the stability of the optical lens 100, and enhances the imaging quality of the camera module.

Understandably, the first support part 61 is tightly fitted and abuts against both the fixed part 10 and the movable part 20, while the second support part 62, being loosely fitted between the fixed part 10 and the movable part 20, has a certain gap with both the fixed part 10 and/or the movable part 20. This gap provides a certain amount of pre-set space for adjusting the position of the movable part 20. In other words, when the movable part 20 is driven by the piezoelectric actuator 30, the first support part 61 always provides stable support for the movable part 20 to ensure its parallelism during movement. When the movable part 20 tilts, the gap at the second support part 62 provides a certain amount of leeway for adjusting its position. Furthermore, when the movable part 20 tilts to a certain degree, abutting against the fixed part 10 and the movable part 20 corrects the movement state of the movable part 20, preventing further tilting and thus avoiding any impact on driving performance due to the tilt of the movable part 20. Furthermore, this arrangement facilitates assembly; a tight fit is beneficial for the installation and positioning of the movable part 20, while a loose fit allows for easy adjustment of the movable part 20, further reducing assembly tolerances and improving the assembly accuracy of the camera module. It should be understood that the tilting of the movable part 20 in this application comprises: tilting where the movable part 20 tends to rotate around the optical axis, tilting where the movable part 20 tends to rotate around a first direction, and tilting where the movable part 20 is driven to rotate around a second direction.

In some embodiments, the first support part 61 and the second support part 62 may also be simultaneously fitted and abutted between the fixed part 10 and the movable part 20, so that the first support part 61 and the second support part 62 can always provide stable support for the movable part 20, thereby ensuring the parallelism of the movable part 20 when it moves and reducing the risk of the movable part 20 tilting.

Furthermore, when the movable part 20 is driven to move along the optical axis, the main supporting component is the first support part 61. The straight-line distance from the contact point between the friction head 32 and the movable part 20 to the first support part 61 is less than the straight-line distance from the contact point between the friction head 32 and the movable part 20 to the second support part 62. Since the first support part 61 adopts a tight-fit assembly method, the straight-line distance from the contact point between the friction head 32 and the movable part 20 to the first support part 61 is the lever arm value corresponding to the overturning moment of the movable part 20. By reducing the lever arm value, the overturning moment value is further reduced, thereby avoiding the risk of the movable part 20 tilting. Furthermore, the above-mentioned tight-fit and loose-fit assembly methods can be considered through the tolerance values in the assembly process. For example, the tolerance between the first support part 61 and the movable part 20 and the fixed part 10 is small, for example, 0.01, while the tolerance between the second support part 62 and the movable part 20 and the fixed part 10 is large, for example, 0.02. When the movable part 20 is not tilted, the first support part 61 provides support for the movable part 20. However, when the movable part 20 tilts, the second support part 62 provides support to straighten the movable part 20. This can reduce the possibility of the movable part 20 tilting to a certain extent, which helps to improve the imaging quality of the camera module.

In some embodiments, referring to FIGS. 2, 7, 16, 20, and 21, the movable part 20 comprises a first movable sidewall 21 located on a first side and a second movable sidewall 23 located on a second side. The first movable sidewall 21 and the second movable sidewall 23 are arranged opposite each other along the first direction. The pressing block 50, the pre-pressing part 40, and the piezoelectric actuator 30 are sequentially located above the first movable sidewall 21 along the second direction. The first movable sidewall 21 is provided with a second guide groove 211 and a friction portion 22. The second guide groove 211 is formed at the bottom surface of the first movable sidewall 21 and is arranged opposite to the first guide groove 111 along the second direction. The first support part 61 is installed between the first guide groove 111 and the second guide groove 211, such that the bottom surface of the first movable sidewall 21 abuts against the first support part 61. The friction portion 22 is installed on the top surface of the first movable sidewall 21 and abuts against the friction head 32 of the piezoelectric actuator 30. The first movable sidewall 21 is accommodated in the second receiving groove 113. The second movable sidewall 23 is provided with a second support groove 231. The second support groove 231 is formed at the bottom surface of the second movable sidewall 23 and is arranged opposite to the first support groove 131 along the second direction. The second support part 62 is installed between the first support groove 131 and the second support groove 231, so that the bottom surface of the second movable sidewall 23 abuts against the second support part 62. By assembling the support part structure between the guide rail and the guide groove structure, the support part is stably clamped between the movable part 20 and the fixed part 10, thereby increasing the stability of the camera module.

In some embodiments, the fixed part 10 further comprises a first fixed sidewall 11 located on a first side, a second fixed sidewall 13 located on a second side, and a fixed body 12 connecting the first fixed sidewall 11 and the second fixed sidewall 13. The first fixed sidewall 11 and the second fixed sidewall 13 are respectively disposed opposite to each other on two sides of the fixed body 12 along the second direction. The first receiving groove 112 and the second receiving groove 113 are formed in the first fixed sidewall 11 along the second direction. The first receiving groove 112 and the second receiving groove 113 are located at the top of the first fixed sidewall 11, such that the pressing block 50 abuts against the top of the first fixed sidewall 11. The first guide groove 111 is provided at the bottom of the first fixed sidewall 11, and the first support groove 131 is provided at the bottom of the second fixed sidewall 13. The first support part 61 is mounted at the first guide groove 111 and supports the first side of the movable part 20, while the second support part 62 is mounted at the first support groove 131 and supports the second side of the movable part 20. The arrangement of the first support part 61 and the second support part 62 reduces the frictional resistance experienced by the movable part 20 when it is driven to move, thus improving the driving performance within the camera module. The first guide groove 111 and the first support groove 131 are flush with each other on two sides of the fixed part 10 along the first direction, so that the first support part 61 and the second support part 62 are relatively flush with each other along the first direction, providing stable support for the movable part 20. Furthermore, as shown in FIG. 4, since the piezoelectric actuator 30 drives the movable part 20 from the top, the first support part 61 and the second support part 62 only need to be flush with each other at the bottom of the movable part 20 to provide stable support, further improving the stability of the movable part 20 when driven along the optical axis. In other words, when the piezoelectric actuator 30 drives the movable part 20, a support portion is provided at the bottom of the movable part 20 on the opposite side where the piezoelectric actuator 30 is located. This allows the movable part 20 to be clamped between the piezoelectric actuator 30 and the support portion, preventing the movable part 20 from tilting during the driving process. Furthermore, there is no need to provide additional support portions on the side or top of the movable part 20, thereby reducing the number of support portions in the camera module, optimizing the assembly process, further reducing assembly tolerances, and increasing assembly consistency.

Specifically, when friction is generated between the support part and the fixed part 10 and the movable part 20, the movement state of the support part is uncertain. The support part may be in a rolling state or a sliding state, which may cause the friction between the support part and the movable part 20 to change. Since the support part can switch its movement state at will, reducing the number of support parts can reduce the risk of tilting of the movable part 20 or overturning and the support part getting stuck, thereby enhancing the imaging performance of the camera module.

In some embodiments, the driving arrangement further comprises an insert disposed on the abutting surface between the first guide groove 111 and the first support part 61, providing a flatter support surface for the first support part 61. Further, the insert in the first guide groove 111 has the same shape as the first guide groove 111. For example, if the first guide groove 111 is a V-shaped groove, the insert can also be V-shaped; if the first guide groove 111 is a U-shaped groove, the insert can also be U-shaped; or, the insert can also be planar. On the one hand, this helps to reduce wear on the first support part 61 when it moves inside the first guide groove 111, extending the service life of the first support part 61; it also reduces the risk of the first support part 61 jamming during use, further improving the quality and lifespan of the camera module. On the other hand, it reduces deformation phenomena such as pitting in the first support part 61 caused by excessive force under pre-pressing force, further enhancing the reliability of the camera module.

In some embodiments, the driving arrangement further comprises an insert that lies flat on the contact surface between the first support groove 131 and the second support part 62 to enhance the support for the second support part 62. The insert in the first support groove 131 has the same shape as the first support groove 131. For example, if the first support groove 131 is a V-shaped groove, the insert can also be V-shaped; if the first support groove 131 is a U-shaped groove, the insert can also be U-shaped; or, the insert can also be planar. This insert structure helps to reduce wear on the second support part 62 when it moves inside the first support groove 131, extending the service life of the second support part 62; it also reduces the risk of the second support part 62 jamming during use, further improving the quality and lifespan of the camera module.

In some embodiments, the contact surfaces of the second guide groove 211 and the second support groove 231 in the movable part 20 with the support structure are also provided with insert structures. That is, the first support part 61 contacts the inserts in the second guide groove 211 and the inserts in the first guide groove 111 respectively, and the second support part 62 contacts the inserts in the second support groove 231 and the inserts in the first support groove 131 respectively. The provided insert structures reduce wear on the first support part 61 when it moves between the first guide groove 111 and the second guide groove 211, and reduce wear on the second support part 62 when it moves between the second support groove 231 and the first support groove 131, further improving the quality and lifespan of the camera module. On the other hand, they also reduce deformation phenomena such as dents in the first support part 61 and the second support part 62 caused by excessive force, further enhancing the reliability of the camera module.

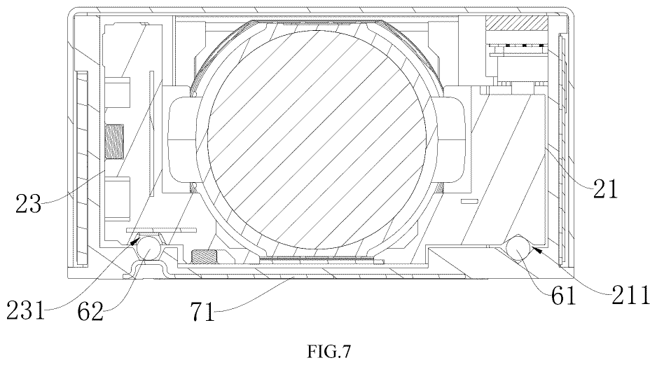

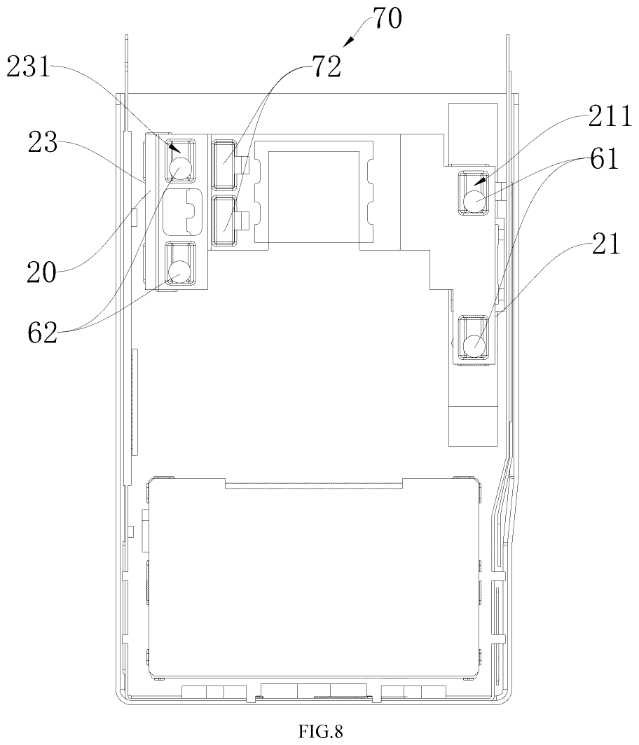

As shown in FIGS. 8 and 9, in some embodiments, each of the first support part 61 and the second support part 62 comprises at least two support portions spaced apart along the optical axis. The spacing between at least two support portions of the first support part 61 is greater than the spacing between at least two support portions of the second support part 62, so as to provide a larger support area on the same side of the piezoelectric actuator 30. It is understood that the first support part 61 is assembled inside the second guide groove 211, and the second support part 62 is assembled inside the second support groove 231. As above, the length of the second movable sidewall 23 along the optical axis can be less than the length of the first movable sidewall 21 along the optical axis to provide sufficient movement space for the first support part 61 and the second support part 62. The support portion can be implemented as a ball or a slider.

In some embodiments, the movable part 20 and/or the fixed part 10 are provided with a guide structure suitable for mounting the support part, such as a guide groove or guide rail structure. Since the support part is arranged along the optical axis, it facilitates guiding the movable part 20 to move along the optical axis. It is understood that a metal insert is provided on the inner side of the guide groove or guide rail, which helps to reduce wear on the support when it moves inside the guide groove or guide rail, reduces the risk of the support getting stuck during use, and further improves the quality and lifespan of the camera module.

In some embodiments, the first support part 61 can be implemented as a plurality of support portions arranged sequentially along the optical axis. It should be understood that, on the one hand, increasing the number of support portions can improve the stability and load-bearing capacity of the movable part 20, making the movable part 20 more stable when moving along the optical axis; on the other hand, since the motion state of a single support portion is uncertain, the support portion may be in a rolling or sliding state, increasing the number of support portions can compensate for the mutual motion states between the support portions. Further, the second support part 62 can be implemented as a plurality of support portions arranged sequentially along the optical axis, so that the opposite sides of the movable part 20 receive balanced support. Specifically, the first support part 61 comprises at least three support portions, and the second support part 62 comprises at least three support portions.

Specifically, since the movable part 20 moves along the optical axis, the first support part 61 and the second support part 62 are provided between the movable part 20 and the fixed part 10 to support the own weight of the movable part 20. To further maintain the stability of the optical lens 100, the first support part 61 and the second support part 62 are arranged as close as possible along the first direction with respect to the optical axis on two sides of the bottom of the movable part 20 to provide as symmetrical support force as possible for the movable part 20, thereby reducing the risk of tilting of the movable part 20.

Understandably, since the second movable sidewall 23 does not have components such as the piezoelectric actuator 30, its length along the optical axis does not need to be increased. In other words, the length of the second movable sidewall 23 along the optical axis can be less than the length of the first movable sidewall 21 along the optical axis, which helps to increase the compactness of the driving arrangement structure and further reduce the weight of the movable part 20 and the size of the driving arrangement. The piezoelectric actuator 30 and the pre-pressing part 40 are set on the top of the first movable sidewall 21. On the one hand, this makes the internal space of the camera module more rationally utilized. This is because the piezoelectric actuator 30 and the pre-pressing part 40 both extend along the optical axis, and the corresponding first movable sidewall 21 of the movable part 20 also needs to extend along the optical axis. That is to say, the first movable sidewall 21 needs to have a certain length to increase the drive stroke of the piezoelectric actuator 30. Furthermore, by setting the first support part 61 on the bottom surface of the first movable sidewall 21, there can be a longer space to set the first support part 61, so as to provide a larger support area through the first support part 61. Conversely, since the piezoelectric actuator 30 does not need to be installed on one side of the second movable sidewall 23, a shorter length can be provided to offer sufficient space for the second support part 62. This not only enhances the structural compactness of the lens driving arrangement but also helps reduce its size. Furthermore, due to the large optical focusing stroke in the periscope camera module, this design also helps ensure that the first support part 61 and the second support part 62 consistently provide stable support for the movable part 20 throughout the long stroke. Because of the large optical focusing stroke in the camera module, this design helps ensure that the support provides effective support for the movable part 20 throughout the long stroke.

As shown in FIG. 22, in a modified embodiment of this application, the first support part 61 and the second support part 62 are respectively disposed on two sides of the optical axis along the first direction. The first support part 61 is disposed on the bottom surface of the first movable sidewall 21 of the movable part 20, and the second support part 62 is disposed on the bottom surface of the second movable sidewall 23 of the movable part 20. The number of support portions in the first support part 61 is greater than the number of support portions in the second support part 62, and the length of the first support part 61 along the optical axis is greater than the length of the second support part 62 along the optical axis, thereby allowing the movable part 20 to have more support positions in the first support part 61. It should be understood that the piezoelectric actuator 30 and the pre-pressing part 40 are located on top of the first support part 61. The greater number of support portions in the first support part 61 allows the force acting on the first support part 61 (at least including the pre-pressing force generated by the pre-pressing part 40) to be distributed by more support portions, thereby reducing the force on each support portion and lowering the risk of pitting on the surfaces of the movable part 20 and the fixed part 10 in contact with the first support part 61. Accordingly, the length of the first movable sidewall 21 along the optical axis is greater than the length of the second movable sidewall 23 along the optical axis, so as to provide more space for the first support part 61. The second movable sidewall 23 is shorter along the optical axis, which can enhance the structural compactness of the driving arrangement and reduce the size of the driving arrangement.

Specifically, the first support part 61 has a number of support portions greater than or equal to 3, for example, 8. The two support portions located at both ends along the optical axis have the largest height dimension along the second direction, that is, the height dimension of the other support portions along the second direction is less than or equal to the height dimension of the two support portions located at both ends of the first support part 61; the second support part 62 has a number of support portions of 1, and the height dimension of the second support part 62 along the second direction is equal to the height dimension of the two support portions at two ends of the first support part 61.

More specifically, in this embodiment, the first support part 61 is assembled inside the second guide groove 211, and the second support part 62 is assembled inside the second support groove 231. The first support part 61 has a large number of support portions, which can reduce the risk of pits forming in the second guide groove 211 or the first guide groove 111. Correspondingly, the length of the second guide groove 211 along the optical axis is greater than the length of the second support groove 231 along the optical axis.

It is worth mentioning that in this modified embodiment, the dimension of the pressing block 50 along the optical axis is larger than the dimension of the first support part 61 along the optical axis, and the projection of the first support part 61 along the second direction is entirely within the projection range of the pressing block 50 along the second direction in the optical axis direction. This allows the force on the multiple support portions in the first support part 61 to be more uniform. Furthermore, the dimension of the pressing block 50 along the optical axis is also larger than the dimension of the second guide groove 211 along the optical axis, and the projection of the second guide groove 211 along the second direction is entirely within the projection range of the pressing block 50 along the second direction in the optical axis direction. This ensures that even if the position of the first support part 61 in the second guide groove 211 changes, the projection of the first support part 61 along the second direction in the optical axis direction will always remain entirely within the projection range of the pressing block 50 along the second direction. As mentioned above, the pressing block 50 can provide deformation space for the pre-pressing part 40, maintain the deformation generated by the pre-pressing part 40, and also adjust the magnitude of the pre-pressing force generated by the pre-pressing part 40. Since the first support part 61, the pressing block 50, and the pre-pressing part 40 are located on the same side with respect to the optical axis, the pre-pressing force can act more directly on the first support part 61, and the adjustment of the pre-pressing force by the pressing block 50 can also be directly applied to the first support part 61. The projection of the first support part 61 along the second direction is entirely within the projection range of the pressing block 50 along the second direction. On the one hand, the pressing block 50 keeps the pre-pressing part 40 and the first support part 61 in close spatial alignment to generate pre-pressing force and support force. On the other hand, during the driving process, the first support part 61 remains within the range of the pressing block 50, reducing the risk of overturning of the movable part 20 and improving the stability of the driving arrangement. Furthermore, the pre-pressing force adjusted by the pressing block 50 can be dispersed by the multiple support portions of the first support part 61, making the force on each support more uniform. Especially when a fall or impact occurs, the multiple supports can disperse the impact force, reducing the risk of dents in the first support part 61. In addition, the pressing block 50 can also protect the first support part 61 from falling out of its original position, preventing it from affecting the reliability of the driving arrangement.

It is worth mentioning that in this modified embodiment, the imaginary line of the direction of the pre-pressing force applied to the movable part 20 intersects with the line connecting the first support part 61, which helps to reduce the overturning moment value and further reduce the risk of tilting of the movable part 20. Specifically, the position of the friction head 32 of the piezoelectric actuator 30 acting on the first movable sidewall 21 is aligned with the cross-sectional center of the first support part 61 in the second direction. This arrangement helps the pre-pressing force applied by the pre-pressing part 40 to act stably and directly on the first support part 61, increasing the stability of the pre-pressing force transmission, thereby reducing errors caused by poor alignment of components and improving the reliability of the camera module. Furthermore, this alignment method helps to reduce excessive local wear on the first support part 61, extending the service life of the camera module while reducing the overturning moment value and further reducing the risk of tilting of the optical lens 100.

It is worth mentioning that, in this embodiment, the support portion can be implemented as a component suitable for rolling or sliding, such as ball, roller, or slider.

Referring to FIGS. 2, 16, and 19, in some embodiments, the movable part 20 further comprises a friction portion 22. The friction portion 22 is disposed on the first movable sidewall 21 of the movable part 20 and faces the side where the friction head 32 is located. Thus, the friction head 32 of the piezoelectric actuator 30 is frictionally coupled to the friction portion 22 by the pre-pressing force action of the pre-pressing part 40. It can be understood that the friction portion 22 helps to increase the friction between the movable part 20 and the friction head 32 of the piezoelectric actuator 30, and further enhances the driving force provided by the piezoelectric actuator 30.

In some embodiments, the friction portion 22 may be integrally formed on the first movable sidewall 21 of the movable part 20, or the friction portion 22 and the movable part 20 may be treated as independent components, with the friction portion 22 attached to the first movable sidewall 21 of the movable part 20 by an adhesive, thus forming a separate structure from the movable part 20. It is understood that the provision of the friction portion 22 helps to enhance the frictional force between the movable part 20 and the friction head 32 of the piezoelectric actuator 30, which is beneficial to improving the driving performance in the camera module. Of course, the friction portion 22 may also be attached to the first movable sidewall 21 of the movable part 20 by spraying, plating, or other methods.

Referring to FIGS. 2, 5, 6, 16, and 19, in some embodiments, at least a portion of the bottom of the friction portion 22 and the movable part 20 maintains frictional contact with the piezoelectric actuator 30 and the first support part 61 respectively. Under the action of the pressing block 50, the first support part 61 provides an upward supporting force to the movable part 20 in the second direction, wherein the direction of the downward pressing force generated by the pressing block 50 is opposite to the direction of the supporting force. To further prevent the movable part 20 from tilting, a support part is provided between the fixed part 10 and the movable part 20 to provide support and guidance for the movable part 20 to move stably along the optical axis within the fixed part 10, thereby enhancing the stability of the optical lens 100 during optical focusing and/or optical zooming of the camera module, and thus improving the imaging quality of the camera module.

Understandably, in this application, the piezoelectric actuator 30 is located at the upper part of the friction portion 22 along the second direction and drives the movable part 20 at the top of the movable part 20. The pre-pressing part 40 provides a preload downward pressing force along the second direction at the top of the piezoelectric actuator 30, causing the friction head 32 to make frictional contact with the friction portion 22 of the movable part 20. The piezoelectric actuator 30 provides driving force to the movable part 20 to drive the movable part 20 to move along the optical axis. Furthermore, the first support part 61 located between the fixed part 10 and the movable part 20 provides a support force upward along the second direction to the movable part 20. The support force is opposite to the direction of the preload, which helps to prevent surface contact between the movable part 20 and the fixed part 10, which would further increase friction and hinder driving.

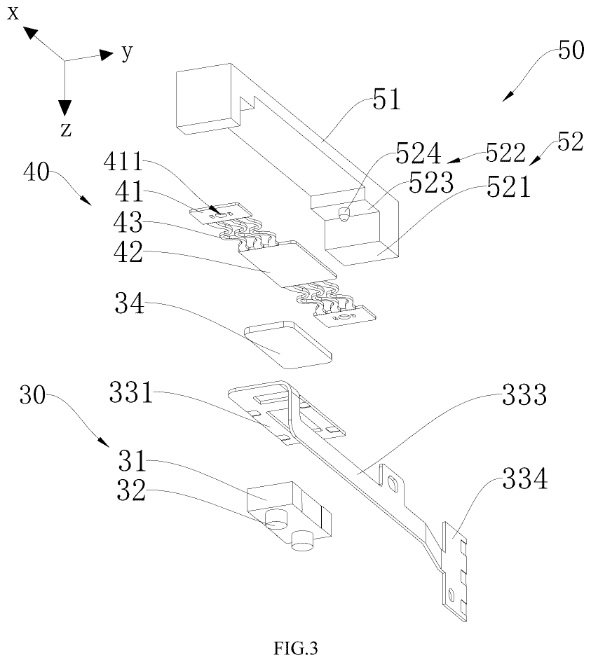

In some embodiments, as shown in FIG. 3, the pressing block 50 comprises a pressing beam 51 and two pressing arms 52. The pressing arms 52 are extended from two ends of the pressing beam 51 toward the fixed part 10 in the second direction, so that the pressing block 50 is fixed in the first receiving groove 112 of the fixed part 10. A groove 500 is provided between the pressing beam 51 and the pressing arms 52. The groove 500 is adapted to provide deformation space for the pre-pressed member 40. The pressing arm 52 comprises a pressing mounting platform 522 and a pressing fixing platform 521. The pressing fixing platform 521 is located outside the pressing mounting platform 522 along the optical axis. The length of the pressing fixing platform 521 along the second direction is greater than the length of the pressing mounting platform 522 along the second direction, so that the groove 500 is formed between the pressing mounting platform 522 and the pressing beam 51. The pre-pressing part 40 is installed on the pressing mounting platform 522, and the pressing fixing platform 521 is fixed to the fixed part 10. This further simplifies the assembly process, enhances the stability of the camera module, and improves the installation stability of the pre-pressing part 40, thereby enhancing the stability of the provided pre-pressing force.

In some embodiments, the first fixed sidewall 11 of the fixed part 10 further comprises a first sidewall body 115 and a base extension 114, wherein there are two base extensions 114 which are extended inward from the first sidewall body 115. A second receiving groove 113 is formed between the two base extensions 114, and a second mounting plane 1141 is formed on the top surface of each of the two base extensions 114. The two pressing fixing platforms 521 of the pressing block 50 abut against the two second mounting planes 1141 respectively. It is understood that the pressing arm 52 can be connected to the fixed part 10, and the two pressing fixing platforms 521 of the pressing arms 52 and the two second mounting planes 1141 of the fixed part 10 can abut against each other, further enhancing the stability and reliability of the pressing block 50. Since the pressing beam 51 and the pressing mounting platform 522 are located in different height planes, the formed groove 500 provides reserved space for the deformation generated by the pre-pressing part 40. Furthermore, by fixing the pressing block 50 to the fixed part 10, adjustments can be made during the assembly process, thereby reducing the risk of inconsistencies in assembly.

In some embodiments, as shown in FIGS. 3, 6, 17, 18, and 19, when the pre-pressing part 40 is subjected to the supporting force provided by the first support part 61, the pre-pressing part 40 undergoes an upward convex bending deformation and generates a pre-pressing force downward in the second direction, thereby providing a pre-pressing force downward in the second direction to the movable part 20. This causes the friction head 32 in the piezoelectric actuator 30 to rub against the movable part 20, further providing a stable driving force. It is understood that the flatness and consistency of the pre-pressing part 40 are relatively good, which helps to reduce the amount of variation in the pre-pressing part 40.

In some embodiments, the pre-pressing part 40 is an elastic element capable of deformation, thereby providing a pre-pressing force after deformation that drives the movable part 20 to maintain frictional contact with the piezoelectric actuator 30. Under the action of the pre-pressing, the friction head 32 in the piezoelectric actuator 30 contacts the friction portion 22 of the movable part 20 and generates friction, thereby driving the movable part 20 to move. Specifically, in one example, as shown in FIG. 5, the pre-pressing part 40 is a spring plate with a bent structure. After being supported by the first support part 61, the spring plate with the bent structure undergoes an upward convex bending deformation and generates a downward pre-pressing force. It is understood that since the pre-pressing part 40 will have certain tolerances during assembly, the spring plate with the bent structure is less affected by tolerance fluctuations within a certain preload range, resulting in higher consistency of the preload provided by the spring plate with the bent structure.

In some embodiments, as shown in FIGS. 3, 17, and 18, the pre-pressing part 40 comprises a fixed end 41, an elastic part 42, and a bending part 43. There are two fixed ends 41 and two bending parts 43. The two bending parts 43 are respectively disposed between the two fixed ends 41 and the elastic part 42, and respectively connect the elastic part 42 and the two fixed ends 41. The two fixed ends 41 are fixed to the pressing block 50. The elastic part 42 abuts against the piezoelectric active part 31. It is understood that a hollow structure can also be provided in the elastic part 42 and the bending part 43 to further reduce the elastic coefficient, thereby helping to reduce the influence of material tolerances, assembly tolerances, or other displacement fluctuations on the magnitude of the pre-pressing.

Furthermore, when the pre-pressing part 40 is a spring plate, as shown in FIG. 5, it can be bent during the manufacturing process to give it a certain deformation. Thus, during assembly, after the spring plate is installed with the piezoelectric actuator 30 and the pressing block 50, the deformation of the spring plate itself applies pre-pressing to the piezoelectric actuator 30 and the movable part 20. In other words, by pre-deforming the spring plate before subsequent assembly and fixing, a greater pre-pressing is applied to the movable part 20, which is beneficial for improving the driving effect.

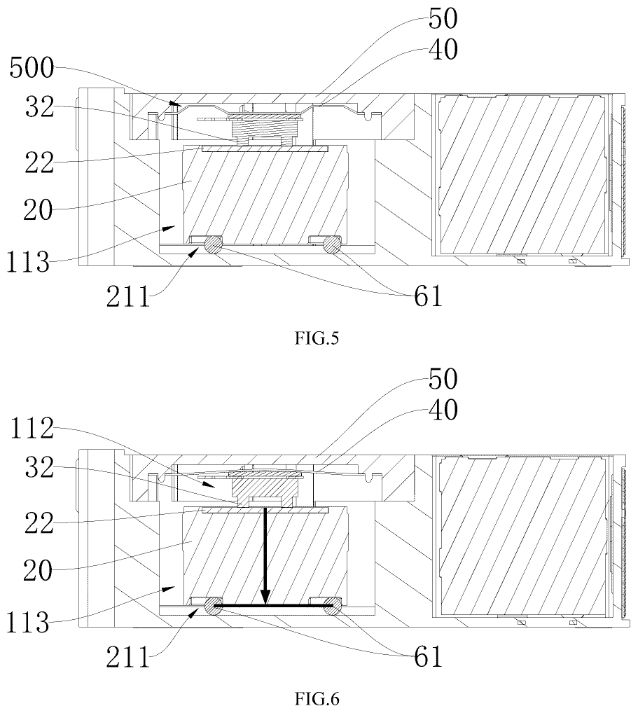

In some embodiments, as shown in FIGS. 6, 18, and 19, the pre-pressing part 40 has a planar spring plate structure. It is understood that before the piezoelectric actuator 30 is driven, the deformation of the pre-pressing part 40 is generated by the synergistic action of the pressing block 50 and the first support part 61. The pre-pressing part 40 comprises a fixed end 41 and an elastic part 42. The fixed end 41 is fixed to the pressing block 50, and the elastic part 42 abuts against the piezoelectric active part 31. When the pre-pressing part 40 is subjected to the supporting force of the pressing block 50 and the first support part 61, the elastic part 42 of the pre-pressing part 40 will undergo an upward convex bending deformation, generating a downward preload. The presence of the pre-pressing helps maintain frictional contact between the friction head 32 and the movable part 20 to generate a stable frictional force. The piezoelectric actuator 30 further drives the movable part 20 to move, enhancing the driving effect. It should be understood that, under the above circumstances, the middle part of the pre-pressing part 40 is higher than two ends and is protruded in a direction away from the piezoelectric actuator 30. That is, the elastic part 42 of the pre-pressing part 40 is higher than the fixed ends 41 at two ends.

In some embodiments, as shown in FIG. 6, the deformation of the pre-pressing part 40 is related to the length of the lower pressing arm 52 of the pressing block 50 along the second direction. In other words, given that the thickness of the first movable sidewall 21 of the movable part 20 and the thickness of the piezoelectric actuator 30 along the second direction are determined, the smaller the length of the lower pressing arm 52 along the second direction, the more the pressing block 50 needs to move further downward along the second direction to connect the lower pressing arm 52 with the fixed part 10. At this time, the pressing beam 51 exerts a stronger downward force on the first support part 61, resulting in a greater supporting force provided by the first support part 61 to the pre-pressing part 40, thereby increasing the deformation of the pre-pressing part 40 and further generating a greater pre-pressing force. Conversely, the larger the length of the lower pressing arm 52 along the second direction, the smaller the degree to which the pressing block 50 moves downward along the second direction, resulting in a smaller deformation of the pre-pressing part 40 and further reducing the generated pre-pressing force. Understandably, the set length of the pressing arm 52 along the second direction cannot be too small, so as to avoid generating excessive support force and preload, which could further damage the piezoelectric actuator 30, and may also cause the first support part 61 to be subjected to excessive preload, resulting in excessive compression and dents. In other words, the set length of the pressing arm 52 along the second direction cannot be too large either, to prevent the deformation of the pre-pressing part 40 from being too small when the length of the pressing arm 52 along the second direction is too large, thus providing less pre-pressing force to the movable part 20 and failing to meet the needs of driving the movable part 20 to move. On the other hand, increasing the set length of the pressing arm 52 along the second direction will increase the height of the camera module along the second direction, reducing the portability of the camera module.

In some embodiments, as shown in FIGS. 3 and 18, each pressing mounting platform 522 of the pressing block 50 is provided with a first mounting plane 523 and a mounting column 524. The mounting column 524 is protruded from the first mounting plane 523 toward the fixed end 41 of the pre-pressing part 40, so that the fixed end 41 of the pre-pressing part 40 is fixed below the first mounting plane 523 by the mounting column 524. The flat lower surface (first mounting plane 523) of the pressing mounting platform 522 helps to provide a flat mounting plane for the pre-pressing part 40, avoiding the phenomenon of inconsistent heights on the left and right sides of the pre-pressing part 40, and thus avoiding the phenomenon of increasing the variation of the pre-pressing part 40 and providing inconsistent pre-pressing force to the movable part 20. It should be understood that, for example, as shown in FIG. 18, the first mounting plane 523 being located on the lower surface of the pressing mounting platform 522 does not mean that the first mounting plane 523 is located on the lowest lower surface of the pressing mounting platform 522; the first mounting plane 523 can be a part of the stepped lower surface of the pressing mounting platform 522.

It is understood that the mounting columns 524 on two sides of the pressing mounting platform 522 correspond to fixing holes 411 on the fixing end 41 of the pre-pressing part 40. Therefore, during assembly, the mounting columns 524 can extend into the fixing holes 411, thereby fixing the pre-pressing part 40 to the pressing mounting platform 522. Specifically, during fixing, the mounting columns 524 can be directly riveted to the fixing holes 411, or adhesive can be applied to the surfaces of the fixing end 41 of the pre-pressing part 40 and the pressing mounting platform 522 for pre-fixation, and then the mounting columns 524 can be riveted to the fixing holes 411 for fixing. This further enhances the stability of the pre-pressing part 40 and the pressing block 50 during installation and use, which is beneficial for maintaining the stability of the provided pre-pressing force.

In some embodiments, the pre-pressing part 40 can be installed on the pressing block 50 first, and after the pressing block 50 is flipped over, the pressing arm 52 can be fixed to the first fixed side wall 11 of the fixed part 10. This further optimizes the assembly process of the pre-pressing part 40 and the pressing block 50, increases assembly efficiency, and reduces assembly difficulty. It should be understood that during the assembly process, the piezoelectric actuator 30 and the pre-pressing part 40 are first assembled into a semi-finished product, and then the piezoelectric actuator 30 is carried by the pre-pressing part 40 to the next assembly step. If the pre-pressing part 40 is directly assembled to the fixed part 10, it is necessary to ensure that the position of the friction head 32 of the piezoelectric actuator 30 and the movable part 20 are aligned at all times during the assembly process. Otherwise, after the assembly is completed, the friction contact position between the friction head 32 and the movable part 20 may be offset, which will affect the driving effect. Moreover, due to the characteristics of the pre-pressing part 40, it is also difficult to adjust the pre-pressing part 40 during the assembly process. Compared to the above method, the assembly method of first installing the pre-pressing part 40 onto the pressing block 50, then flipping the pressing block 50 and fixing the pressing arm 52 onto the fixed part 10 eliminates the need to keep the friction head 32 and the movable part 20 aligned during the assembly of the pre-pressing part 40, reducing the assembly difficulty. Moreover, after the pre-pressing part 40 is attached to the pressing block 50, the position and assembly between the pressing block 50 and the fixed part 10 can be adjusted to achieve the adjustment of the pre-pressing part 40, making it more adjustable.

It is worth mentioning that, in this application, as shown in FIGS. 3 and 18, the two fixed ends 41 of the pre-pressing part 40 are respectively provided with perforated hollow holes 412 located outside the fixing holes 411. Since there is a force interaction between the pre-pressing part 40 and the piezoelectric actuator 30, the hollow holes 412 can buffer and disperse stress, providing a buffering effect for the deformation of the pre-pressing part 40 and avoiding structural damage caused by stress concentration. Furthermore, the hollow holes 412 are symmetrically formed around the fixing holes 411. More specifically, the hollow holes 412 have an arc-shaped structure and are axially symmetrically formed around the fixing holes 411 with respect to the optical axis.

Furthermore, in this application, the pre-pressing part 40 can also be installed on the pressing block 50 by insert injection molding. For example, the two fixed ends 41 of the pre-pressing part 40 are at least partially fitted into the lower pressing mounting platform 522 of the two pressing arms 52 of the pressing block 50 to achieve the fixation of the pre-pressing part 40 and the pressing block 50.

As shown in FIG. 8, in some embodiments, two second guide grooves 211 are spaced apart on the bottom surface of the first movable sidewall 21 along the optical axis, and two second support grooves 231 are spaced apart on the bottom surface of the second movable sidewall 23 along the optical axis. The distance between the farthest endpoints of the two second guide grooves 211 is greater than the distance between the farthest endpoints of the two second support grooves 231.

Due to the pre-pressing force, the friction head 32 drives the friction portion 22 on the first movable sidewall 21. By increasing the length of the first movable sidewall 21 along the optical axis, the length of the friction portion 22 on the first movable sidewall 21 along the optical axis is also increased, thereby increasing the travel of the movable part 20. Furthermore, the piezoelectric actuator 30 and the first support part 61 are co-located on the first movable sidewall 21. Since both the piezoelectric actuator 30 and the pre-pressing part 40 are extended along the optical axis, the corresponding first movable sidewall 21 also needs to extend along the optical axis. In other words, the first movable sidewall 21 has a certain length along the optical axis. Therefore, there is more space on the bottom side of the first movable sidewall 21 to accommodate the first support part 61. To further improve the structural balance, the distance between the first support parts 61 can be appropriately increased. Specifically, the second guide groove 211 and the second support groove 231 can be circular, rectangular, hemispherical, U-shaped, V-shaped, pyramidal, etc.

In some embodiments, two second guide grooves 211 are spaced apart along the optical axis on the bottom surface of the first movable sidewall 21, the first support part 61 is installed in the second guide grooves 211 and the first guide groove 111, and two second support grooves 231 are spaced apart along the optical axis on the bottom surface of the second movable sidewall 23, which is suitable for the second support part 62 to be installed in the second support grooves 231 and the first support groove 131, which helps to improve the installation stability of the support and optimize the assembly process.

Furthermore, since the support structure is assembled inside the guide groove structure, as the distance between the two second guide grooves 211 increases, the distance between the two support parts of the first support part 61 assembled in the two second guide grooves 211 also increases, thereby making the support area formed by the line connecting the first support part 61 and the second support part 62 larger, thereby reducing the risk of the movable part 20 tilting during movement.

In some embodiments, as shown in FIG. 6, along the second direction, the line connecting the projection of the friction portion 22 with the projection of the farthest endpoints of the two second guide grooves 211 overlaps with each other, and the line connecting the projection of the friction portion 22 with the projection of the two support parts of the first support part 61 overlaps with each other. This helps to suppress the risk of the movable part 20 tipping over in the left-right and front-back directions. Therefore, by increasing the distance between the two support parts of the first support part 61, a larger support area is provided for the movable part 20, and a stable support force is provided throughout the entire movement stroke of the movable part 20, reducing the possibility of the movable part 20 tipping over in the front-back direction. In other words, the length of the friction portion 22 along the optical axis is less than the distance between the farthest endpoints of the two second guide grooves 211 along the optical axis.

In some embodiments, each of the first support part 61 and the second support part 62 comprises two balls for providing a stable supporting force to the movable part 20. Further, each ball is disposed within a single guide groove to avoid interference between the two balls. It is understood that the greater the distance between the two balls spaced apart along the optical axis in the first support part 61 and the second support part 62, the more stable the supporting force provided to the movable part 20, further enhancing the stability and reliability of the optical lens 100. When the distance between the two balls in the first support part 61 is greater than the distance between the two balls in the second support part 62, the area of the support surface formed by the ball assembly is increased, thereby increasing the stability of the optical lens 100.

In some embodiments, the projection of the friction head 32 of the piezoelectric actuator 30 along the second direction overlaps with the projection of the line connecting the first support part 61 along the second direction, further reducing the overturning moment value and reducing the risk of overturning of the movable part 20.

In some embodiments, the piezoelectric actuator 30 has two friction heads 32 which are spaced apart along the optical axis on the piezoelectric active part 31. The distance between the two friction heads 32 of the piezoelectric actuator 30 is smaller than the distance between the two support portions of the first support part 61, which helps to reduce the deviation of the pre-pressing and further makes the pre-pressing force evenly distributed on the two support portions of the first support part 61, reducing wear and damage to the first support part 61 caused by uneven pre-pressing. Furthermore, when the piezoelectric active part 31 causes the friction heads 32 to move by generating vibration deformation, the angle of contact between the friction heads 32 and the movable part 20 changes with the movement. This causes the force generated between the friction heads 32 and the movable part 20 to not always be parallel to the optical axis. The direction of the force may have a certain tilt angle with respect to the plane where the first movable sidewall 21 of the movable part 20 is located. At this time, the tilted force may further cause the movable part 20 to tilt. Therefore, the larger the distance between the two support parts of the first support part 61, the larger the support area of the movable part 20 can be, thereby reducing the overturning moment value and further reducing the risk of tilting of the movable part 20.

In some embodiments, the imaginary line of the direction of the pre-pressing force applied to the movable part 20 intersects with the line connecting the first support part 61, which helps to reduce the overturning moment value and further reduce the risk of tilting of the movable part 20.

In some embodiments, the position of the friction head 32 of the piezoelectric actuator 30 acting on the first movable sidewall 21 is aligned with the cross-sectional center of the first support part 61 in the second direction. This arrangement facilitates the stable and direct application of pre-pressing force by the pre-pressing part 40 onto the first support part 61, increasing the stability of pre-pressing force transmission and reducing errors caused by misalignment of components, thereby improving the reliability of the camera module. Furthermore, this alignment helps reduce excessive local wear on the first support part 61, extending the service life of the camera module while reducing the overturning moment value, further reducing the risk of tilting of the optical lens 100.

In the modified embodiment shown in FIG. 22, the first movable sidewall 21 has one second guide groove 211, and the second movable sidewall 23 has one second support groove 231. The length of the second guide groove 211 along the optical axis is greater than the length of the second support groove 231 along the optical axis. It should be understood that the larger length of the second guide groove 211 along the optical axis allows for a greater number of support portions of the first support part 61 provided in the second guide groove 211, thereby increasing the support area formed by the line connecting the first support part 61 and the second support part 62, thus reducing the risk of tilting of the movable part 20 during movement.

Furthermore, in this modified embodiment, as shown in FIG. 19, when viewed along the second direction, the projections of the friction heads 32 of the piezoelectric actuator 30 all fall on the second guide groove 211 in the optical axis direction. More specifically, when viewed along the second direction, the projections of the friction heads 32 of the piezoelectric actuator 30 all fall on the first support part 61 in the optical axis direction. This reduces the risk of overturning of the movable part 20 and also helps to evenly distribute the preload on the first support part 61, reducing wear and damage to the first support part 61 caused by uneven pre-pressing. More specifically, the piezoelectric actuator 30 has two friction heads 32 which are spaced apart along the optical axis direction on the piezoelectric active part 31. The distance between the two friction heads 32 can be greater than the dimension of any one support portion of the first support part 61 in the optical axis direction. When viewed along the second direction, the projections of the two friction heads 32 all fall on the first support part 61 in the optical axis direction. Therefore, in some cases, when viewed along the second direction, the projections of all the friction heads 32 of the piezoelectric actuator 30 fall entirely on the first support part 61 in the optical axis direction.

Accordingly, in this modified embodiment, when viewed along the second direction, the projection of the friction portion 22 overlaps with the projection of the second guide groove 211, so that during the movement stroke of the movable part 20, the projection of the friction head 32 can fall on the first support part 61. More specifically, the length of the friction portion 22 along the optical axis is less than the length of the second guide groove 211 along the optical axis.

In some embodiments, referring to FIGS. 8, 9, and 22, the first support part 61 and the second support part 62 are components that can be independently formed with respect to the movable part 20 and the pressing block 50. Furthermore, the first support part 61 can be a multi-point structure spaced apart along the optical axis, such as a ball or a slider. The second support part 62 can be a multi-point structure or a guide rail structure spaced apart along the optical axis, such as a ball, a slider, or a guide rod. When a guide rod is used as a support component, its better linearity can increase the smoothness and reliability of the movable part 20 when driven to move, further reducing the tilting or overturning phenomenon of the optical lens 100. Specifically, the second support groove 231 equipped with the second support part 62 can be trapezoidal, rectangular, or V-shaped, etc.

Understandably, when the first support part 61 uses balls as its support structure and the second support part 62 uses a guide rod as its support structure, the downward pressing force exerted on the second support part 62 in the second direction is mainly due to the magnetic attraction force provided by a magnetic attraction assembly 70 which is less than the pre-pressing force on the first support part 61. The force on the first support part 61 comprises the magnetic attracting force provided by the magnetic attraction assembly 70 and the pre-pressing force provided by the pre-pressing part 40. This reduces the frictional force generated by the surface contact of the second support part 62, thereby reducing the power consumption of the piezoelectric actuator 30. On the other hand, if the first support part 61 uses a guide rod as its support structure, the large frictional force generated by the surface contact of the guide rod structure, which has a large coefficient of friction due to the large pressure, will affect the driving effect of the piezoelectric actuator 30. Understandably, when using balls as the support structure, the balls contact the guide rail and guide groove using point contact, resulting in minimal rolling friction and large sliding friction, which is beneficial for driving the movable part 20.

In some embodiments, the first support part 61 and the second support part 62 are configured as hemispherical structures fixed to the fixed part 10 and/or the movable part 20, or they may be bosses. Using point contact friction helps to reduce wear on the guide groove or guide rail structure and extend the service life of the camera module.

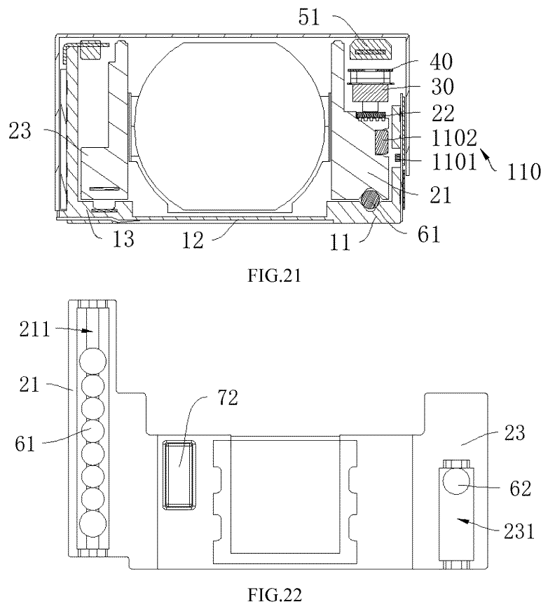

In some embodiments, as shown in FIGS. 9, 10, 20, and 22, the driving arrangement further comprises the magnetic attraction assembly 70. The magnetic attraction assembly 70 comprises a first magnetic attracting element 71 and a second magnetic attracting element 72. The first magnetic attracting element 71 is disposed on the main body of the fixed part 10, and the second magnetic attracting element 72 is disposed on the bottom of the movable part 20. The first magnetic attracting element 71 and the second magnetic attracting element 72 are disposed opposite each other along the second direction and interact to generate a magnetic attracting force. This magnetic attracting force causes the movable part 20 and the fixed part 10 to clamp the first support part 61 and the second support part 62. Referring to FIGS. 9 and 10, along the first direction, the distance from the second magnetic attracting element 72 to the second support part 62 is less than the distance from the second magnetic attracting element 72 to the first support part 61, and the directions of the magnetic attraction force and the preload are the same. Specifically, the second magnetic attracting element 72 is disposed on the second movable sidewall 23 of the movable part 20, and the first magnetic attracting element 71 is disposed on the second fixed sidewall 13 of the fixed part 10. The first magnetic attracting element 71 and the second magnetic attracting element 72 are arranged opposite each other along the second direction and generate magnetic attraction through interaction. Referring to FIGS. 20 and 21, along the first direction, the distance from the second magnetic attracting element 72 to the second support part 62 is greater than the distance from the second magnetic attracting element 72 to the first support part 61, and the magnetic attraction and pre-pressing force have the same direction. Specifically, the second magnetic attracting element 72 is disposed on the first movable sidewall 21 of the movable part 20, and the first magnetic attracting element 71 is disposed on the first fixed sidewall 11 of the fixed part 10. The first magnetic attracting element 71 and the second magnetic attracting element 72 are arranged opposite each other along the second direction and generate magnetic attraction through interaction. Since the direction of the magnetic attraction is the same as the direction of the pre-pressing force, the pre-pressing force and the magnetic attraction are superimposed, and when the magnetic attraction is insufficient to resist external forces, the pre-pressing force can provide additional support. Furthermore, since the magnetic attraction assembly 70 is located at the bottom of the movable part 20 and the piezoelectric actuator 30 is located at the top of the movable part 20, the movable part 20 can be supported by only setting a support part at the bottom of the movable part 20, further reducing the number of positions that need to be set in the camera module.

Understandably, since the magnetic attraction assembly 70 is located at the bottom of the movable part 20, the first movable sidewall 21 is subjected to pre-pressing force, and the movable part 20 tends to tilt. Therefore, a magnetic attracting force is needed to reduce the risk of tilting of the movable part 20. The magnetic attracting force and the pre-pressing force are in the same direction, along the first direction. The point of application of the magnetic attracting force and the point of application of the pre-pressing force on the movable part 20 are located on two sides of the optical axis. This helps to ensure that the movable part 20 is tightly attached to the fixed part 10, enhancing the stability of the camera module. Furthermore, the magnetic attracting force and the pre-pressing force work together to further balance the forces on the movable part 20, helping to reduce the tilting of the optical lens 100 caused by torque imbalance.

In some embodiments, as shown in FIGS. 9 and 10, the second magnetic member 72 is disposed in the middle region between the two second support grooves 231 along the optical axis to reduce the overturning moment value and further reduce the risk of tilting of the movable part 20.

In some embodiments, as shown in FIG. 10, the first magnetic attracting element 71 is a metal magnetic yoke. The first magnetic attracting element 71 comprises a base portion 711 and a support portion 712. The projection of at least a portion of the base portion 711 along the second direction overlaps with the projection of the second magnetic attracting element 72 along the second direction, and the projection of at least a portion of the support portion 712 along the second direction overlaps with the projection of the second support part 62 along the second direction. By providing the first magnetic attracting element 71, on the one hand, the effect of magnetic attraction is enhanced, the pre-pressing is better balanced, and the risk of overturning of the movable part 20 is reduced; on the other hand, the magnetic attraction makes the support portion stably clamped between the movable part 20 and the fixed part 10, improving the stability of the support portion and thus improving the imaging quality of the camera module.

In some embodiments, the base portion 711 and the support portion 712 of the first magnetic attracting element 71 are integrally connected, which improves the convenience of processing and increases processing efficiency. Furthermore, the base portion 711 and the support portion 712 can be a separate structure, which helps to improve the flatness of the base portion 711, but when the area of the base portion 711 is too large, deformation is likely to occur.

In some embodiments, the support portion 712 may be V-shaped or planar according to the shape of the first guide groove 111 and the first support groove 131, and is disposed on the lower side of the first support part 61 and/or the second support part 62 along the second direction, so as to avoid pits in the first support part 61 and the second support part 62, and further improve the quality of use and service life of the camera module.

Further, as shown in FIGS. 20 and 22, the second magnetic attracting element 72 is fixed to the movable part 20, and the first magnetic attracting element 71 is fixed to the fixed part 10. The second magnetic attracting element 72 and the first magnetic attracting element 71 are arranged opposite each other along the second direction and generate magnetic attraction through their interaction. The distance between the second magnetic attracting element 72 and the first support part 61 in the first direction is less than the distance between the second magnetic attracting element 72 and the second support part 62 in the first direction; that is, in the first direction, the second magnetic attracting element 72 is closer to the first support part 61 than the second support part 62. Since the dimension of the first support part 61 in the optical axis direction is larger than the dimension of the second support part 62 in the optical axis direction, bringing the second magnetic attracting element 72 closer to the first support part 61 ensures that the magnetic attraction generated by the magnetic attraction assembly 70 is relatively large from each side of the support plane formed by the first support part 61 and the second support part 62, thereby reducing the risk of the movable part 20 tipping over with respect to the fixed part 10.

In some embodiments, the piezoelectric actuator 30 further comprises an electric conductive component 33 disposed between the piezoelectric active part 31 and the pre-pressing part 40, as shown in FIGS. 3 and 15 to 19. The electric conductive component 33 comprises a first connecting part 331, a second connecting part 333, and an electrical conductive part 334. Referring to the embodiment shown in FIG. 3, the first connecting part 331 is a horizontal plate disposed along the second direction between the piezoelectric active part 31 and the pre-pressing part 40 of the piezoelectric actuator 30. The second connecting part 333 is a vertical plate integrally bent along the second direction from the first connecting part 331. The electrical conductive part 334 is extended from the second connecting part 333 along the outer peripheral wall of the fixed part 10 in the optical axis direction and is connected to a conductor 14 disposed on the fixed part 10. In the embodiment shown in FIGS. 15 to 19, the first connecting part 331 is a horizontal plate disposed along the second direction between the piezoelectric active part 31 and the pre-pressing part 40 of the piezoelectric actuator 30. The first connecting part 331 may have a through hole to reduce the influence of the electric conductive component 33 on the piezoelectric active part 31. The second connecting part 333 is a vertical plate integrally bent along the second direction from the first connecting part 331. The electrical conductive part 334 is extended along the outer peripheral wall of the fixing portion 10 from the second connecting part 333 in the second direction and is connected to the conductor 14 provided on the fixing portion 10. Specifically, the second connecting part 333 comprises a first sub-connecting portion 3331 and a second sub-connecting portion 3332. The first sub-connecting portion 3331 and the second sub-connecting portion 3332 are respectively connected from two ends of the first connecting part 331 along the optical axis and integrally bent towards the second direction. Then, the other ends of the first sub-connecting portion 3331 and the second sub-connecting portion 3332 are respectively connected to the electrical conductive part 334 in the second direction. The electric conductive component 33 can increase the space utilization inside the camera module and achieve electrical conduction.

Furthermore, the electric conductive component 33 further comprises two shaping components 335 that are respectively fixed to the outside of the bends of the first sub-connecting portion 3331 and the second sub-connecting portion 3332. The shaping components 335 are used to maintain the bent state of the first sub-connecting portion 3331 and the second sub-connecting portion 3332. The shaping components 335 can be made of materials such as plastic or metal.

In some embodiments, the friction head 32 in the piezoelectric actuator 30 can directly contact the first movable sidewall 21 of the movable part 20 which does not have a friction portion 22, thereby reducing the weight of the movable part 20 and further reducing the resistance that needs to be overcome to drive the movable part 20.

Referring to FIGS. 1, 4, 15, and 16, in some embodiments, the circuit components in the camera module, in addition to the flexible circuit board, also include a conductor 14 disposed around the outer peripheral wall of the fixed part 10. Specifically, the conductor 14 is embedded in or externally disposed on the first fixed side wall 11 and the second fixed side wall 13, with at least a portion of the conductor 14 exposed on the outer peripheral side of the fixed part 10. The conductor 14 is provided with a conductor portion 141, and the conductor 14 is welded to the electrical conductive part 334 through the conductor portion 141 to achieve electrical conduction. Furthermore, the conductor 14 enables the conduction of the circuit parts of the photosensitive assembly 80, the light deflection element 90, and other circuit modules through a simple electrical connection. The conductor 14 with a bent structure, as shown in FIGS. 2 and 15, is easy to connect, adapts to complex spatial layouts and shape requirements, and further enables efficient wiring design in narrow or irregular spaces, thereby improving space utilization.

Furthermore, one of the first magnetic attracting element 71 and the second magnetic attracting element 72 is a magnet, and the other is a magnet or yoke suitable for attracting the magnet. The magnet or yoke can be fixed by means of adhesion, insert injection molding, riveting, etc. Since the first movable sidewall 21 and the second movable sidewall 23 of the movable part 20 are subjected to pre-pressing and magnetic attraction force respectively, and the direction of the magnetic attraction force is the same as the direction of the pre-pressing force, it helps to reduce the risk of tilting of the movable part 20. Specifically, the pre-pressing force can be greater than the magnetic attraction force, because when the magnetic attraction force is too large, the frictional resistance that the movable part 20 needs to overcome when driving the movement will also be greater, further increasing the power consumption of the piezoelectric actuator 30, which is not conducive to the driving of the movable part 20.

In some embodiments, the first magnetic attracting element 71 is a magnet, and the second magnetic attracting element 72 is an insert-molded magnetic yoke, which can also be used as a conductor 14 to simplify the structure. Specifically, the magnetic yoke is designed with metal strip and is cut and shaped after manufacturing; this mass production method can further improve production efficiency. Furthermore, the magnetic yoke used in this application has a large planar area; increasing the metal pressing area during manufacturing can increase the planar regularity. Furthermore, the magnetic yoke can be made of a material that attracts magnets, such as metal, to further enhance the magnetic attraction and thus improve the stability of the optical lens 100.

In some embodiments, the magnetic attraction assembly 70 further comprises a first magnetic attracting element 71 and a second magnetic attracting element 72. The first magnetic attracting element 71 located on the movable part 20 and the second magnetic attracting element 72 disposed on the fixed part 10 interact and generate a magnetic attraction force. Therefore, when the movable part 20 is driven along the optical axis, the magnetic attraction force generated by the magnetic attraction assembly 70 can ensure that the movable part 20 is always supported by the support part during the long stroke of the movable part 20, and the movable part 20 will not tilt to a large extent. Furthermore, the magnetic attraction force generated by the magnetic attraction assembly 70 located on the second movable sidewall 23 is consistent with the direction of the pre-pressing force generated by the pre-pressing part 40 on the first movable sidewall 21, which helps to improve the fit between the movable part 20 and the fixed part 10, further reducing the tilting phenomenon of the movable part 20 due to torque imbalance, and further reducing the risk of the optical lens 100 tilting.

In some embodiments, as shown in FIGS. 2, 3, 16, 17, 18, and 19, as previously described, the piezoelectric actuator 30 comprises a piezoelectric active part 31, a friction head 32, and an electric conductive component 33. The piezoelectric actuator 30 abuts against the movable part 20 under pre-pressing force. Specifically, the friction head 32 is disposed on the side of the piezoelectric active part 31 facing the first movable sidewall 21. The piezoelectric active part 31 generates mechanical resonant motion through the inverse piezoelectric effect. When the frequency of the applied voltage matches the natural frequency of the piezoelectric active part 31, resonance occurs, generating ultrasonic waves. Therefore, oscillating reciprocating motion or elliptical motion can be achieved on a specifically configured electrode layer, thereby driving the friction head 32 to perform oscillating reciprocating motion or elliptical motion. Furthermore, through the friction between the friction head 32 and the first movable sidewall 21, the movable part 20 is driven to slide with respect to the fixed part 10.

Referring to FIGS. 2, 3, 16, 17, 18, and 19, in some embodiments, the piezoelectric actuator 30 further comprises a buffer component 34 disposed between the pre-pressing part 40 and the piezoelectric active part 31. Since the elastic modulus of the buffer component 34 is lower than that of the pre-pressing part 40, the buffer component 34 is more prone to deformation. This allows it to adaptively generate different degrees of shrinkage deformation according to the different tolerances in different piezoelectric actuators 30, thereby reducing the preload difference between piezoelectric actuators 30 with different tolerances. In other words, the deformable buffer component 34 can offset at least part of the preload changes caused by material and assembly tolerances, absorb some deformation of the piezoelectric active part 31, and absorb some vibration deformation of the piezoelectric active part 31 to stably maintain the parallelism of the piezoelectric active part 31 with respect to the first movable sidewall 21, further protecting the piezoelectric actuator 30 from excessive mechanical stress. It is worth mentioning that, in one specific example, the buffer component 34 is disposed between the elastic part 42 and the piezoelectric active part 31 of the pre-pressing part 40.

It is understood that the buffer component 34 can be an adhesive tape, with one surface flatly bonded to the pre-pressing part 40, and the opposite surface bonded to the piezoelectric active part 31 or components below the piezoelectric active part 31. Furthermore, the adhesive tape is easy to install and use, requiring no curing while maintaining good flatness, which helps maintain the parallelism of the piezoelectric active part 31 with respect to the first movable sidewall 21. The size of the buffer component 34 can be less than, equal to, or greater than the size of the piezoelectric active part 31, such that the buffer component 34 fills the space between the piezoelectric active part 31 and the pre-pressing part 40. Similarly, this application does not need to limit the specific shape and number of the buffer component 34; for example, two pieces of adhesive tape can be stacked as the buffer component 34, or two pieces of adhesive tape can be spaced apart along the second direction. Preferably, the size of the buffer component 34 is larger than the size of the piezoelectric active part 31, so that the area between the piezoelectric active part 31 and the pre-pressing part 40 is completely filled by the buffer component 34, which helps ensure the structural strength of the pre-pressing part 40 connection and enhances the installation parallelism provided to the piezoelectric active part 31.

Specifically, the buffer component 34 can also be a low-modulus adhesive disposed on the surface of the piezoelectric active part 31. In other words, since the buffer component 34 can be attached between the pre-pressing part 40 and the conductive part 33, it not only has the advantage of easy assembly, but also avoids the problem of affecting the vibration mode of the piezoelectric active part 31 after using adhesives such as UV glue or thermosetting glue to bond the pre-pressing part 40.

Further, as shown in FIGS. 16, 17, 18, and 19, the pre-pressing part 40 further comprises a mounting part 44 which is disposed between the elastic part 42 and the buffer component 34. The mounting part 44 is fixed to the elastic part 42, thereby fixing the elastic part 42 to the buffer component 34 via the mounting part 44. The mounting part 44 facilitates the fixing of the pre-pressing part 40 to the piezoelectric actuator 30, provides a flat mounting surface for the piezoelectric actuator 30, and allows adjustment of the height of the elastic part 42 in the second direction by adjusting the thickness of the mounting part 44, thereby adjusting the magnitude of the pre-pressing force provided by the pre-pressing part 40. Specifically, the mounting part 44 can be fixed to the elastic part 42 first, and then fixed to the piezoelectric actuator 30; alternatively, the mounting part 44 can be fixed to the piezoelectric actuator 30 via the buffer component 34 first, and then fixed to the elastic part 42. Of course, fixing the pre-pressing part 40 to the elastic part 42 first improves the convenience of fixing the pre-pressing part 40 to the piezoelectric actuator 30, and also creates a flat mounting surface for the pre-pressing part 40. Here, the mounting part 44 and the elastic part 42 can be fixed by adhesive bonding, insert injection molding, riveting, etc. For example, in the modified embodiment shown in FIGS. 16 and 19, the mounting part 44 has two connecting posts 441 protruding towards the elastic part 42, and the elastic part 42 has two corresponding connecting holes 421, so that the two connecting posts 441 pass through the two connecting holes 421 respectively, and are then fixed by riveting. Here, the use of connecting posts 441 and connecting holes 421 not only facilitates positioning, but also allows the connecting posts 441 to protrude through the connecting holes 421 and out of the elastic part 42, thereby enabling the connecting posts 441 to protect the elastic part 42 and prevent the elastic part 42 from directly impacting the pressing block 50.

As shown in FIGS. 2, 3, 16, and 17, in some embodiments, the piezoelectric active part 31 is a substrate utilizing the inverse piezoelectric effect, which contracts or expands according to changes in the polarization direction and the electric field direction. This effect means that when an electric field is applied in the polarization direction of the dielectric, the dielectric will undergo mechanical deformation, thereby enabling the piezoelectric active part 31 to achieve polarization by applying an electric field to materials such as single crystals, polycrystalline ceramics, and polymers, thereby generating ultrasonic oscillations. This oscillation can generate oscillating reciprocating motion or elliptical motion on a specifically configured electrode layer, thereby driving the friction head 32 to perform corresponding movements. It can be understood that the frictional force between the friction head 32 and the outer wall of the movable part 20 can drive the movable part 20 to move with respect to the fixed part 10; therefore, the driving force is actually the frictional force between the friction head 32 and the movable part 20.

In one specific embodiment of this application, the piezoelectric active part 31 adopts a multi-layer stacked structure. Specifically, the piezoelectric active part 31 is formed by alternating stacking of ceramic layers and electrode layers in the thickness direction, in the order of ceramic layer, electrode layer, ceramic layer, electrode layer . . . ceramic layer, electrode layer, ceramic layer. Each electrode layer is located between two adjacent ceramic layers. When an electric field is applied between adjacent electrode layers, the ceramic layer will undergo elongation or contraction deformation. By setting multiple electrode layers, the voltage required to drive the piezoelectric active part 31 to perform bending vibration can be reduced. The number of electrode layers and ceramic layers can be selected according to specific needs. In other words, for example, the number of ceramic layers can be greater than or equal to the number of electrode layers. The ceramic layers are usually made of materials with piezoelectric effect, such as PZT piezoelectric ceramics; while the electrode layers are made of conductive materials, such as copper, gold, silver, or silver alloys. The fixation between the multiple ceramic layers and the multiple electrode layers can be achieved by a ceramic co-firing process, that is, laying a layer of ceramic slurry, then laying a layer of electrode slurry, and then heating and sintering them together to form the stacked piezoelectric active part 31. Furthermore, by providing a power source to the multilayer electrode layers, the multilayer ceramic layers disposed between the multilayer electrode layers can be polarized.

It is understandable that the side electrical connection part in the camera module is connected to the positive voltage and negative voltage of the power supply respectively, thereby providing at least one electrode layer with positive voltage and at least one electrode layer with negative voltage, thereby polarizing the multilayer ceramic layer. The piezoelectric ceramics after polarization will automatically align in the piezoelectric direction, further generating the piezoelectric effect.

In some embodiments, to improve the driving performance of the piezoelectric actuator 30, the piezoelectric active part 31 may be made of piezoelectric ceramic material or piezoelectric single crystal material. The piezoelectric active part 31 may be a single-layer ceramic body or a multi-layer ceramic body, or a single-layer single crystal or a multi-layer single crystal, such as lead zirconate titanate (PZT) based piezoelectric ceramics, potassium sodium niobate (KNN) based piezoelectric ceramics, barium titanate (BT) based piezoelectric ceramics, lead magnesium niobate-lead indium niobate (PMN-PT) based piezoelectric single crystals, etc.

In some embodiments, the piezoelectric active part 31 is rectangular in shape along the optical axis. A friction head 32 protrudes from the piezoelectric active part 31 on the side facing the movable part 20 along the second direction. Specifically, two friction heads 32 are provided, spaced apart along the optical axis. It can be understood that the piezoelectric actuator 30 drives the movable part 20 to move along the optical axis. Compared to having only a single protruding friction head 32 to drive the movable part 20, having two friction heads 32 working together improves the effect of driving the movable part 20 to perform long-stroke movements.

In some embodiments, the friction head 32 is made of wear-resistant materials, such as various high-hardness wear-resistant ceramic materials, like alumina, zirconium oxide, silicon carbide ceramics, or high-wear-resistant metal materials, carbon fiber materials, or composite materials of ceramics, metal particles, and polymers. This improves the wear resistance of the friction head 32 and enhances the friction between the movable part 20 and the friction head 32, further strengthening the driving force provided by the piezoelectric actuator 30. Furthermore, the good wear resistance helps extend the service life of the friction head 32. In some embodiments, the friction head 32 and the piezoelectric active part 31 can be an integral structure or a detachable structure. The friction head 32 and the piezoelectric active part 31 can be fixed to the piezoelectric active part 31 by means of bonding, snap-fitting, nesting, welding, or fastener connection, ensuring that the connection strength is guaranteed through surface contact. Simultaneously, the friction head 32 can generate significant movement with the deformation of the piezoelectric active part 31.

In some embodiments, the piezoelectric active part 31 undergoes bending vibration along the second direction in a mode with one crest and one trough. Since the position of the friction head 32 can match the mode of the piezoelectric active part 31, the friction head 32 can be positioned at the crest and trough of the mode at the corresponding location. It is understood that the shape of the friction head 32 can be a sphere, hemisphere, cuboid, frustum, cylinder, semi-cylinder, etc. The number of friction heads 32 can be one, two, or more. In this application, no specific limitations are placed on the shape or number of friction heads 32, the shape or electrode arrangement of the piezoelectric active part 31, or the connection method between the friction head 32 and the piezoelectric active part 31.

In some embodiments, the driving arrangement further comprises a position sensing assembly 110 for sensing and controlling the movement position of the movable part 20. The position sensing assembly 110 is disposed on the side of the movable part 20 to make reasonable use of the space of the camera module and increase the compactness of the structure. Further, the position sensing assembly 110 comprises a position sensing magnet 1102 and a position sensing element 1101, wherein the position sensing magnet 1102 is fixed to the movable part 20, and the position sensing element 1101 is fixed to the fixed part 10, so that when the distance between the position sensing magnet 1102 and the position sensing element 1101 changes, the magnetic field of the position sensing magnet 1102 obtained by the position sensing element 1101 changes, thereby obtaining position change information of the position sensing magnet 1102 and the movable part 20 with respect to the fixed part 10. It is worth mentioning that the position sensing element 1101 can be a Hall element, an integrated circuit driver (driver IC), a tunnel magnetoresistive (TMR) or other position sensing elements.

Referring further to FIG. 21, in this modified embodiment, the position sensing assembly 110 and the piezoelectric actuator 30 are disposed on the same side of the movable part 20, that is, on the side where the first movable sidewall 21 is located. This allows the position sensing assembly 110 to better acquire position change information of the movable part 20, achieving better drive control. Specifically, the position sensing magnet 1102 is fixed to the first movable sidewall 21, and the position sensing magnet 1102 is located below the piezoelectric actuator 30. The position sensing element 1101 is fixed and electrically connected to the conductor 14, thereby fixing the position sensing element 1101 to the fixed part 10 via the conductor 14. More specifically, the position sensing element 1101 is located diagonally opposite the position sensing magnet 1102 to provide better position sensing effect. Viewed along the first direction, the position sensing element 1101 and the position sensing magnet 1102 do not overlap at least partially. Further, the position sensing element 1101 is located diagonally below the position sensing magnet 1102.

Furthermore, the driving arrangement further comprises a top cover 120 which is fixed above the fixed part 10 and forms a receiving cavity to accommodate other components of the drive unit.

In some embodiments of this application, as shown in FIG. 1, the camera module further comprises an optical system. Since the fixed part 10 is a frame, the optical system is assembled inside the fixed part 10. The optical system comprises a light deflection element 90, an optical lens 100, and a photosensitive assembly 80 arranged sequentially along the optical axis. The optical lens 100 is disposed on the light conversion path of the light deflection element 90, and the photosensitive assembly 80 is used to receive the light transmitted from the optical lens 100 and form an image. Specifically, the light-emitting direction of the light deflection element 90, the axial direction of the optical lens 100, and the normal of the photosensitive assembly 80 are all arranged along the optical axis. The light deflection element 90 is located inside the fixed part 10 near the light incident side, the optical lenses 100 are all located in the central region inside the fixed part 10, and the photosensitive assembly 80 is located inside the fixed part 10 away from the light incident side. The camera module provided by this application has the characteristics of easy assembly and good pre-pressing force consistency within the camera module.

In some embodiments of this application, the light deflection element 90 has an incident surface and an exit surface that intersect, and the light deflection element 90 changes the propagation direction of light to fold the optical path. The optical lens 100 extends along the optical axis and has a lens mounting hole, with at least one optical lens distributed within the lens mounting hole along the optical axis, thereby achieving the focusing effect of the optical lens 100 on light. After receiving the focused light, the photosensitive assembly 80 converts the received light signal into an electrical signal for imaging processing.

In some embodiments, the number of optical lenses 100 can be two, wherein one optical lens 100 can be fixed, and the other optical lens 100 can be driven and moved along the optical axis to achieve optical focusing and optical zoom functions. Of course, in this example, both optical lenses 100 can also be driven to move along the optical axis to achieve optical focusing and optical zoom functions. Further, the number of optical lenses 100 can be three, wherein two optical lenses 100 can be fixed, and the other optical lens 100 can be driven to move along the optical axis to achieve optical focusing and optical zoom functions. Of course, in this example, one optical lens 100 can be fixed, and the other two optical lenses 100 can be driven to move along the optical axis to achieve optical focusing and optical zoom functions. In other specific embodiments of this application, the number of optical lenses 100 can also be four, five, etc., and is not limited to this application.

In some embodiments, the photosensitive assembly 80 further comprises a chip circuit board, a photosensitive chip, a filter element, and a filter element holder. The photosensitive chip is disposed and connected to the chip circuit board. The filter element holder is located around the photosensitive chip and disposed on the chip circuit board. The filter element holder and the chip circuit board are either integrally formed or have a separate structure. The filter element is mounted on the filter element holder to maintain the photosensitive path of the photosensitive chip and to filter the imaging light entering the photosensitive chip.

This application can also provide a camera module, as shown in FIG. 1, which comprises:
The driving arrangement as described above;
The light deflection element 90 used to deflect incident light rays;
The optical lens 100 held on the light deflection path of the light deflection element 90;
The photosensitive assembly 80 used to receive light from the optical lens 100.

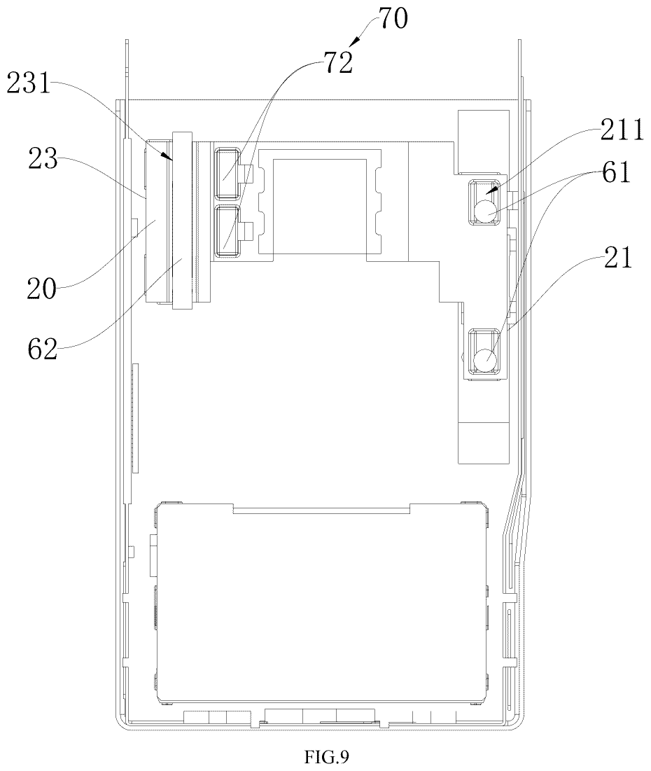

This application also provides a method for assembling a camera module, as shown in FIGS. 11 to 14, which comprises the following steps:
S1: provide a fixed part 10;
S2: Provide a movable part 20 and install the movable part 20 in the fixed part 10, the movable part 20 is used to support the optical lens 100, and the optical lens 100 defines an optical axis;
S3: Provide a piezoelectric actuator 30, a pre-pressing part 40, and a pressing block 50, and assemble the piezoelectric actuator 30, the pre-pressing part 40, and the pressing block 50 to form a pre-pressing drive assembly, wherein the pre-pressing part 40 is disposed between the piezoelectric actuator 30 and the pressing block 50, the piezoelectric actuator 30 is mounted on the pre-pressing part 40, the pressing block 50 is coupled to the pre-pressing part 40, and provides a deformable preset space for the pre-pressing part 40;
S4: Install the pre-pressing force drive assembly on the fixed part 10 in a direction perpendicular to the optical axis and the drive assembly is located on top of the movable part 20, the pressing block 50 is fixed to the fixed part 10, the pre-pressing part 40 applies a pre-pressing force perpendicular to the optical axis (i.e., the second direction) to the piezoelectric actuator 30, the piezoelectric actuator 30 and the movable part 20 abut against each other under the action of the pre-pressing force, and the piezoelectric actuator 30 and the movable part 20 make frictional contact.

By installing the piezoelectric actuator 30 at the top of the movable part 20, the support structure can be located only at the bottom of the movable part 20 for support, eliminating the need for additional support structures at the top or sides of the movable part 20. This reduces the number of support structures and enhances assembly consistency and accuracy. Furthermore, since the assembly process proceeds layer by layer from bottom to top, the assembly process is further simplified, reducing assembly tolerances.

In some embodiments, in the method for assembling the camera module, the step S1 further comprises the following steps:
S11: Provide a first magnetic attracting element 71 which is disposed on the fixed part 10.

In some embodiments, in the method for assembling the camera module, the step S2 further comprises the following steps:
S21: Provide a second magnetic attracting element 72 in the movable part 20;
S22: Provide a first support part 61 and a second support part 62, the first support part 61 is assembled into the first guide groove 111, and the second support part 62 is assembled into the first support groove 131, the second magnetic attracting element 72 and the first magnetic attracting element 71 are arranged opposite to each other along the second direction and interact to generate a magnetic attracting force. The magnetic attraction force causes the movable part 20 and the fixed part 10 to clamp the first support part 61 and the second support part 62.

In some embodiments, in the method for assembling the camera module, the step S3 further comprises the following steps:
S31: First, fix the pre-pressing part 40 and the piezoelectric actuator 30, and then couple the pre-pressing part 40 to the pressing block 50 to form a pre-pressing drive assembly. In this way, the pre-pressing part 40 can be assembled with the piezoelectric actuator 30 together with the pressing block 50, reducing the assembly difficulty.

Specifically, in the step S31, the pre-pressing part 40 comprises two fixed ends 41, an elastic part 42, and two bending parts 43. The two bending parts 43 are respectively disposed between the two fixed ends 41 and the elastic part 42 and respectively connect the elastic part 42 and the two fixed ends 41. The pre-pressing part 40 is fixed to the pressing block 50 through the two fixed ends 41, and the piezoelectric actuator 30 is installed on the pre-pressing part 40 by being fixed to the elastic part 42.

It is worth mentioning that, in other embodiments of this application, the pre-pressing part 40 and the pressing block 50 may be fixed first in the step S3. Specifically, the step S3 comprises:
S31b: First, the pre-pressing part 40 is coupled to the pressing block 50, and then the piezoelectric actuator 30 is installed on the pre-pressing part 40 to form a pre-pressing drive assembly.

Furthermore, in some embodiments, the step S4 further comprises the step of:
S41: install the pressing arm 52 of the pressing block 50 on the fixed part 10, wherein the friction head 32 of the piezoelectric actuator 30 is facing and abutting against the first movable side wall 21 of the movable part 20, the pressing block 50 keeps the first movable side wall 21 between the friction head 32 of the piezoelectric actuator 30 and the first support part 61, the first support part 61 provides the movable part 20 with a support force in the second direction.
S42: allowing the pre-pressing part 40 to deform under the action of the pressing block 50 and the first support part 61, so as to provide a pre-pressing force that is opposite to the support force and in the same direction as the downward force.

Specifically, in the step S41, the pressing block 50 is installed in the first receiving groove 112 of the fixed part 10.

Furthermore, after assembling the piezoelectric actuator 30, the pre-pressing part 40, and the pressing block 50, the pressing block 50 is then assembled onto the fixed part 10 to complete the assembly process. This simplifies the entire assembly process and further reduces the problems of tilting of the movable part 20 and poor assembly consistency of the camera module caused by assembly errors.

It should be understood that the above assembly method can also be applied to the modified embodiments shown in FIGS. 15 to 22. Further, in the step S31, the pre-pressing part 40 further comprises a mounting part 44 which is fixed to the elastic part 42, so that the elastic part 42 is fixed to the piezoelectric actuator 30 through the mounting part 44.

In some embodiments, the bottom of the first movable sidewall 21 has a second guide groove 211, the bottom of the second movable sidewall 23 has a second support groove 231, the movable part 20 is movably disposed within the fixed part 10, the piezoelectric actuator 30 is in frictional contact with the top of the first movable sidewall 21 for driving the movable part 20 to move along the optical axis; a pre-pressing part 40 is disposed on the top of the piezoelectric actuator 30 and applies a pre-pressing force perpendicular to the optical axis direction to the second guide groove 211, wherein the pre-pressing force direction intersects the plane containing the inner surface of the second guide groove 211, and the magnetic attraction assembly 70 approaches the second support groove 231 and applies a magnetic attraction force perpendicular to the optical axis direction to the second support groove 231, wherein the direction of the magnetic attraction force is perpendicular to the plane containing the inner surface of the second support groove 231. The first support part 61 comprises at least two support balls 611, and the second support part 62 comprises at least one support ball 611. The at least two support balls 611 of the first support part 61 are disposed in the second guide groove 211 as the main guide part, and the at least one support ball 611 of the second support part 62 is disposed in the second support groove 231 as the auxiliary support part. This application improves the stability and contact flatness of the periscope camera module by driving it at the top of the first movable sidewall 21 of the movable part 20 and magnetically attracting it at the bottom of the movable part 20 near the second movable sidewall 23. The driving and magnetic attraction are combined with the second guide groove 211, the second support groove 231, the first support part 61 and the second support part 62. This reduces the risk of the optical lens 100 tipping over, solves the tilt and consistency problems existing in the periscope camera module, and simplifies the assembly difficulty.

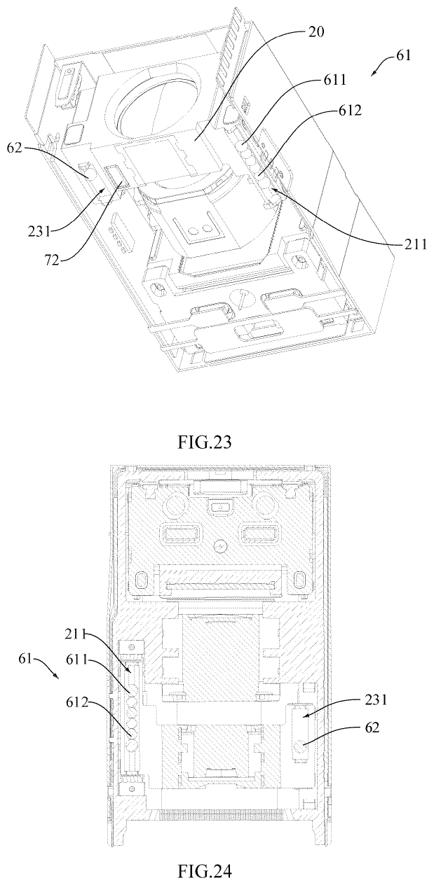

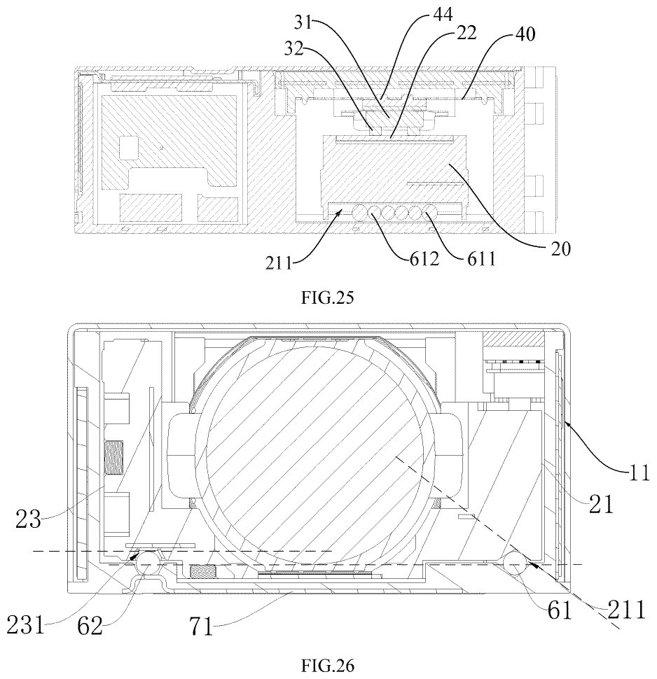

Specifically, as shown in FIGS. 23 to 26, the first support part 61 and the second support part 62 each comprise at least two support balls 611 spaced apart along the optical axis; The second guide groove 211 and the second support groove 231 are segmented guide grooves, that is, there are two second guide grooves 211 and two second support grooves 231. The two segments of the second guide groove 211 and the two segments of the second support groove 231 are spaced apart along the optical axis. Each segment of the second guide groove 211 and each segment of the second support groove 231 is provided with one support ball 611 to provide stable support at the bottom of the movable part 20, reduce shaking and offset during movement, and improve the stability and reliability of the driving arrangement.

In some embodiments, the distance between at least two support balls 611 of the first support part 61 is greater than the distance between at least two support balls 611 of the second support part 62, that is, the distance between the two support balls 611 located on two sides of the bottom of the movable part 20 is different. The first support part 61 serves as the dominant support end, and the second support part 62 serves as the auxiliary support end. When the movable part 20 tilts, the second support part 62 can make minor adjustments to prevent the movable part 20 from tipping over. Simultaneously, the larger distance between the two support balls 611 of the first support part 61 increases the support area, thereby improving the stability of the driving arrangement.

It should be understood that due to the size limitations of the driving arrangement and the optical lens 100, the length of the movable part 20 along the optical axis is fixed; that is, the length of the movable part 20 along the optical axis cannot be infinitely large or infinitely small. Furthermore, the two segments of the second guide groove 211 and the two segments of the second support groove 231 are spaced apart along the optical axis on opposite sides of the bottom of the movable part 20. This limits the length of each segment of the second guide groove 211 and each segment of the second support groove 231 along the optical axis, preventing them from being lengthened. When each support ball 611 is disposed in each segment of the second guide groove 211 and each segment of the second support groove 231, the shorter length of each segment of the second guide groove 211 and each segment of the second support groove 231 restricts the movement position of the support ball 611, thereby limiting the travel distance of the movable part 20. Moreover, when a single support ball 611 is confined within a shorter segment of each second guide groove 211 and each segment of the second support groove 231, the risk of the support ball 611 getting stuck increases, causing the support ball 611 to generate sliding friction, which increases the frictional force, affects the stability and reliability of the driving arrangement, and also affects the driving effect of the driving arrangement.

To address the aforementioned problems, this application also provides another embodiment. The first support part 61 comprises at least two support balls 611 arranged along the optical axis, and the second support part 62 comprises at least one support ball 611. Specifically, at least two support balls 611 of the first support part 61 are disposed within a second guide groove 211, and at least one support ball 611 of the second support part 62 is disposed within a second support groove 231. It should be understood that since a second guide groove 211 and a second support groove 231 are respectively disposed on opposite sides of the bottom of the movable part 20, the length of the second guide groove 211 and the second support groove 231 along the optical axis can be longer, for example, extending through the bottom of the movable part 20 along the optical axis. This provides a larger movement space for the support balls 611 within the second guide groove 211 and the second support groove 231, and also increases the flexibility of the support balls 611, reducing the risk of sliding friction and thus reducing the frictional force when the support balls 611 roll. Furthermore, when at least two support balls 611 of the first support part 61 move within a second guide groove 211, the support balls 611 exhibit greater flexibility, reducing the risk of jamming and thus improving the reliability and stability of the driving arrangement. This is because the motion state of a single support ball 611 is uncertain; it may be in a rolling or sliding state. Increasing the number of support balls 611 in a second guide groove 211 allows for mutual compensation of the motion states among the support balls 611.

Furthermore, as described above, since the piezoelectric actuator 30 is driven from the top of the first movable sidewall 21, the pre-pressing part 40 generates a pre-pressing force parallel to the second direction at the top of the piezoelectric actuator 30. This causes the pre-pressing force to primarily act on the first support part 61 on the same side as the piezoelectric actuator 30. The magnetic attraction assembly 70 is located at the bottom of the movable part 20 near the second support part 62. This causes the magnetic attraction force generated by the magnetic attraction assembly 70 to primarily act on the second support part 62 on the opposite side of the piezoelectric actuator 30, and the pre-pressing force is greater than the magnetic attraction force. In other words, the force on the first support part 61 is greater than the force on the second support part 62. This may lead to the following: Firstly, due to the greater force on one side of the movable part 20, for example, the first movable sidewall 21, the force on the first movable sidewall 21 and the second movable sidewall 23 of the movable part 20 is uneven, which may easily cause overturning and affect the stability of the driving arrangement. Secondly, the greater force on the first support part 61 makes the support ball 611 of the first support part 61 more prone to denting, especially when a drop or collision occurs, a greater impact force is applied to the first support part 61, making it more prone to denting and affecting the driving effect. Thirdly, the greater force on the first support part 61 makes the support ball 611 of the first support part 61 more prone to sliding friction or even jamming during the movement of the movable part 20 along the optical axis, affecting the performance of the driving arrangement.

In this application, the structure of the second guide groove 211 and the second support groove 231 is such that the pre-pressing force direction intersects the plane containing the inner surface of the second guide groove 211, and the magnetic attraction direction is perpendicular to the plane containing the inner surface of the second support groove 231. Furthermore, at least two support balls 611 of the first support part 61 are disposed within one second guide groove 211, and at least one support ball 611 of the second support part 62 is disposed within one second support groove 231. This allows at least two support balls 611 of the first support part 61 to serve as the main guiding portion within the second guide groove 211, and at least one support ball 611 of the second support part 62 to serve as the auxiliary supporting portion within the second support groove 231. The main guide section guides the movable part 20 as it moves along the optical axis, guiding the long travel of the movable part 20 along the optical axis and improving the driving accuracy of the driving arrangement. The auxiliary support section supports the movable part 20 as it moves along the optical axis, reducing the risk of the movable part 20 tipping over during movement and improving the reliability and stability of the driving arrangement.

It is understandable that because the first support part 61 and the first movable sidewall 21 are subjected to greater pre-pressing force, while the second support part 62 and the second movable sidewall 23 are subjected to less magnetic attraction, the driving arrangement is more likely to overturn towards the first support part 61. The straight-line distance from the contact point between the piezoelectric actuator 30 and the movable part 20 to the first support part 61 is the lever arm value corresponding to the overturning moment of the movable part 20. By placing the first support part 61, which is the dominant directional part, on the same side as the piezoelectric actuator 30 and the pre-pressing part 40, the lever arm value can be reduced, thereby lowering the overturning moment value of the movable part 20 around the optical axis. Furthermore, when at least two support balls 611 of the first support part 61 are disposed in a second guide groove 211, the contact points between the at least two support balls 611 of the first support part 61 and the movable part 20 will form a denser distribution along the optical axis direction. The straight-line distance between the friction contact point between the piezoelectric actuator 30 and the movable part 20 and the support point between the first support part 61 and the movable part 20 can be shortened, so that the overturning arm of the driving arrangement toward the incident light side or exit light side of the optical lens 100 can be reduced, thereby reducing the risk of overturning of the movable part 20.

In other words, even if the first movable sidewall 21 and the second movable sidewall 23 of the movable part 20 experience uneven stress due to differences in pre-pressing force and magnetic attraction, the cooperation between the second guide groove 211 and the first support part 61, as well as the cooperation between the second support groove 231 and the second support part 62, can still reduce the risk of the movable part 20 tipping over. Furthermore, since the magnetic attraction force generated by the magnetic attraction assembly 70 and the pre-pressing force generated by the pre-pressing force component 40 mainly act on the first movable sidewall 21 and the second movable sidewall 23 located on opposite sides, the second support part 62 acts as an auxiliary support part on the side with less magnetic attraction force through the cooperation of the second support groove 231 and the second support part 62, while on the side with greater pre-pressing force, the first support part 61 acts as the main guide part through the cooperation of the second guide groove 211 and the first support part 61. This prevents the movable part 20 from swaying and reduces the risk of tipping over.

In some embodiments, the number of support balls 611 in the first support part 61 is greater than the number of support balls 611 in the second support part 62. Since the force on the first support part 61 is greater than the force on the second support part 62, a larger number of support balls 611 in the first support part 61 can disperse the force, reducing the risk of dents or jamming in the support balls 611. Furthermore, the first support part 61 is disposed on the same side as the piezoelectric actuator 30 and the pre-pressing part 40. A larger number of support balls 611 in the first support part 61 can increase the support area on that side, thereby preventing the movable part 20 from tilting.

Specifically, the first support part 61 comprises two support balls 611 and a small ball 612 located between the two support balls 611. The diameter of the small ball 612 is smaller than the diameter of the support balls 611, and multiple small balls 612 are arranged between the support balls 611. The number of small balls 612 can be greater than or equal to the number of support balls 611. Since the more small balls 612 there are, the greater the distance between the two support balls 611 at both ends of the small ball 612, the larger the support area becomes. This can prevent the movable part 20 from tilting and reduce the wear on the surface of the support balls 611. Furthermore, in the event of a drop or impact, the small balls 612 can disperse the impact force, preventing the support balls 611 from developing dents that would affect the driving effect. Even further, the small balls 612 can maintain rolling friction on the support balls 611, reducing sliding friction and the risk of jamming, and improving the reliability and stability of the driving arrangement.

In some embodiments, two second guide grooves 211 are spaced apart along the optical axis on the bottom surface of the first movable sidewall 21, the first support part 61 is installed in the second guide grooves 211 and the first guide groove 111, and two second support grooves 231 are spaced apart along the optical axis on the bottom surface of the second movable sidewall 23, which is suitable for the second support part 62 to be installed in the second support grooves 231 and the first support groove 131, which helps to improve the installation stability of the support and optimize the assembly process.

Furthermore, since the support structure is assembled inside the guide groove structure, as the distance between the two second guide grooves 211 increases, the distance between the two support parts of the first support part 61 assembled in the two second guide grooves 211 also increases, thereby making the support area formed by the line connecting the first support part 61 and the second support part 62 larger, thereby reducing the risk of the movable part 20 tilting during movement.

In some embodiments, along the second direction, the line connecting the projections of the friction portion 22 and the projections of the farthest ends of the two second guide grooves 211 overlaps, and the line connecting the projections of the friction portion 22 and the projections of the two support parts of the first support part 61 overlaps, which helps to suppress the risk of the movable part 20 tipping over in the left-right and front-back directions. Therefore, by increasing the distance between the two support parts of the first support part 61, a larger support area is provided for the movable part 20, and a stable support force is provided throughout the entire movement stroke of the movable part 20, reducing the possibility of the movable part 20 tipping over in the front-back direction. In other words, the length of the friction portion 22 along the optical axis is less than the distance between the farthest ends of the two second guide grooves 211 along the optical axis.

In some embodiments, each of the first support part 61 and the second support part 62 comprises two balls for providing a stable supporting force to the movable part 20. Further, each ball is disposed within a single guide groove to avoid interference between the two balls. It is understood that the greater the distance between the two balls spaced apart along the optical axis in the first support part 61 and the second support part 62, the more stable the supporting force provided to the movable part 20, further enhancing the stability and reliability of the optical lens 100. When the distance between the two balls in the first support part 61 is greater than the distance between the two balls in the second support part 62, the area of the support surface formed by the ball assembly is increased, thereby increasing the stability of the optical lens 100.

In some embodiments, the projection of the friction head 32 of the piezoelectric actuator 30 along the second direction overlaps with the projection of the line connecting the first support part 61 along the second direction, further reducing the overturning moment value and reducing the risk of overturning of the movable part 20.

In some embodiments, the piezoelectric actuator 30 has two friction heads 32 which are spaced apart along the optical axis on the piezoelectric active part 31. The distance between the two friction heads 32 of the piezoelectric actuator 30 is less than the distance between the two support portions of the first support part 61, which helps to reduce the deviation between the downward pressure and the pre-pressing force, and further makes the pre-pressing force evenly distributed on the two support portions of the first support part 61, reducing wear and damage to the first support part 61 caused by uneven pre-pressing force. Furthermore, when the piezoelectric active part 31 causes the friction heads 32 to move by generating vibration deformation, the angle of contact between the friction heads 32 and the movable part 20 changes with the movement. This causes the force generated between the friction heads 32 and the movable part 20 to not always be parallel to the optical axis. The direction of the force may have a certain tilt angle with respect to the plane where the first movable sidewall 21 of the movable part 20 is located. At this time, the tilted force may further cause the movable part 20 to tilt. Therefore, the larger the distance between the two support parts of the first support part 61, the larger the support area of the movable part 20 can be, thereby reducing the overturning moment value and further reducing the risk of tilting of the movable part 20.

In some embodiments, the imaginary line of the direction of the pre-pressing force applied to the movable part 20 intersects with the line connecting the first support part 61, which helps to reduce the overturning moment value and further reduce the risk of tilting of the movable part 20.

In some embodiments, the pressing block 50, the pre-pressing part 40, the friction head 32, and the first support part 61 are together traversed along an imaginary line parallel to the second direction. The center of the cross-section of the pressing block 50, the position of the friction head 32 acting on the movable part 20, and the center of the cross-section of the first support part 61 are aligned in the second direction. This arrangement facilitates the stable and direct application of pre-pressing force by the pre-pressing part 40 to the first support part 61, increasing the stability of pre-pressing force transmission and reducing errors caused by misalignment of components, thereby improving the reliability of the camera module. Moreover, the adjustment of the pre-pressing force generated by the pre-pressing part 40 by the pressing block 50 can also be applied more directly to the first support part 61, improving the response speed of the driving arrangement. Furthermore, this alignment method helps reduce localized excessive wear on the first support part 61, extending the service life of the camera module while reducing the overturning moment value, further reducing the risk of tilting of the optical lens 100.

In some embodiments, the first support part 61 and the second support part 62 are components that can be independently formed with respect to the movable part 20 and the pressing block 50. Further, the first support part 61 can be a multi-point structure spaced apart along the optical axis, such as a ball or a slider. The second support part 62 can be a multi-point structure or a guide rail structure spaced apart along the optical axis, such as a ball, a slider, or a guide rod. When a guide rod is used as a support component, its better linearity can increase the stability and reliability of the movable part 20 when driven to move, further reducing the tilting or overturning phenomenon of the optical lens 100. Specifically, the second support groove 231 equipped with the second support part 62 can be trapezoidal, rectangular, or V-shaped, etc.

Understandably, when the first support part 61 uses balls as its support structure and the second support part 62 uses a guide rod as its support structure, the downward pressure exerted on the second support part 62 in the second direction is mainly due to the magnetic attraction force provided by the magnetic attraction assembly 70, which is less than the downward pressure on the first support part 61. The downward pressure on the first support part 61 comprises the magnetic attracting force provided by the magnetic attraction assembly 70, the downward pressing force provided by the pressing block 50, and the pre-pressing force provided by the pre-pressing part 40. This reduces the frictional force generated by the surface contact of the second support part 62, thereby reducing the power consumption of the piezoelectric actuator 30. On the other hand, if the first support part 61 uses a guide rod as its support structure, the large downward pressure and the large frictional force generated by the surface contact of the guide rod structure will affect the driving effect of the piezoelectric actuator 30. Understandably, when using balls as the support structure, the balls contact the guide rail and guide groove using point contact, resulting in minimal rolling friction and large sliding friction, which is beneficial for driving the movable part 20.

In some embodiments, the first support part 61 is in two-point contact with the second guide groove 211. The second guide groove 211 is a V-shaped groove, and its two sidewalls are in contact with the two sides of the first support part 61, forming a bidirectional constraint. This constraint restricts the left and right movement of the first support part 61 perpendicular to the extension direction of the second guide groove 211, such as lateral offset along the first direction, while allowing the first support part 61 to move along the extension direction of the second guide groove 211, ensuring the straightness of the movement trajectory of the first support part 61(Compared with single-point contact, two-point contact has a larger contact area, which can distribute the load and reduce local stress concentration. When the first support part 61 is subjected to lateral force, the two side contacts can jointly resist the overturning moment, improving the stability of the driving arrangement. Moreover, the geometry of the V-shaped groove has an “auto-centering” characteristic: if the first support part 61 is offset by force, the constraint of the two side walls will force it back to the center position of the second guide groove 211.

In some embodiments, the second support part 62 makes single-point contact with the second support groove 231. As described above, the second support part 62 is loosely disposed within the second support groove 231, which is a U-shaped groove. The second support part 62 makes frictional contact with the bottom wall of the second support groove 231, thereby achieving single-point contact. This allows for greater movement space for the second support part 62 and avoids movement jamming due to over-constraint. Secondly, single-point contact requires lower machining precision, eliminating the need for strict alignment during assembly, such as dimensional deviations in the second support groove 231 or positional offsets of the second support part 62. When there are dimensional tolerances between the second support groove 231 and the second support part 62, loose fitting reduces assembly difficulty and avoids assembly stress caused by over-tight fit. Finally, single-point contact reduces frictional loss, improves movement efficiency, reduces wear rate, and extends component life.

In some embodiments, the second guide groove 211 has two opposing sidewalls, and there is an included angle between the planes containing the two sidewalls. The first support part 61 is in frictional contact with the two sidewalls of the second guide groove 211, so that the first support part 61 is tightly fitted in the second guide groove 211. The second support groove 231 has a bottom wall, and the second support part 62 is in frictional contact with the bottom wall of the second support groove 231. That is to say, the second guide groove 211 ensures the accuracy of the reciprocating movement of the movable part 20 to form a rigid constraint to prevent the movable part 20 from deviating. The second support groove 231 is suitable for fine adjustment to avoid motion jamming caused by excessive constraint, so that the movement of the movable part 20 is smoother.

In some embodiments, the line connecting the first support part 61 and the second support part 62 intersects the plane containing the sidewall of the second guide groove 211, and the line connecting the first support part 61 and the second support part 62 is parallel to the plane containing the bottom wall of the second support groove 231. In other words, the center points of the first support part 61 and the second support part 62 are on the same horizontal line, so that the movable part 20 is supported at the same height. The center line intersects the plane containing the sidewall of the second guide groove 211 to form precise motion guidance. When the first support part 61 and the second support part 62 are subjected to a load perpendicular to the center line, the reaction force of the two sidewalls of the V-shaped groove can form a symmetrical moment through the center line to counteract the overturning effect of the external load and maintain structural balance. The center line is parallel to the plane of the bottom wall of the U-shaped groove, and the second support part 62 can reciprocate along the extension direction of the bottom wall of the U-shaped groove. Furthermore, since the second support part 62 is loosely disposed in the second support groove 231, the second support part 62 can also be finely adjusted laterally along the bottom wall, thereby avoiding jamming caused by excessive constraint.

It is understandable that during the movement of the movable part 20 along the optical axis driven by the piezoelectric actuator 30, since the piezoelectric actuator 30 is located on the same side as the first movable sidewall 21 and on the opposite side of the second movable sidewall 23, when the piezoelectric actuator 30 is stopped, the self-locking function of the piezoelectric actuator 30 allows the first movable sidewall 21 to stop moving in time, while the second movable sidewall 23, due to inertia, tends to continue moving. Alternatively, if the movable part 20 is already tilted, the displacement of the second movable sidewall 23 may be greater than the displacement of the first movable sidewall 21. This not only makes the second movable sidewall 23 prone to collision and damage with the fixed part 10, but also causes the movable part 20 to tilt, thus affecting the subsequent driving effect of the driving arrangement. Furthermore, when the driving arrangement is dropped or impacted, the self-locking function of the piezoelectric actuator 30 cannot resist the external impact, causing the movable part 20 to move under the action of the external impact force and collide with the fixed part 10.

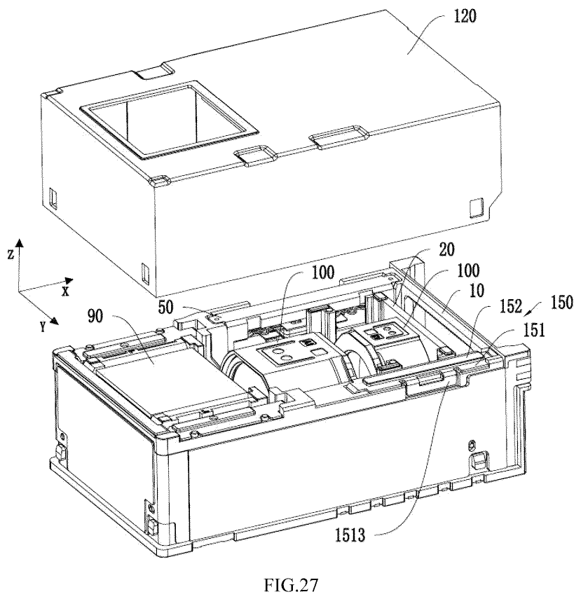

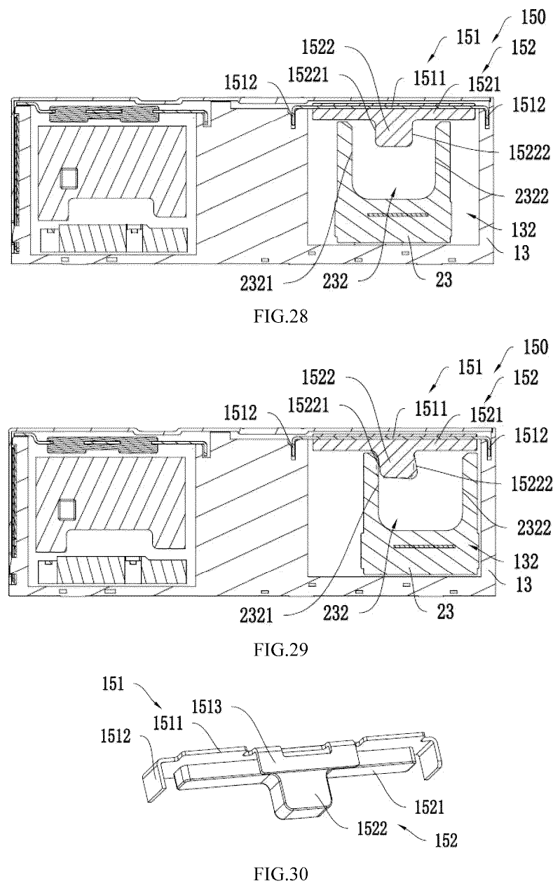

To address the aforementioned problems, as shown in FIGS. 27 to 30, this application incorporates a damping structure 150. The damping structure 150 comprises a damping bracket 151 and a damping element 152. The damping bracket 151 is disposed on the fixed part 10, and the damping element 152 is extended from the plane of the damping bracket 151 toward the second movable sidewall 23, allowing the second movable sidewall 23 to contact the damping element 152. The damping element 152 absorbs or dissipates the impact caused by contact with the second movable sidewall 23, thereby reducing noise. Specifically, the damping bracket 151 comprises a main body part 1511 and installing parts 1512 located at both ends of the main body part 1511. The plane of the main body part 1511 is parallel to the optical axis, and the plane of the installing parts 1512 is perpendicular to the optical axis. It should be understood that the installing parts 1512 can be formed by bending the main body part 1511.

Furthermore, the fixed part 10 comprises a first fixed sidewall 11 located on the first side and a second fixed sidewall 13 located on the second side, wherein the first fixed sidewall 11 and the second fixed sidewall 13 are opposite to each other, the first fixed sidewall 11 is opposite to the first movable sidewall 21 of the movable part 20, and the second fixed sidewall 13 is opposite to the second movable sidewall 23 of the movable part 20. The second fixed sidewall 13 has an opening 132, and at least a portion of the second movable sidewall 23 is disposed within the opening 132 of the second fixed sidewall 13 to reduce the size of the driving arrangement. In one embodiment, the top of the second fixed sidewall 13 faces the insertion port at the top of the driving arrangement, and the mounting part 1512 is disposed within the insertion port to fix the damping bracket 151 to the second fixed sidewall 13. In another embodiment, the second fixed sidewall 13 and the mounting part 1512 can also be integrally formed to fix the damping bracket 151 to the second fixed sidewall 13.

Two installing parts 1512 are respectively fixed to the portions of the second fixed sidewall 13 near the incident light side and near the exit light side. The main body part 1511 is extended along the optical axis between the two installing parts 1512, covering the opening 132 of the second fixed sidewall 13 and located on top of the second movable sidewall 23. Along the second direction, at least a portion of the main body part 1511 abuts against the top of the second fixed sidewall 13, and there is a certain gap between the main body part 1511 and the top of the second movable sidewall 23 to provide sufficient space for the damping element 152.

In some embodiments, the damping element 152 is formed on the main body part 1511 of the damping bracket 151 and extended from the main body part 1511 toward the second movable sidewall 23, such that at least a portion of the damping element 152 is accommodated in the gap between the top of the main body part 1511 and the second movable sidewall 23. The damping element 152 comprises a first part 1521 connected to the main body part 1511 of the damping bracket 151 and a second part 1522 connected to the first part 1521, the second part 1522 is not contacting the main body part 1511. The first part 1521 has a length along the optical axis and a height along a second direction. The length of the first part 1521 is greater than its height; for example, the length of the first part 1521 is less than or equal to the length of the opening 132 of the second fixed sidewall 13 along the optical axis, so that the first part 1521 can fill the opening 132 as much as possible in the optical axis direction. As previously mentioned, when the driving arrangement falls or is impacted, the movable part 20 may move in the second direction under the impact force, causing the movable part 20 to detach from the fixed part 10, which may result in a collision between the top of the movable part 20 and the top cover 120. However, if the length of the first part 1521 of the damping element 152 along the optical axis is sufficiently long, regardless of the position of the movable part 20 in the fixed part 10, the first part 1521 of the damping element 152 can contact the movable part 20 when a fall or impact occurs, thereby absorbing or dissipating the impact, reducing the risk of damage to the movable part 20, and also reducing noise.

Furthermore, the first part 1521 of the damping element 152 comprises a top surface and a bottom surface opposite each other along the second direction. The bottom surface of the first part 1521 is spaced apart from the top of the second movable sidewall 23, meaning there is a gap between them. This ensures that, under normal operating conditions, the top of the second movable sidewall 23 does not contact the bottom surface of the first part 1521, preventing the first part 1521 from affecting the movement of the movable part 20. Contact only occurs between the bottom surface of the first part 1521 and the top of the second movable sidewall 23 in the event of a drop or impact, allowing the first part 1521 to provide cushioning.

In some embodiments, the second movable sidewall 23 has a slot 232 opening toward the top of the driving arrangement, and a second part 1522 of the damping element 152 is extended from the first part 1521 toward the slot 232 of the second movable sidewall 23, wherein at least a portion of the second part 1522 of the damping element 152 is located within the slot 232 of the second movable sidewall 23. In other words, along the optical axis direction, the second part 1522 of the damping element 152 overlaps with the second movable sidewall 23. Specifically, the slot 232 of the second movable sidewall 23 has an inner sidewall parallel to the second direction, and the second part 1522 of the damping element 152 has an inner surface parallel to the second direction. During the movement of the movable part 20 within the fixed part 10 along the optical axis, the inner surface of the second part 1522 contacts the inner sidewall of the slot 232. This restricts further movement of the second movable sidewall 23 along the optical axis by the second part 1522 of the damping element 152, absorbing or dissipating impacts, reducing the risk of damage to the movable part, and also reducing noise. Furthermore, when the second movable sidewall 23 contacts the second part 1522 of the damping element 152, the second part 1522 will move or deform towards the side of the second movable sidewall 23 that is not in contact with it under the action of force. Since the space on the side of the second movable sidewall 23 that is not in contact with the second part 1522 is larger, the second part 1522 can absorb or dissipate the impact caused by the contact to a greater extent through greater deformation, thus better reducing noise.

The second part 1522 has a shorter length along the optical axis than the first part 1521, allowing it to extend into the slot 232 of the second movable sidewall 23. Furthermore, the second part 1522 has a shorter length along the optical axis than the slot 232, ensuring that gaps exist between the two inner surfaces of the second part 1522 and the two inner sidewalls of the slot 232 when no collision occurs. The two inner surfaces of the second part 1522 may comprise a first inner surface 15221 and a second inner surface 15222, and the two inner sidewalls of the slot 232 include a first inner sidewall 2321 and a second inner sidewall 2322. The first inner surface 15221 and the first inner sidewall 2321 are opposite each other along the optical axis, and the second inner surface 15222 and the second inner sidewall 2322 are opposite each other along the optical axis. It can be understood that when the movable part 20 moves towards the exit light side along the optical axis, the first inner surface 15221 contacts the first movable sidewall 21, and the second part 1522 of the damping element 152 moves or deforms towards the exit light side. Because the distance between the second inner surface 15222 and the second movable sidewall 23 increases, the second part 1522 can absorb or dissipate the impact caused by the contact to a greater extent through greater deformation, thus better reducing noise. Similarly, when the movable part 20 moves towards the incident light side along the optical axis, the second part 1522 can also absorb or dissipate the impact caused by the contact to a greater extent through greater deformation, thus better reducing noise.

In some embodiments, the height of the second part 1522 along the second direction is greater than the height of the first part 1521 along the second direction. On the one hand, this avoids increasing the gap between the top of the second movable sidewall 23 and the damping bracket 151 due to the increased height of the first part 1521, thereby preventing an increase in the height of the driving arrangement. On the other hand, it ensures that the second part 1522 can extend into the slot 232 of the second sidewall, allowing the second part 1522 to collide with the inner sidewall of the slot 232. Further, the height of the second part 1522 along the second direction is less than the height of the slot 232 along the second direction to avoid interference between the second part 1522 and the slot 232. Furthermore, it should be understood that if the height of the second part 1522 along the second direction is too large, when the second part 1522 is deformed by external force, there may be insufficient space, causing the second part 1522 to contact the inner sidewall of the slot 232, resulting in interference and affecting the buffering effect.

In some embodiments, the damping bracket 151 further comprises a side connecting part 1513, wherein the plane of the side connecting part 1513 is perpendicular to both the plane of the main body portion 1511 and the plane of the mounting portion 1512. The side connecting part 1513 bends from the plane of the main body portion 1511 along the second direction to the side of the second fixed sidewall 13 at the middle of the main body portion 1511, and the side connecting part 1513 is fixedly connected to the side of the second fixed sidewall 13. As described above, when the driving arrangement falls or is impacted, the second movable sidewall 23 may move along the second direction and collide with the first part 1521 and the damping bracket 151. When the damping bracket 151 is fixed to the fixed part 10 only by the installing parts 1512 at both ends, the middle of the main body portion 1511 of the damping bracket 151 may be deformed due to the impact, thereby affecting the buffering effect of the damping element 152. To avoid the above situation, this application connects the damping bracket 151 and the second fixed sidewall 13 to the middle of the main body part 1511 through the side connection part 1513, which can prevent the main body part 1511 from deforming, thereby maintaining the flatness of the main body part 1511 and avoiding affecting the buffering effect of the damping element 152.

In some embodiments, the first part 1521 and the second part 1522 of the damping element 152 may comprise an elastic material, a flexible material, or an injection-molded material. For example, the first part 1521 and the second part 1522 may be formed of various materials including rubber, polyurethane, porous materials, and sponges. In various embodiments, the first part 1521 and the second part 1522 may be formed of the same material or may be formed of different materials.

In some embodiments of this application, since the pre-pressing part 40 and the first support part 61 are disposed opposite to each other at the top and bottom of the first movable sidewall 21, the pre-pressing force generated by the pre-pressing part 40 can directly act on the first support part 61. This results in a difference in the magnitude of the forces acting on the first support part 61 and the second support part 62, which not only increases the risk of overturning of the movable part 20, but also increases the risk of the first support part 61 experiencing sliding friction or even jamming. Therefore, in this application, through the cooperation of the first support part 61, the second support part 62, the piezoelectric actuator 30, and the pre-pressing part 40, a larger number of support balls 601 are provided on the first support part 61 on the same side as the piezoelectric actuator 30 and the pre-pressing part 40, and a smaller number of support balls 601 are provided on the second support part 62 on the opposite side of the piezoelectric actuator 30 and the pre-pressing part 40. In this way, a larger support area can be provided on the side where the pre-pressing part 40 generates pre-pressing force, reducing the risk of overturning; and the larger number of support balls 601 in the first support part 61 can also disperse the direct action of the pre-pressing force, reducing the risk of sliding friction or even jamming of the first support part 61.

Specifically, the bottom of the first movable sidewall 21 has a guide groove extending along the optical axis; the first support part 61 and the second support part 62 are movably disposed between the movable part 20 and the fixed part 10, the first support part 61 is disposed between the bottom of the first movable sidewall 21 and the fixed part 10, and the second support part 62 is disposed between the second movable sidewall 23 and the fixed part 10; the first support part 61 comprises at least two support balls 601, and the second support part 62 comprises at least one support ball 601. The number of support balls 601 in the first support part 61 is greater than the number of support balls 601 in the second support part 62, and the support balls 601 in the first support part 61 are accommodated in the guide groove; the piezoelectric actuator 30, which is in frictional contact with the top of the first movable sidewall 21, is used to drive the movable part 20 to move along the optical axis direction; the pre-pressing part 40 is disposed on the piezoelectric actuator 30 and applies a pre-pressing force perpendicular to the optical axis direction to the first movable sidewall 21 and the first support part 61.

This application addresses this issue by placing a piezoelectric actuator 30 and a pre-pressing part 40 on the top of the first movable sidewall 21 of the movable part 20, and by placing a first support part 61 and a second support part 62 between the fixed part 10 and the bottom of the movable part 20. This allows the movable part 20 to move stably along the optical axis under the drive of the piezoelectric actuator 30. The first support part 61, located on the same side as the piezoelectric actuator 30, comprises at least two support balls 601, and the second support part 62, located on the opposite side of the piezoelectric actuator 30, comprises at least one support ball 601. The piezoelectric actuator 30 and the first support part 61 are located on the upper and lower sides of the first movable sidewall 21 of the movable part 20 respectively, so as to ensure that the first movable sidewall 21 is simultaneously subjected to downward pre-pressing force and upward support force, preventing the movable part 20 from tipping over due to uneven force distribution on the first movable sidewall 21.

The number of the support balls 601 in the first support part 61 is greater than the number of the support balls 601 in the second support part 62, so as to provide sufficient support for the first movable sidewall 21. At the same time, at least two support balls 601 in the first support part 61 and at least one support ball 601 in the second support part 62 are distributed on both sides of the bottom of the movable part 20 with respect to the optical axis direction, forming at least one triangular effective support surface, and providing a larger support area on the same side of the piezoelectric actuator 30, providing more stable support for the movable part 20, and preventing the movable part 20 from tilting or jamming due to uneven force on one side during the driving process.

Furthermore, the first support part 61 comprises at least two support balls 601 and at least one small ball 602 located between them, and the pre-pressing force is applied between the lines connecting the at least two support balls 601 of the first support part 61.

The arrangement of the small ball 602 increases the support area on the same side as the piezoelectric actuator 30 by adjusting the spacing between the at least two support balls 601, thereby covering the range of action of the pre-pressing force as much as possible. This reduces the risk of the movable part 20 tipping over during driving and improves the stability of the driving arrangement. Furthermore, the contact point distribution of the support balls 601 at the bottom of the movable part 20 is optimized. When the driving arrangement falls or collides, the small ball 602 can disperse the impact force, preventing the support balls 601 from developing dents due to concentrated force, thus improving the reliability of the driving arrangement. Moreover, the at least one small ball 602 and the at least two support balls 601 form a support portion. The rolling of the small ball 602 increases the probability of the at least two support balls 601 rolling and moving, reducing friction and improving drive efficiency. This also reduces the risk of the support balls 601 jamming, further improving the stability of the driving arrangement.

Since the piezoelectric actuator 30 is driven on top of the first movable sidewall 21, the pre-pressing part 40 generates a pre-pressing force parallel to the second direction, which points towards the first support part 61 on the same side as the piezoelectric actuator 30. The pressing block 50 is located on top of the pre-pressing part 40 and can adjust the magnitude of the pre-pressing force. In this case, the force on the first support part 61 will be greater than that on the second support part 62 on the opposite side of the piezoelectric actuator 30. The uneven force on the movable part 20 on the first movable sidewall 21 and the second movable sidewall 23 may cause it to overturn, thereby affecting the stability and reliability of the driving arrangement.

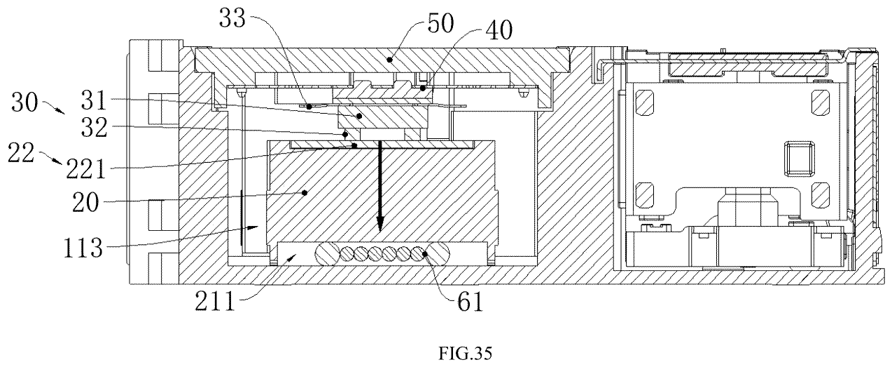

To address the aforementioned issues, as shown in FIGS. 35 to 37, this application incorporates a greater number of support balls 601 in the first support part 61. On one hand, this significantly increases the effective support area on the same side as the piezoelectric actuator 30, providing more stable support for the movable part 20 and preventing tilting or jamming during operation. On the other hand, the increased number of support balls 601 can collaboratively distribute the pre-pressing force, reducing the local pressure on a single support ball 601 and minimizing the risk of dents. Especially in drop or impact scenarios, the increased number of support balls 601 can significantly suppress dent formation on the contact surface by dispersing the impact force, ensuring the long-term reliability and stability of the driving arrangement.

Furthermore, if the number of support balls 601 in the first support part 61 increases while the length of the ball groove is insufficient, the movement space of multiple support balls 601 within a single groove will decrease. This can lead to sliding friction or jamming of the support balls 601 within the groove, failing to meet the requirements for long-stroke movement. Therefore, a through guide groove is provided at the bottom of the first movable sidewall 21 to increase the length of the guide groove, thereby increasing the movement space of the first support part 61, increasing the flexibility of the support balls 601's movement, and reducing the risk of sliding friction and jamming.

Furthermore, the first support part 61 is configured with a structure of balls of different sizes. When a fall occurs, the pressure can be dispersed by the small balls 602 to prevent the large balls from getting dented. The small balls 602 can also keep the large balls rolling and reduce the risk of sliding friction and jamming, thereby improving the reliability of the driving arrangement.

In some embodiments of the support portion of this application, the first support part 61 is implemented as comprising at least two support balls 601 and at least one small ball 602 located between the two support balls 601, and the second support part 62 is implemented as at least one support ball 601. The pre-pressing force of the pre-pressing part 40 acts on the line connecting at least two of the support balls 601 of the first support part 61 to ensure that the support provided by the first support part 61 can reduce torque deviation.

All the support balls 601 are of the same size, while the small balls 602 are smaller than the support ball 601. This design allows all the support balls 601 to form at least one triangular support surface, effectively reducing torque deviation caused by unilateral preload, minimizing the deflection tendency of the movable part 20 during movement, preventing jamming or vibration, and facilitating dynamic balance of the movable part 20 during driving. Furthermore, the rolling of at least one small ball 602 increases the rolling probability of the support ball 601, reducing friction and improving driving efficiency; it also reduces the risk of the support ball 601 jamming, improving the stability and reliability of the driving arrangement.

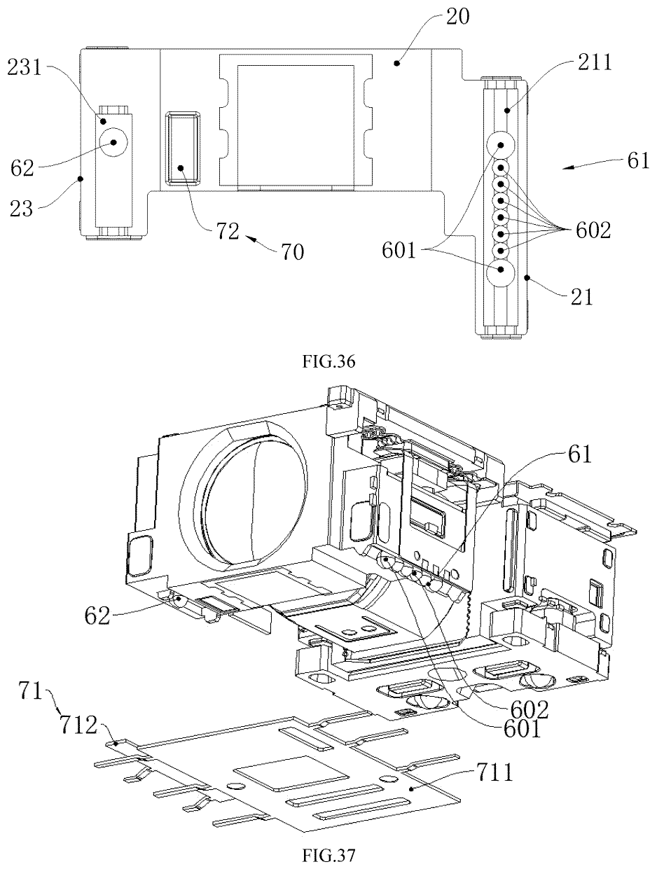

As shown in FIGS. 35 and 36, the first support part 61 is implemented by comprising two support balls 601 at the beginning and end, and a plurality of small balls 602 located between them. The second support part 62 is implemented by one support ball 601. The three support balls 601 each provide a support contact point at the bottom of the movable part 20, and the three support balls 601 form a triangular effective support surface with the minimum number of support balls 601, thereby improving the stability of the support. In the first support part 61 at the bottom of the first movable sidewall 21, the plurality of small balls 602 fill the gap between the two support balls 601 along the optical axis, extend the side support area, and adjust the spacing between the two support contact points to optimize the contact point distribution. At the same time, it improves the movement state of the two support balls 601 at the beginning and end during the driving process, reduces sliding wear, and improves the stability of the driving arrangement. When the drive unit is dropped or collided, the small ball 602 can disperse the impact force to avoid the support ball 601 from being dented due to force concentration, thereby improving the reliability of the drive unit.

When the balls are assembled between the movable part 20 and the fixed part 10, their motion is unpredictable; they can freely switch between rolling and sliding states. Therefore, during the movement of the movable part 20, there is a certain probability that the balls will get stuck in the ball grooves they contact, which can also cause the movable part 20 to tilt or even overturn. In the support formed by multiple balls on the same side, the balls make point contact with both the fixed part 10 and the movable part 20. If the movable part 20 tilts, one of the balls in the support may not be able to contact both the fixed part 10 and the movable part 20 simultaneously, potentially leading to jamming between the movable part 20 and the ball, or separation between the movable part 20 and the ball, thus preventing the movable part 20 from moving further. Furthermore, considering the size of the movable space at the ball assembly point, the manufacturing tolerances of the fixed part 10 and the movable part 20, as well as the assembly tolerances between them, can also cause the movable part 20 to tilt or get stuck.

In this application, the first support part 61 is disposed on the same side as the piezoelectric actuator 30. The first and last two support balls 601 guide all the balls of the first support part 61 to move along the optical axis. Multiple small balls 602 fill the gap between the first and last support balls 601 along the optical axis. By adjusting the contact point position, the first and last support balls 601 are always in an ideal contact support position, enhancing the support density of the pre-driven first movable sidewall 21. This also improves the motion state of the first and last support balls 601 to a certain extent, reducing sliding friction, lowering the motion resistance of the first and last support balls 601, and improving the smoothness of the movement of the movable part 20. Furthermore, the ball arrangement of the first support part 61 can buffer high-frequency vibrations, reduce the instantaneous impact load on the first and last support balls 601, reduce wear, and extend service life.

Furthermore, the first support part 61 is tightly clamped between the bottom of the first movable side wall 21 of the movable part 20 and the first fixed side wall 11 of the fixed part 10, and the second support part 62 is loosely clamped between the bottom of the second movable side wall 23 of the movable part 20 and the second fixed side wall 13 of the fixed part 10. That is, the first and last support balls 601 on the same side as the piezoelectric actuator 30 are tightly fitted between the bottom of the first movable side wall 21 of the movable part 20 and the first fixed side wall 11 of the fixed part 10, and the support balls 601 on the opposite side of the piezoelectric actuator 30 are loosely fitted between the bottom of the second movable side wall 23 of the movable part 20 and the second fixed side wall 13 of the fixed part 10. With the first support part 61 located on the first movable side wall 21 being tightly fitted, the support ball 601 located on the second movable side wall 23, which is loosely fitted, provides support for that side. While maintaining the basic support function, it reduces excessive constraint on that side and prevents the movable part 20 from getting stuck during movement.

It should be understood that the support balls 601 of the first support part 61 and the support balls 601 of the second support part 62 can also adopt the tight-fit and loose-fit structures described above. This support layout ensures that the straight-line distance from the contact point between the friction head 32 and the movable part 20 to the tight-fit support ball 601 is less than the straight-line distance from the contact point between the friction head 32 and the movable part 20 to the loose-fit support ball 601. Since the support balls 601 of the first support part 61 are tight-fitted, the straight-line distance from the contact point between the friction head 32 and the movable part 20 to the support ball 601 of the first support part 61 is the lever arm x corresponding to the overturning moment of the movable part 20. By reducing the value of x, the value of the overturning moment M is reduced, preventing the movable part 20 from tilting or even jamming. Since the first support part 61 is located at the bottom of the first movable sidewall 21 and the piezoelectric actuator 30 is located at the top of the first movable sidewall 21, when the support balls 601 of the first support part 61 are tightly fitted, the straight-line distance from the contact point between the friction head 32 and the movable part 20 to the first support part 61 is the lever arm value corresponding to the overturning moment of the movable part 20. Compared with placing one ball in a ball groove, when multiple support balls 601 of the first support part 61 are arranged in a guide groove, their contact points with the movable part 20 will form a denser distribution along the optical axis. The straight-line distance (i.e., the overturning lever arm value) from the contact point between the friction head 32 and the movable part 20 to the nearest support point of the first support part 61 is significantly shortened, which can further reduce the risk of overturning of the movable part 20.

The small ball 602 is smaller than the support ball 601. In the height direction, there is a certain height gap between the small ball 602 and the inner wall of the ball groove that accommodates the first support part 61, forming a buffer space for processing or assembly errors, and avoiding increased movement resistance due to tolerance.

In some embodiments, the second support part 62, which is located on the opposite side of the piezoelectric actuator 30, is implemented as consisting of two support balls 601 and a plurality of small balls 602 disposed between the two support balls 601. The total length of all the balls in the second support part 62 is less than the total length of all the balls in the first support part 61, so as to form a larger effective support surface and provide more stable support for the movable part 20 in a driving arrangement with a large unilateral preload.

In some embodiments of the guide groove and support groove of this application, the number of guide grooves and support grooves is one. The guide groove penetrates the bottom of the first movable sidewall 21 along the optical axis, and the support groove penetrates at least a portion of the bottom of the second movable sidewall 23 along the optical axis. The length of the guide groove along the optical axis is greater than the length of the support groove along the optical axis. Specifically, the first movable sidewall 21 is provided with one second guide groove 211, and the second movable sidewall 23 is provided with one second support groove 231. The first guide groove 111 penetrates the bottom of the first movable sidewall 21 along the optical axis, and the first support groove 131 penetrates at least a portion of the bottom of the second movable sidewall 23 along the optical axis. The length of the second guide groove 211 along the optical axis is greater than the length of the second support groove 231 along the optical axis. It should be understood that the second guide groove 211 has a large length along the optical axis, which can accommodate a larger number of support balls 601 of the first support part 61, thereby making the support area formed by the line connecting the first support part 61 and the second support part 62 larger, thus reducing the risk of the movable part 20 tilting during the movement.

Furthermore, in this modified embodiment, as shown in FIG. 35, when viewed along the second direction, the projections of the friction heads 32 of the piezoelectric actuator 30 all fall on the second guide groove 211 in the optical axis direction. More specifically, when viewed along the second direction, the projections of the friction heads 32 of the piezoelectric actuator 30 all fall on the first support part 61 in the optical axis direction. This reduces the risk of overturning of the movable part 20 and also helps to evenly distribute the pre-pressing force on the first support part 61, reducing wear and damage to the first support part 61 caused by uneven preload. More specifically, the piezoelectric actuator 30 has two friction heads 32 which are spaced apart along the optical axis direction on the piezoelectric active part 31. The distance between the two friction heads 32 can be greater than the dimension of any one of the first support parts 61 in the optical axis direction. In the second direction, the projections of the two friction heads 32 all fall on the first support part 61 in the optical axis direction. Therefore, in some cases, along the second direction, the projections of all the friction heads 32 of the piezoelectric actuator 30 fall entirely on the first support part 61 in the optical axis direction.

Based on the foregoing, it can be seen that the length of the first movable sidewall 21 is greater than the length of the second movable sidewall 23 because the piezoelectric actuator 30 is mounted on the first movable sidewall 21, which can accommodate a larger travel stroke. Similarly, the guide groove is longer than the support groove, so that the balls on the same side as the piezoelectric actuator 30 can move in a longer space, resulting in a larger support area, higher flexibility, and better reliability and stability.

Specifically, there is one first guide groove 111, one second guide groove 211, one first support groove 131 and one second support groove 231, and multiple balls that make up a support part are set in one groove.

In some embodiments of this application, the support balls 601 of the first support part 61 are tightly fitted into the guide groove, and the support ball 601 of the second support part 62 is loosely fitted into the support groove. Specifically, the support balls 601 of the first support part 61 are tightly clamped between the first guide groove 111 and the second guide groove 211 to provide support and guidance for the first movable sidewall 21 where the piezoelectric actuator 30 is located. The support ball 601 of the second support part 62 is loosely clamped between the first support groove 131 and the second support groove 231. While the first support part 61 serves as the main support component and maintains the basic support function, it also provides a certain degree of tilting buffer flexibility for the movable part 20 during movement, ensuring the stability of the movable part 20 during operation.

It is understandable that the length of the ball groove directly affects the movement space and flexibility of the ball within the ball groove, and even the travel distance of the movable part 20. Therefore, the length of the guide groove is greater than the length of the support groove. The tightly fitted balls are placed in the longer guide groove, and the loosely fitted balls are placed in the shorter support groove, so as to provide more movement space for the tightly fitted balls. The tightly fitted balls are also more flexible, which can reduce the risk of sliding friction of the tightly fitted balls and reduce friction.

Specifically, the guide groove is implemented as a V-shaped groove to tightly clamp the support balls 601 of the first support part 61, so that the support balls 601 of the first support part 61 make point contact with the guide groove under pre-pressing force, thereby reducing the frictional resistance of the first support part 61 during the movement of the movable part 20 by point contact; the support groove can be implemented as a U-shaped groove to loosely clamp the support ball 601 of the second support part 62, providing a basic clamping effect while providing a larger movement space for the support ball 601 of the second support part 62, and preventing the movable part 20 from jamming when tilted.

More specifically, both the guide groove and the support groove are closed grooves, reducing the probability of external debris entering the ball groove and affecting the rolling of the balls. This ensures that all balls can roll normally in the ball groove, guaranteeing the smooth movement of the movable part 20 within the fixed part 10. It also prevents the balls from detaching from the groove, thus affecting the reliability of the driving arrangement.

In this application, the guide groove and the support groove are designed to be as long as possible to ensure that the balls have a large space for movement and flexibility within them, while avoiding the embedded structure from jamming the balls and affecting the driving effect. Specifically, the first support part 61, which is arranged on the same side as the piezoelectric actuator 30, needs to be of sufficient length, that is, all the balls serving as the first support part 61 need to have sufficient length along the optical axis, and the ball groove accommodating the first support part 61 also needs to be of sufficient length along the optical axis to cover the pre-pressing range of the piezoelectric actuator 30 and provide more effective support for unilateral pre-pressing drive.

In some embodiments of this application, the minimum length of the first support part 61 along the optical axis is less than the length of the guide groove along the optical axis. That is, the minimum total length of the plurality of support balls 601 arranged on the same side as the piezoelectric actuator 30 is less than the length of the guide groove along the optical axis, as shown in FIGS. 35 and 36. When the first support part 61 is implemented as two support balls 601 arranged on the same side as the piezoelectric actuator 30 and at least one small ball 602 located between them, the minimum distance between the two support balls 601 is less than the length of the guide groove along the optical axis, so that the balls have sufficient room to move in the guide groove and reduce the risk of sliding friction of the balls.

In some embodiments of the guide groove length in this application, the difference between the length of the guide groove along the optical axis and the minimum total length of the first support part 61 is not less than the mechanical stroke of the movable part 20. That is, the difference between the length of the guide groove along the optical axis and the total length of the two support balls 601 and at least one small ball 602 in the guide groove is not less than the mechanical stroke of the movable part 20, so that the support balls 601 can roll throughout the entire movement of the movable part 20 to support the movable part 20 and give the movable part 20 a sufficient moving distance to realize the fast focusing function of the camera module.

In one embodiment, the first support part 61 has at least three balls, including at least two support balls 601 and at least one small ball 602. For example, the number of support balls 601 is two, and the number of small balls 602 is greater than three but not greater than eight. Specifically, the number of support balls 601 is two, and the number of small balls 602 is four; or the number of support balls 601 is two, and the number of small balls 602 is five; or the number of support balls 601 is two, and the number of small balls 602 is six; or the number of support balls 601 is two, and the number of small balls 602 is seven. It should be understood that the more small balls 602 there are, the greater the distance between two support balls 601, and the larger the support area. However, if the number of small balls 602 is too large, the larger the space occupied in the guide groove, the smaller the space for the support balls 601 to move, affecting the rolling of the support balls 601.

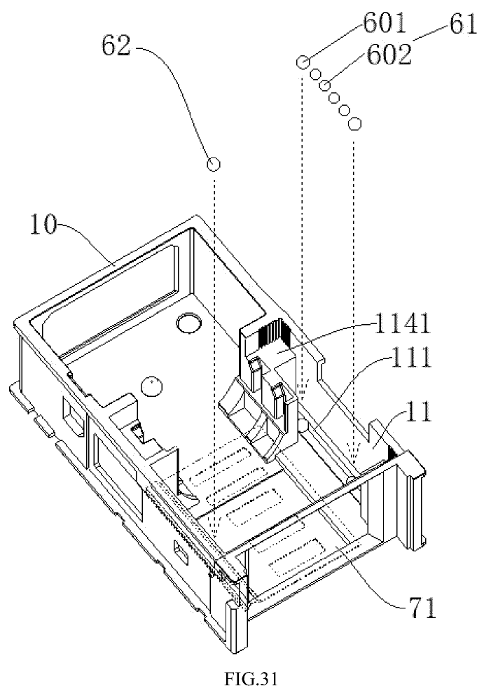

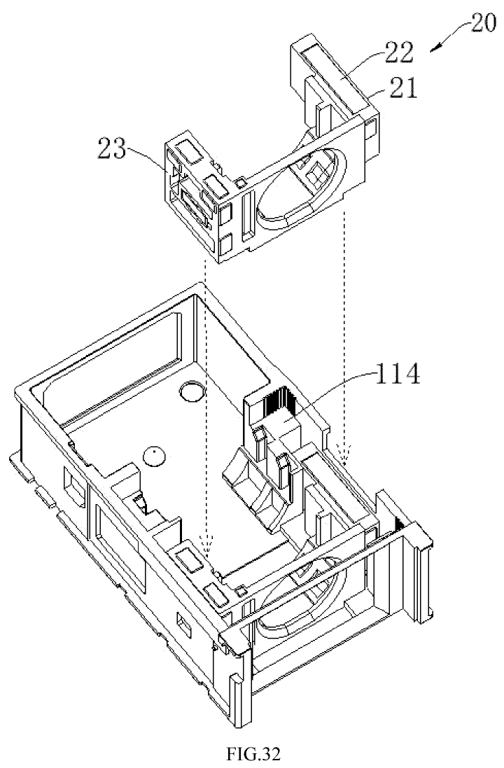

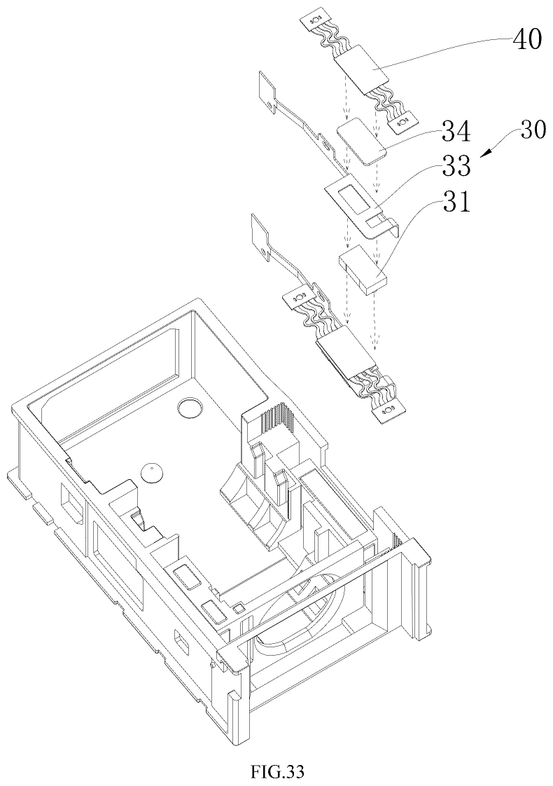

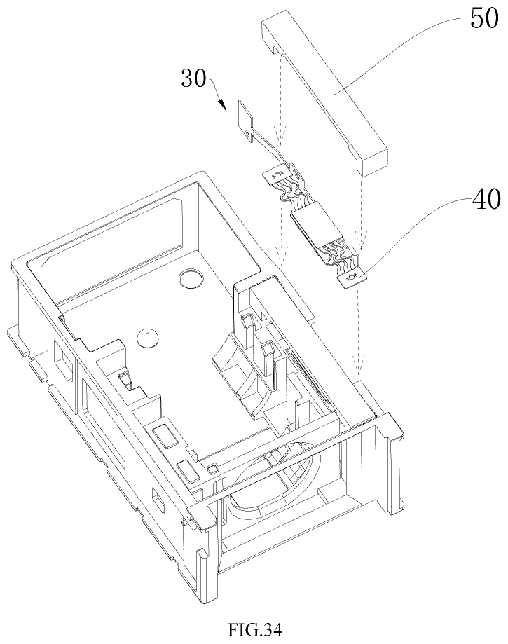

For assembling a camera module, as shown in FIGS. 31 to 34, the assembling method comprises the following steps.
S1: A fixed part 10 and a movable part 20 are provided, and the movable part 20 is installed in the fixed part 10. The movable part 20 is used to support an optical lens 100 which defines an optical axis.
S2: A piezoelectric actuator 30 and a pre-pressing part 40 are provided. The pre-pressing part 40 is located on the top of the piezoelectric actuator 30. The piezoelectric actuator 30 is located on the top side of at least a portion of the movable part 20. Under the action of the pre-pressing part 40, a pre-pressing force along the second direction is applied to the movable part 20, and the bottom end is in frictional contact with the movable part 20 for driving the movable part 20 to move along the optical axis direction.
S3: A first support part 61 and a second support part 62 are assembled between the movable part 20 and the fixed part 10. The first support part 61 is disposed on the same side as the piezoelectric actuator 30, and the second support part 62 is disposed on the opposite side of the piezoelectric actuator 30. The first support part 61 has at least two support balls 601, and the second support part 62 has at least one support ball 601.

By assembling the first support part 61 and the second support part 62 between the movable part 20 and the fixed part 10, and providing more support balls 601 in the support part on the same side as the piezoelectric actuator 30, the movable part 20 is ensured to receive sufficient support on the piezoelectrically driven side, thereby reducing the overturning moment generated by the preload of the pre-pressing part 40 and maintaining the stability of the movement of the movable part 20.

This application also provides a method for assembling a camera module, which comprises the following steps.
S1: Provide a fixed part 10;
S2: A movable part 20 is provided and installed in the fixed part 10. The movable part 20 is used to support the optical lens 100, and the optical lens 100 defines an optical axis.
S3: Provide a piezoelectric actuator 30, a pre-pressing part 40, and a pressing block 50, and assemble the piezoelectric actuator 30, the pre-pressing part 40, and the pressing block 50 to form a pre-compressing drive assembly, wherein the pre-pressing part 40 is disposed between the piezoelectric actuator 30 and the pressing block 50, the piezoelectric actuator 30 is mounted on the pre-pressing part 40, the pressing block 50 is coupled to the pre-pressing part 40, and provides a deformable preset space for the pre-pressing part 40.
S4: The pre-pressing driving assembly is installed on the fixed part 10 in a direction perpendicular to the optical axis and the drive assembly is located on top of the movable part 20. The pressing block 50 is fixed to the fixed part 10. The pre-pressing part 40 applies a pre-pressing force perpendicular to the optical axis (i.e., the second direction) to the piezoelectric actuator 30. The piezoelectric actuator 30 and the movable part 20 abut against each other under the action of the pre-pressing force, and the piezoelectric actuator 30 and the movable part 20 make frictional contact.

By installing a piezoelectric actuator 30 at the top of the movable part 20, the support structure can be located only at the bottom of the movable part 20 for support, eliminating the need for additional support structures at the top or sides of the movable part 20. This reduces the number of support structures and enhances assembly consistency and accuracy. Furthermore, since the assembly process proceeds layer by layer from bottom to top, the assembly process is further simplified, reducing assembly tolerances.

In some embodiments, in the method for assembling a camera module, the step S1 further comprises the following steps.
S11: A fixed part 10 and a first magnetic attracting element 71 are provided, wherein the first magnetic attracting element 71 is disposed on the fixed part 10.

In some embodiments, in the method for assembling a camera module, the step S2 further comprises the following steps.
S21: A second magnetic member 72 is provided, and the second magnetic member 72 is provided in the movable part 20;
S22: A first support part 61 and a second support part 62 are provided. The first support part 61 is assembled into the first guide groove 111, and the second support part 62 is assembled into the first support groove 131. The second magnetic attracting element 72 and the first magnetic attracting element 71 are arranged opposite to each other along the second direction and interact to generate a magnetic attraction force. The magnetic attracting force causes the movable part 20 and the fixed part 10 to clamp the first support part 61 and the second support part 62.

In some embodiments, in the method for assembling a camera module, the step S3further comprises the following steps.
S31: First, fix the pre-pressing part 40 and the piezoelectric actuator 30, and then couple the pre-pressing part 40 to the pressing block 50 to form a pre-compressing driving assembly. In this way, the pre-pressing part 40 can be assembled with the piezoelectric actuator 30 together with the pressing block 50, reducing the assembly difficulty.

Specifically, in step S31, the pre-pressing part 40 comprises two fixed ends 41, an elastic part 42, and two bending parts 43. The two bending parts 43 are respectively disposed between the two fixed ends 41 and the elastic part 42 and respectively connect the elastic part 42 and the two fixed ends 41. The pre-pressing part 40 is fixed to the pressing block 50 through the two fixed ends 41, and the piezoelectric actuator 30 is installed on the pre-pressing part 40 by being fixed to the elastic part 42.

It is worth mentioning that, in other embodiments of this application, the pre-pressing part 40 and the pressing block 50 may be fixed first in the step S3. Specifically, the step S3 comprises the following step.
S31b: First, the pre-pressing part 40 is coupled to the pressing block 50, and then the piezoelectric actuator 30 is installed on the pre-pressing part 40 to form a pre-compressing drive assembly.

Specifically, the step S3 further comprises the following step.
Step S31: Assemble at least two support balls 601 and at least one small ball 602 which are disposed on the same side as the pre-pressing driving assembly into the first guide groove 111, and assemble at least one support ball 601 which is disposed on the opposite side of the pre-pressing assembly into the first support groove 131.

Furthermore, in some embodiments, the step S4 further comprises the following steps.
S41: The pressing arm 52 of the pressing block 50 is installed on the fixed part 10. The friction head 32 of the piezoelectric actuator 30 is facing and abutting against the first movable side wall 21 of the movable part 20. The pressing block 50 keeps the first movable side wall 21 between the friction head 32 of the piezoelectric actuator 30 and the first support part 61. The first support part 61 provides the movable part 20 with a support force in the second direction.
S42: the pre-pressing part 40 deforms under the action of the pressing block 50 and the first support part 61, providing a pre-compressing force that is opposite to the support force and in the same direction as the downward force.

Specifically, in the step S41, the pressing block 50 is installed in the first receiving groove 112 of the fixed part 10.

Furthermore, after assembling the piezoelectric actuator 30, the pre-pressing part 40, and the pressing block 50, the pressing block 50 is then assembled onto the fixed part 10 to complete the assembly process. This simplifies the entire assembly process and further reduces the problems of tilting of the movable part 20 and poor assembly consistency of the camera module caused by assembly errors.

Furthermore, in the step S31, the pre-pressing part 40 further comprises a mounting part 44 which is fixed to the elastic part 42, thereby fixing the elastic part 42 to the piezoelectric actuator 30 through the mounting part 44.

In some embodiments of this application, the top of the movable part 20 has a friction plate 221 extending along the optical axis, and the bottom of the movable part 20 has a guide groove extending along the optical axis; the piezoelectric actuator 30 comprises at least one friction head 32 which frictionally contacts the friction plate 221 and drives the movable part 20 to move along the optical axis; a pre-pressing part 40 is disposed on the top of the piezoelectric actuator 30 and applies a pre-pressing force perpendicular to the optical axis to the movable part 20; a first support part 61 is disposed between the bottom of the movable part 20 and the fixed part 10, and the first support part 61 comprises a plurality of support balls 601; when the movable part 20 moves to its extreme position, the minimum length of the plurality of support balls 601 closely arranged is not less than the maximum distance from the at least one friction head 32 to one end of the friction plate 221.

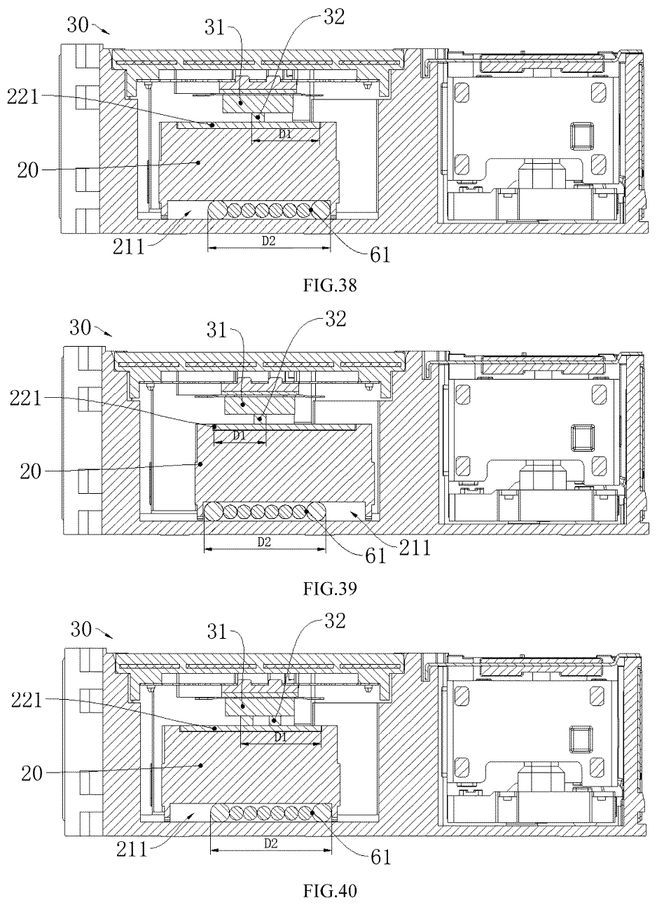

The movable part 20 comprises an incident light side and an exit light side, which are located on opposite sides of the movable part 20 along the optical axis, as shown in FIGS. 38 to 41. When the movable part 20 moves to one side to its extreme position, a plurality of support balls 601 of the first support part 61 are concentratedly arranged at one end of the guide groove near the other side of the movable part 20. The minimum length of the plurality of support balls 601 is not less than the maximum distance from the at least one friction head 32 to the friction plate 221 near the other side of the movable part 20, so that the movable part 20 is still stably supported by the first support part 61 at the extreme position, so as to prevent the pre-pressing part 40 being not adequately supported at the extreme position by the pre-pressing force applied by the friction head 32, thus preventing the movable part 20 from overturning at the extreme position.

In this application, the pre-pressing force generated by the pre-pressing part 40 is applied to the first movable sidewall 21 through the friction head 32. The guide groove is located at the bottom of the first movable sidewall 21, and the multiple balls of the first support part 61 are located in the guide groove so that the movable part 20 is supported by the first support part 61 during normal movement.

Based on this, when the extreme position is reached, that is, when the movable part 20 is at its extreme position near the incident light side or the exit light side, the support balls 601 will be concentrated at one end of the guide groove or near one end of the guide groove. It should be understood that the pre-pressing force generated by the pre-pressing part 40 is transmitted to the first movable sidewall 21 through the friction head 32. If the support balls 601 are concentrated, causing the friction contact position between the friction head 32 and the first movable sidewall 21 to not be supported by the first support part 61 in the second direction, the movable part 20 may be at risk of overturning.

Therefore, in this application, when the movable part 20 moves to its extreme position, the total length of the plurality of support balls 601 in the first support part 61 in the concentrated state, that is, the distance between the first and last support balls 601, is not less than the maximum distance from the at least one friction head 32 to one end of the friction plate 221, so as to keep the point of action of the friction head 32 on the movable part 20 always within the range supported by the support balls 601. The pre-pressing part 40 can always get effective support from the first support part 61 through the friction contact position of the friction head 32 acting on the first movable side wall 21, so as to avoid the movable part 20 from overturning at the extreme position as much as possible.

For example, specifically, when the movable part 20 moves towards the incident light side to its extreme position, the plurality of support balls 601 of the first support part 61 are concentratedly arranged at the end of the guide groove near the incident light side, and the minimum length of the plurality of support balls 601 tightly arranged is not less than the maximum distance from the at least one friction head 32 to the friction plate 221 near the incident light side.

In some embodiments, the friction head 32 is embodied as a single friction head 32. When the movable part 20 moves to one side to its extreme position, the distance from the friction head 32 to the end of the friction plate 221 near the other side of the movable part 20 is D1. The plurality of support balls 601 of the first support part 61 are compacted in the guide groove near the other side of the movable part 20. The length of the plurality of support balls 601 is D2, D1≤D2, so as to ensure that the movable part 20 can still be stably supported when it moves to the extreme position, thereby reducing the risk of overturning at the extreme position.

Specifically, as shown in FIG. 38, when the movable part 20 moves toward the incident light side to its extreme position, the plurality of support balls 601 of the first support part 61 are concentratedly arranged at the end of the guide groove near the incident light side, and the minimum length of the plurality of support balls 601 being tightly arranged is not less than the distance from the friction head 32 to the end of the friction plate 221 near the incident light side; as shown in FIG. 39, when the movable part 20 moves toward the exit light side to its extreme position, the plurality of support balls 601 of the first support part 61 are concentratedly arranged at the end of the guide groove near the incident light side, and the minimum length of the plurality of support balls 601 being tightly arranged is not less than the distance from the friction head 32 to the end of the friction plate 221 near the incident light side.

In some embodiments, the number of the friction heads 32 is two. When the movable part 20 moves to its extreme position towards one side, the distance from the friction head 32 near that side of the movable part 20 to the end of the friction plate 221 near the other side of the movable part 20 is D1. The plurality of support balls 601 of the first support part 61 are compacted in the guide groove near the end of the movable part 20 on the other side. The length of the plurality of support balls 601 is D2, D1≤D2, so as to ensure that the movable part 20 can still be stably supported when it moves to the extreme position, thereby reducing the risk of overturning at the extreme position.

Specifically, as shown in FIG. 40, when the movable part 20 moves toward the incident light side to its extreme position, the plurality of support balls 601 of the first support part 61 are concentratedly arranged at one end of the guide groove near the exit light side. The minimum of the plurality of support balls 601 is not less than the maximum distance from the friction head 32 near the incident light side to the end of the friction plate 221 near the exit light side. As shown in FIG. 41, when the movable part 20 moves toward the exit light side to its extreme position, the plurality of support balls 601 of the first support part 61 are concentratedly arranged at one end of the guide groove near the incident light side. The minimum length of the plurality of support balls 601 which are closely arranged is not less than the maximum distance from the friction head 32 near the exit light side to the end of the friction plate 221 near the incident light side.

In other words, regardless of which direction the movable part 20 moves, and regardless of whether it is a single friction head 32 or a double friction head 32, at the extreme position, the projection of the contact position between the friction head 32 and the friction plate 221 overlaps with the projection of the multiple support balls 601 of the first support part 61. That is, during the movement of the movable part 20, the friction head 32 and its contact position are supported by the first support part 61.

It should be understood that in the above situation, the movement direction of the movable part 20 is opposite to the movement direction of the first support part 61. Since the movement of the balls in the guide groove is uncontrollable, it is also possible for the situation to be the opposite of the above state, that is, the movement direction of the movable part 20 is the same as the movement direction of the first support part 61, as shown in FIGS. 42 to 45. When the movable part 20 moves to the extreme position to one side, the multiple support balls 601 of the first support part 61 are concentrated and arranged at one end of the guide groove near the side of the movable part 20. The minimum length of the multiple support balls 601 which are tightly arranged is not less than the maximum distance from the at least one friction head 32 to the end of the friction plate 221 near the side of the movable part 20.

Specifically, when the movable part 20 moves towards the incident light side to its extreme position, the plurality of support balls 601 of the first support part 61 are concentrated at one end of the guide groove near the incident light side, and the minimum length of the plurality of support balls 601 which are tightly arranged is not less than the maximum distance from the at least one friction head 32 to the friction plate 221 near the incident light side. When the movable part 20 moves towards the exit light side to its extreme position, the plurality of support balls 601 of the first support part 61 are concentrated at one end of the guide groove near the exit light side, and the minimum length of the plurality of support balls 601 which are tightly arranged is not less than the maximum distance from the at least one friction head 32 to the friction plate 221 near the exit light side.

In some embodiments, the friction head 32 is a single friction head 32. When the movable part 20 moves to one side to its extreme position, the distance from the friction head 32 to the end of the friction plate 221 near the side of the movable part 20 is D1. The plurality of support balls 601 of the first support part 61 are compacted in the guide groove near the end of the movable part 20. The length of the plurality of support balls 601 is D2, D1≤D2, so as to ensure that the movable part 20 can still be stably supported when it moves to the extreme position, thereby reducing the risk of overturning of the movable part 20 at the extreme position.

Specifically, as shown in FIG. 42, when the movable part 20 moves toward the incident light side to its extreme position, the plurality of support balls 601 of the first support part 61 are concentratedly arranged at one end of the guide groove near the incident light side, and the minimum length of the plurality of support balls 601 being tightly arranged is not less than the distance from the friction head 32 to the end of the friction plate 221 near the incident light side; as shown in FIG. 43, when the movable part 20 moves toward the exit light side to its extreme position, the plurality of support balls 601 of the first support part 61 are concentratedly arranged at one end of the guide groove near the exit light side, and the minimum length of the plurality of support balls 601 which are tightly arranged is not less than the distance from the friction head 32 to the end of the friction plate 221 near the exit light side.

In some embodiments, a double friction head 32 is provided. When the movable part 20 moves to its extreme position toward one side, the distance from the friction head 32 near the other side of the movable part 20 to the end of the friction plate 221 near the side of the movable part 20 is D1. The plurality of support balls 601 of the first support part 61 are compacted in the guide groove near the end of the movable part 20. The length of the plurality of support balls 601 is D2, D1≤D2, so as to ensure that the movable part 20 can still be stably supported when it moves to the extreme position, thereby reducing the risk of overturning at the extreme position.

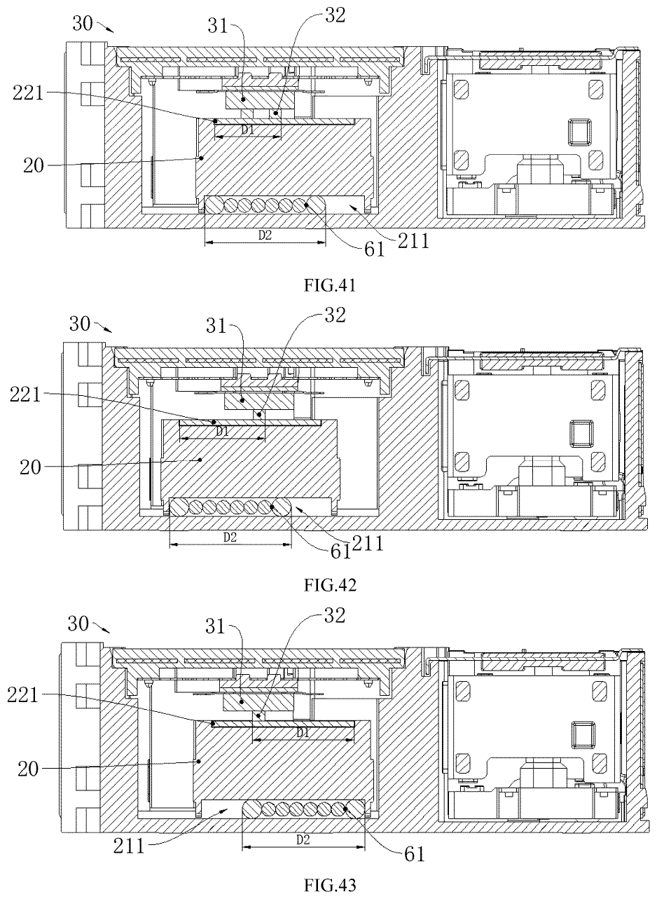

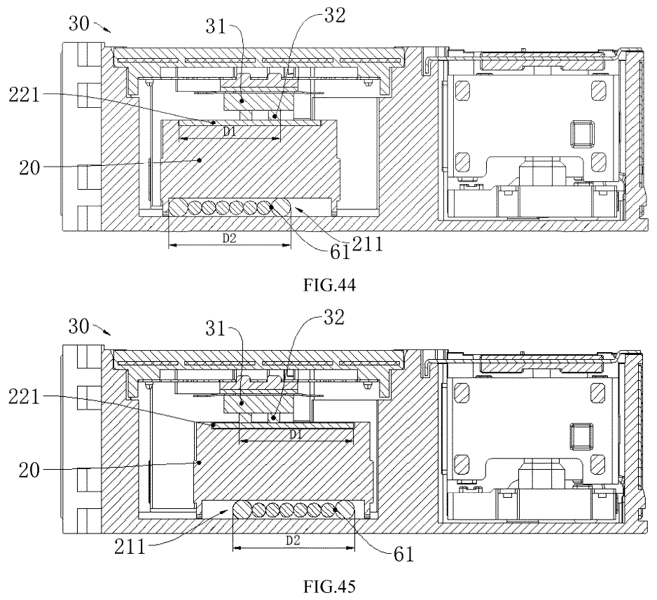

Specifically, as shown in FIG. 44, when the movable part 20 moves toward the incident light side to its extreme position, the plurality of support balls 601 of the first support part 61 are concentratedly arranged at one end of the guide groove near the incident light side. The minimum length of the plurality of support balls 601 is not less than the maximum distance from the friction head 32 near the exit light side to the end of the friction plate 221 near the incident light side. As shown in FIG. 45, when the movable part 20 moves toward the exit light side to its extreme position, the plurality of support balls 601 of the first support part 61 are concentratedly arranged at one end of the guide groove near the exit light side. The minimum length of the plurality of support balls 601 is not less than the maximum distance from the friction head 32 near the incident light side to the end of the friction plate 221 near the exit light side.

In some embodiments, the maximum distance from the at least one friction head 32 to one end of the friction plate 221 is not less than the mechanical stroke of the movable part 20, ensuring that the movement range of the movable part 20 driven by the piezoelectric actuator 30 covers the mechanical stroke of the movable part 20, preventing the friction head 32 from exceeding the length range of the friction plate 221 and rubbing against other structures at the extreme position, and avoiding the friction between the friction head 32 and structures other than the friction plate 221 from affecting the effect of friction drive.

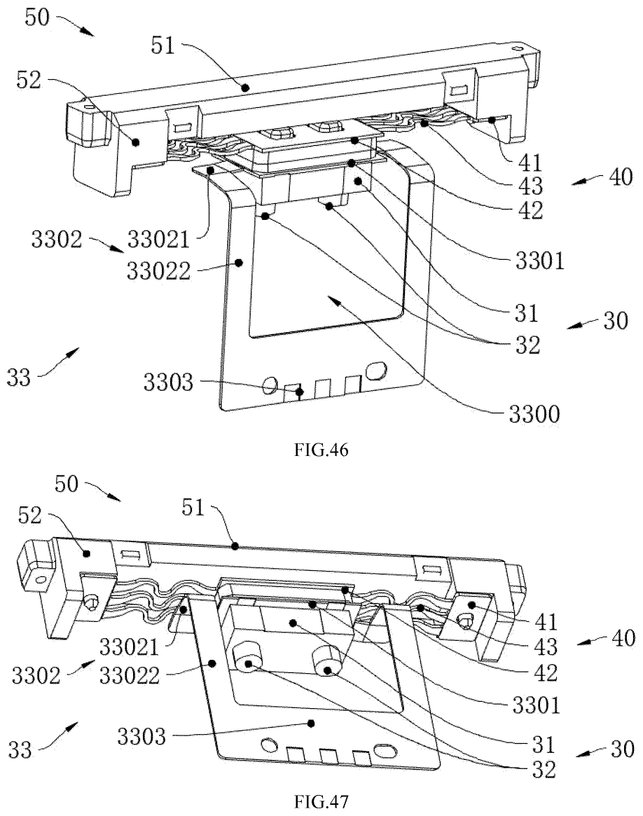

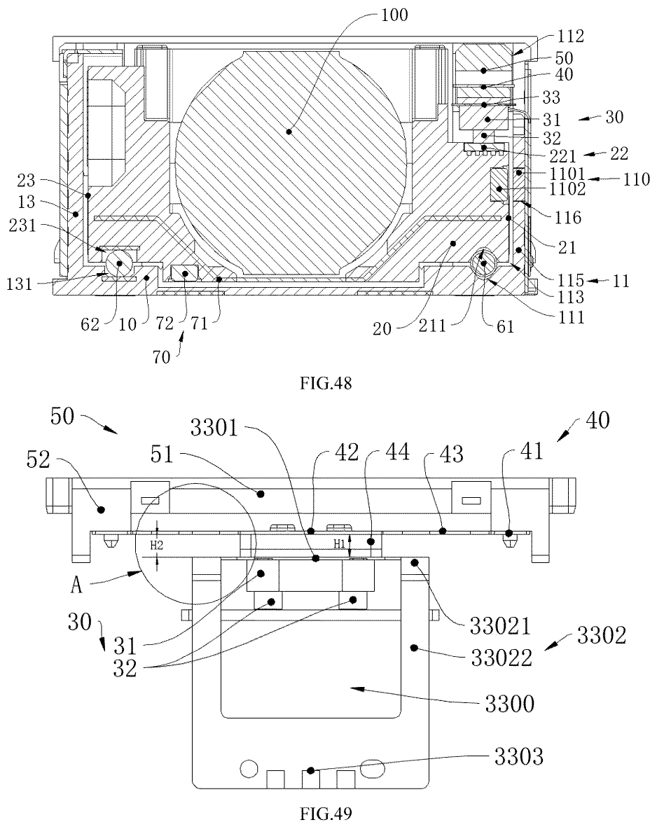

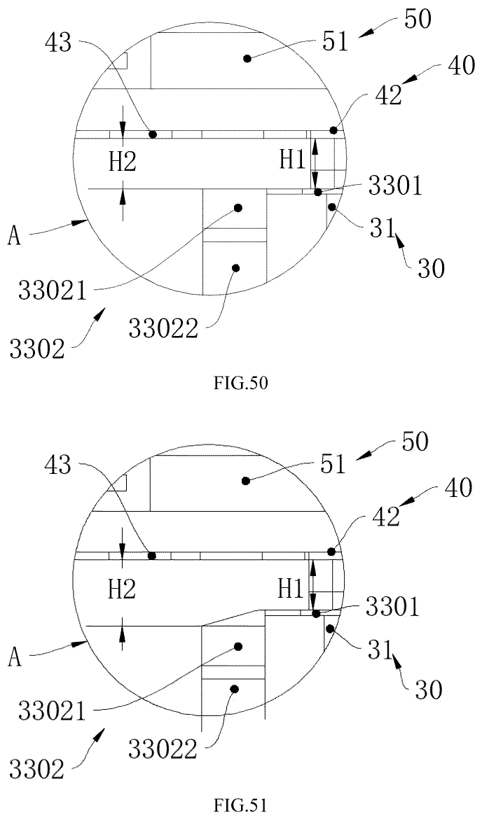

As shown in FIGS. 46 to 51, this application discloses a driving arrangement comprising a movable part 20 for carrying an optical lens 100 defining an optical axis, a fixed part 10, a position sensing assembly 110, a piezoelectric actuator 30, an electric conductive component 33 and a flexible circuit board 15. The movable part 20 comprises a first movable sidewall 21, the movable part 20 is movably disposed within the fixed part 10, the fixed part 10 comprises a first fixed sidewall 11, the first movable sidewall 21 and the first fixed sidewall 11 are opposite to each other along a first direction, the first direction being perpendicular to the optical axis direction. The position sensing assembly 110 comprises a position sensing element 1101 and a position sensing magnet 1102 disposed opposite to each other along the first direction. The position sensing magnet 1102 is disposed on the first movable sidewall 21. The piezoelectric actuator 30 is in frictional contact with the top of the first movable sidewall 21 and is used to drive the movable part 20 to move along the optical axis. The electric conductive component 33 is disposed on the top of the piezoelectric actuator 30 and electrically connected to the piezoelectric actuator 30, and the electric conductive component 33 is bent from the top of the piezoelectric actuator 30 to the first fixed sidewall 11. The flexible circuit board 15 is disposed on the first fixed sidewall 11, and at least a portion of the position sensing element 1101 and the electric conductive component 33 are respectively located on two sides of the flexible circuit board 15 and electrically connected to the flexible circuit board 15.

This application achieves electric conductivity between the position sensing assembly 110 and the electric conductive component 33 on the first fixed sidewall 11 by setting the bent conductive component 33 and the flexible circuit board 15. The position sensing element 1101 and the electric conductive component 33 are respectively located on two sides of the flexible circuit board 15 and electrically connected to the flexible circuit board 15. The position sensing element 1101 and the electric conductive component 33 are located on the outer side of the first movable sidewall 21, and the position sensing element 1101 is located on the inner side of the first fixed sidewall 11, so that the position sensing magnet 1102 is closer to the driving source, ensuring the accuracy of measurement and the speed of signal transmission. The electric conductive component 33 is located on the outer side of the flexible circuit board 15 to avoid structural interference between the electric conductive component 33 located on the inner side and the position sensing element 1101, and at the same time to prevent the electric conductive component 33 located on the inner side from being excessively bent and causing the risk of breakage. This conduction method allows the electric conductive component 33 and the position sensing element 1101 to be connected together on the flexible circuit board 15, and then connected to other external components through the flexible circuit board 15, simplifying the conduction circuit and facilitating the soldering of the electric conductive component 33 to the flexible circuit board 15. Furthermore, it allows for a more compact structure of the driving arrangement.

The driving arrangement further comprises the position sensing assembly 110 for sensing and controlling the movement position of the movable part 20. The position sensing assembly 110 is disposed on the side of the movable part 20 to make reasonable use of the space of the camera module and increase the compactness of the structure. Further, the position sensing assembly 110 may include a Hall element, an integrated circuit driver (driver IC), a tunnel magnetoresistive (TMR), etc. The position sensing assembly 110 comprises the position sensing element 1101 and the position sensing magnet 1102 disposed opposite to each other along the first direction. The position sensing element 1101 is located on the first fixed sidewall 11 of the fixed part 10, and the position sensing magnet 1102 is located on the first movable sidewall 21 of the movable part 20 to sense the position of the optical lens 100 on the movable part 20.

The driving arrangement further comprises the flexible circuit board 15 which is disposed on the outer side of the first fixed sidewall 11. The flexible circuit board 15 comprises an inner side and an outer side opposite to each other along the first direction. At least a portion of the position sensing element 1101 and the electric conductive component 33 are respectively located on two sides of the flexible circuit board 15 and electrically connected to the flexible circuit board 15, which facilitates the conduction of the position sensing element 1101 and the electric conductive component 33, and also facilitates the soldering of the electric conductive component 33.

For the purpose of position sensing, the position sensing element 1101 needs to be mounted on the first fixed sidewall 11 so that its corresponding position sensing magnet 1102 is closer to the piezoelectric actuator 30 which serves as the drive source, resulting in more accurate measurements and faster signal transmission. It should be understood that when the movable part 20 tilts, according to the inner wheel difference principle, the tilt angle on the same side as the position sensing magnet 1102 is greater than the tilt angle on the opposite side. Therefore, the position sensing magnet 1102 is closer to the piezoelectric actuator 30 on the same side, resulting in a more noticeable sensing effect. Furthermore, the electric conductive component 33 is electrically connected to the piezoelectric actuator 30 to conduct electricity between the piezoelectric actuator 30 and the flexible circuit board 15. The electric conductive component 33, bent and extended from the same side as the piezoelectric actuator 30 to the outside of the first fixed sidewall 11, not only simplifies the structure of the electric conductive component 33 but also makes welding the electric conductive component 33 to the flexible circuit board 15 easier. Therefore, in this application, the position sensing element 1101 and the electric conductive component 33 are designed to be located on the same side of the first movable sidewall 21. Furthermore, the position sensing element 1101 needs to correspond with the position sensing magnet 1102 along the first direction to achieve better sensing performance. Therefore, in this application, the position sensing element 1101 is located inside the flexible circuit board 15 so that the position sensing element 1101 and the position sensing magnet 1102 are opposite each other, thereby improving the sensing accuracy of the position sensing element 1101.

In this application, the first fixed sidewall 11 has a mounting groove 116. The position sensing element 1101 is disposed in the mounting groove 116 to electrically connect to the inner side of the flexible circuit board 15. The electric conductive component 33 is bent to the outer side of the flexible circuit board 15 to electrically connect to the flexible circuit board 15. Specifically, the mounting groove 116 is opened along the first direction and penetrates the first fixed sidewall 11 to accommodate the position sensing element 1101, so that the position sensing element 1101 is opposite to the position sensing magnet 1102. This avoids the installation of the position sensing assembly 110 increasing the assembly tolerance between the movable part 20 and the fixed part 10, thereby avoiding an increase in the overall width of the camera module.

At least a portion of the flexible circuit board 15 is disposed on the outside of the mounting groove 116, which further facilitates the circuit conduction of the position sensing element 1101.

It is understandable that if the electric conductive component 33 is connected to the inside of the flexible circuit board 15, on the one hand, the electric conductive component 33 may interfere with the position sensing element 1101, affecting the conduction between the position sensing element 1101 and the flexible circuit board 15; on the other hand, the electric conductive component 33 needs to be connected to the piezoelectric actuator 30 and soldered to the flexible circuit board 15, that is, the electric conductive component 33 comprises at least two connecting parts, respectively connecting the piezoelectric actuator 30 and the flexible circuit board 15, and the plane where the piezoelectric actuator 30 is located and the plane where the flexible circuit board 15 is located are perpendicular to each other, then the planes where the at least two connecting parts of the electric conductive component 33 are located are perpendicular to each other. In other words, the electric conductive component 33 needs to be bent before being soldered to the flexible circuit board 15 to conduct electricity. If the bending angle is too small, the electric conductive component 33 will be prone to breakage due to excessive bending. In addition, there is a very small assembly tolerance between the fixed part 10 and the movable part 20, that is, the gap between the first fixed side wall 11 and the first movable side wall 21 is very small, and the space for the electric conductive component 33 to bend is very small. The electric conductive component 33 is subjected to greater stress at the bending point, which increases the risk of breakage when bending.

Therefore, in this application, the electric conductive component 33 is conductive on the outside of the flexible circuit board 15. This conductive method reduces the risk of breakage due to excessive bending of the electric conductive component 33 within a limited space. It also simplifies the connection of the electric conductive component 33 and the position sensing element 1101. By concentrating the electric conductive component 33 and the position sensing element 1101 on the flexible circuit board 15, and then connecting them to other external components through the flexible circuit board 15, the circuitry is simpler, and the soldering of the electric conductive component 33 to the flexible circuit board 15 is more convenient. Furthermore, it allows for a more compact structure of the driving arrangement.

In some embodiments, the flexible circuit board 15 comprises a top near the piezoelectric actuator 30 and a bottom away from the piezoelectric actuator 30. The electric conductive component 33 bends from the top of the piezoelectric actuator 30 and extends to the bottom of the flexible circuit board 15 for soldering and conduction at the bottom of the flexible circuit board 15. By setting the soldering point positions of the electric conductive component 33 and the flexible circuit board 15, the number of bends of the electric conductive component 33 is reduced, thereby simplifying the structure of the electric conductive component 33 and reducing the risk of breakage of the electric conductive component 33.

In some embodiments of the electric conductive component 33 of this application, the electric conductive component 33 comprises a main body 3301, an extension part 3302, and a welding part 3303. The main body 3301 is located at the top of the piezoelectric actuator 30. The extension part 3302 is bent from the plane of the main body 3301 along the second direction. The welding part 3303 is connected to the extension part 3302 and is electrically connected to the bottom of the flexible circuit board 15. The plane of the main body 3301 is perpendicular to the plane of the flexible circuit board 15, and the plane of the extension part 3302 is parallel to the plane of the flexible circuit board 15. The second direction is perpendicular to the optical axis direction and the first direction. As shown in FIGS. 46 and 47, the main body 3301 is located between the pre-pressing part 40 and the piezoelectric actuator 30, and is a horizontal plate extending along the XY interface. The extension part 3302 and the welding part 3303 are vertical plates extending from the outer surface of the first fixed sidewall 11 of the fixed part 10. The horizontal plate and the vertical plate are connected through the bending area of the extension part 3302, and the extension end of the vertical plate of the electric conductive component 33 is the welding part 3303, which is used to weld the flexible circuit board 15 located on the outside of the first fixed sidewall 11, thereby increasing the space utilization inside the camera module while achieving electrical conductivity.

In some embodiments, the main body 3301 is located on top of the piezoelectric active part 31 of the piezoelectric actuator 30, and the extension part 3302 is extended from two ends of the main body 3301 along the optical axis and then is bent along the second direction. Since the two ends of the electric conductive component 33 are electrically connected to the piezoelectric active part 31 and the flexible circuit board 15 respectively through the main body 3301 and the welding part 3303, the main body 3301 will deform and generate a counterforce due to the vibration of the piezoelectric active part 31, and the counterforce will affect the vibration of the piezoelectric active part 31 in the opposite direction. In this application, the extension parts 3302 are extended from two ends of the main body 3301 along the optical axis. Since the vibration of the piezoelectric active part 31 has a certain direction and amplitude, the extension parts 3302 are extended symmetrically from two sides of the main body 3301 for generating symmetrical counterforce, thereby reducing the impact of the counterforce on the piezoelectric active part 31 and helping to maintain the stability of the vibration of the piezoelectric active part 31.

In this application, the extension parts 3302 are bent from two ends of the main body 3301 toward the outer surface of the first fixed sidewall 11 of the fixed part 10 along the optical axis and extends along the second direction, so that the extension part 3302 has a larger length along the second direction and a smaller width along the optical axis, so as to reduce the tensile force generated by the welding part 3303 and the flexible circuit board 15, thereby reducing the impact of the reaction force on the piezoelectric active part 31.

Specifically, the extension part 3302 comprises an integrally formed extension area 33021 and an extension leg 33022. The extension areas 33021 are extended from two ends of the main body 3301 in the optical axis direction and are then bent along the second direction to connect with the extension legs 33022. The extension leg 33022 is connected to the welding part 3303 at the bottom along the second direction. The main body 3301, the extension area 33021, the extension leg 33022 and the welding part 3303 form an extension opening 3300 to ensure that the extension part 3302 has sufficient length along the second direction and a small width along the optical axis direction, thereby further reducing the tensile force generated by the welding part 3303 and the flexible circuit board 15 and reducing the impact of its reaction force on the piezoelectric active part 31.

In addition, the above mentioned welding method at the bottom of the flexible circuit board 15 can increase the extension length of the extension leg 33022 after the electric conductive component 33 is bent. The lower the welding position between the flexible circuit board 15 and the welding part 3303, the longer the extension leg 33022 of the extension part 3302, which further reduces the tensile force generated by the welding part 3303 and the flexible circuit board 15, thereby reducing the impact of its reaction force on the piezoelectric active part 31, thus ensuring the driving performance of the piezoelectric actuator 30.

Referring to FIGS. 46 to 50, in this application, the pre-pressing part 40 comprises a pre-pressing part body and pre-pressing deformable bodies. The pre-pressing deformable bodies are extended from two ends of the pre-pressing part body along the optical axis. Since the extension area 33021 of the extension part 3302 of the electric conductive component 33 overlaps with the projection of the pre-pressing deformable body of the pre-pressing part 40 along the second direction, when the height of the extension area 33021 is relatively high, interference may occur between the deformation of the pre-pressing deformable body and the deformation of the extension area 33021 under the vibration of the piezoelectric active part 31. The pre-pressing part body is implemented as the elastic part 42 in the pre-pressing part 40, and the pre-pressing deformable body is implemented as the bending part 43 in the pre-pressing part 40.

In some embodiments of this application, along the second direction, the distance from the top surface of the main body 3301 of the electric conductive component 33 to the bottom surface of the pre-pressing part body is H1, and the distance from the top surface of the extension part 3302 of the electric conductive component 33 to the bottom surface of the pre-pressing deformable body is H2, where H1≤H2. That is, the distance H2 between the top surface of the extension part 3302 and the bottom surface of the pre-pressing deformable body should be increased to avoid interference between the deformation of the pre-pressing deformable body and the deformation of the electric conductive component 33 under the vibration of the piezoelectric active part 31, thereby ensuring the driving effect of the piezoelectric actuator 30.

In some embodiments, a mounting part 44 is provided between the pre-pressing part body and the main body portion 3301 of the electric conductive component 33 to increase the distance H1 from the top surface of the main body portion 3301 to the bottom surface of the pre-pressing part body. As shown in FIG. 49, by raising the pre-pressing part 40 to increase H1, the distance between the pre-pressing part 40 and the electric conductive component 33 is increased, reducing the probability of interference between the electric conductive component 33 and the pre-pressing deformable body, thereby ensuring the driving effect of the piezoelectric actuator 30.

In some embodiments, when the mounting part 44 is present, H1 can be equal to H2 as long as there is a non-interfering deformation space between the pre-pressing part 40 and the electric conductive component 33.

Furthermore, the plane of the extension area 33021 of the extension part 3302 has a height difference with respect to the plane of the main body 3301. The extension part 3302 and the main body 3301 are connected by an inclined connecting portion, as shown in FIG. 51. A slope is formed from one end of the main body 3301 to the adjacent extension area 33021. This increases the height of H2 and facilitates the connection between the electric conductive component 33 and the flexible circuit board 15. It should be understood that because the electric conductive component 33 and the flexible circuit board 15 are connected and conductive at the bottom of the camera module, the electric conductive component 33 will be pulled during the welding process. It is difficult to keep the plane of the extension area 33021 of the electric conductive component 33 parallel to the plane of the main body 3301 during this process. Therefore, the height difference between the plane of the extension area 33021 and the plane of the main body 3301 makes assembly easier.

The basic principles, main features, and advantages of this application have been described above. Those skilled in the art should understand that this application is not limited to the above embodiments. The embodiments and descriptions in the specification are merely the principles of this application. Various changes and modifications can be made to this application without departing from its spirit and scope, and all such changes and modifications fall within the scope of the claims. The scope of protection claimed by this application is defined by the appended claims and their equivalents.

What is claimed is:

1. A driving arrangement, comprising:
a movable part for supporting an optical lens which defines an optical axis, and a friction plate arranged on a top of said movable part and extending along said optical axis, wherein a bottom of said movable part has a guide groove extending along said optical axis;
a fixed part, wherein said movable part is movably disposed within said fixed part;
a piezoelectric actuator which comprises at least one friction head that is in frictional contact with said friction plate and is used to drive said movable part to move along said optical axis;
a pre-pressing part which is arranged on a top of said piezoelectric actuator to apply a pre-pressing force perpendicular to said optical axis to said movable part; and
a first support part provided between said bottom of said movable part and said fixed part, wherein said first support part comprises a plurality of support balls, wherein when said movable part is moved to an extreme position, a minimum length of said plurality of support balls being closely arranged is not less than a maximum distance between said at least one friction head and an end of said friction plate.

2. The driving arrangement as claimed in claim 1, wherein said movable part comprises a first movable sidewall and a second movable sidewall which is opposite to said first movable sidewall, wherein said pre-pressing part, said friction head and said friction plate are sequentially located at a top of said first movable sidewall along a second direction, and said first support part is located at a bottom of said first movable sidewall, wherein a projection of said pre-pressing part along said second direction, a projection of said friction head along said second direction, a projection of said friction plate along said second direction and a projection of said first support part along said second direction overlap each other, wherein said second direction is perpendicular to said optical axis.

3. The driving arrangement as claimed in claim 2, wherein said movable part has an incident light side and an exit light side, and when said movable part is moved to said extreme position at said incident light side, said plurality of support balls are concentratedly arranged at one end of said guide groove adjacent to said exit light side, and said minimum length of said plurality of support balls being closely arranged is not less than said maximum distance between said at least one friction head and said one end of said friction plate adjacent to said exit light side.

4. The driving arrangement as claimed in claim 3, wherein when said movable part is moved to said extreme position at said exit light side, said plurality of support balls are concentratedly arranged at another end of said guide groove adjacent to said incident light side, and said minimum length of said plurality of support balls being closely arranged is not less than said maximum distance between said at least one friction head and said another end of said friction plate adjacent to said incident light side.

5. The driving arrangement as claimed in claim 2, wherein said movable part has an incident light side and an exit light side, and when said movable part is moved to said extreme position at said incident light side, said plurality of support balls are concentratedly arranged at another end of said guide groove adjacent to said incident light side, and said minimum length of said plurality of support balls being closely arranged is not less than said maximum distance between said at least one friction head and said another end of said friction plate adjacent to said incident light side.

6. The driving arrangement as claimed in claim 5, wherein when said movable part is moved to said extreme position at said exit light side, said plurality of support balls are concentratedly arranged at one end of said guide groove adjacent to said exit light side, and said minimum length of said plurality of support balls being closely arranged is not less than said maximum distance between said at least one friction head and said one end of said friction plate adjacent to said exit light side.

7. The driving arrangement as claimed in claim 2, wherein said projection of said friction plate along said second direction overlaps with a line connecting the two farthest endpoints of said guide groove, and said projection of said friction plate along said second direction overlaps with a line connecting said two support balls of said first support part.

8. The driving arrangement as claimed in claim 2, wherein said projection of said friction head along said second direction overlaps with said projection of a line connecting the first and last balls of said first support part along said second direction.

9. The driving arrangement as claimed in claim 2, wherein said projection of said friction head along said second direction is covered by said projection of said guide groove along said second direction.

10. The driving arrangement as claimed in claim 2, further comprising a pressing block fixed to said fixed part and coupled to said pre-pressing part to provide a deformable preset space for said pre-pressing part, wherein said pressing block is placed on a top of said pre-pressing part, and said projection of said first support part along said second direction is entirely within a projection range of said pressing block along said second direction.

11. The driving arrangement as claimed in claim 3, wherein said maximum distance between said at least one friction head and said one end of said friction plate is not less than a mechanical stroke of said movable part.
